(19) United States
(12) Patent Application Publication
(10) Pub. No.: US 2004/0115475 A1
(43) Pub. Date: Jun. 17, 2004

(54) Aromatic methylidene compound, methylstyrul compound for producing the same, production electroluminescent element

(75) Inventor: Mitsuru Hashimoto, Yokohama-shi (JP)

Correspondence Address: DARBY & DARBY P.C., P. O. BOX 5257, NEW YORK, NY, 10150-5257, US

(73) Assignee: Matsushita Electric Industrial Co., Ltd., Kadoma-Shi (JP)

(21) Appl. No.: 10/639,790

(22) Filed: Aug. 12, 2003

(30) Foreign Application Priority Data
Aug. 14, 2002 (JP) 2002-236223
Aug. 29, 2002 (JP) 2002-251825
Aug. 29, 2002 (JP) 2002-251826
Aug. 29, 2002 (JP) 2002-251827
Aug. 29, 2002 (JP) 2002-251828

(51) Int. Cl. H05B 33/14; C09K 11/06; H01B 1/12

(52) U.S. Cl. 428/690; 428/917; 313/504; 257/40

(57) ABSTRACT

A novel aromatic methylidene compound of formula (1):

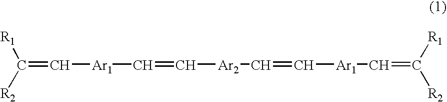

wherein R₁ and R₂ are H, alkyl group, cycloalkyl group, aromatic group, or heteroaromatic group; or R₁ and R₂ together form a condensed ring consisting of aromatic or heteroaromatic rings; Ar₁ is a phenylene group, Ar₂ is the following groups:

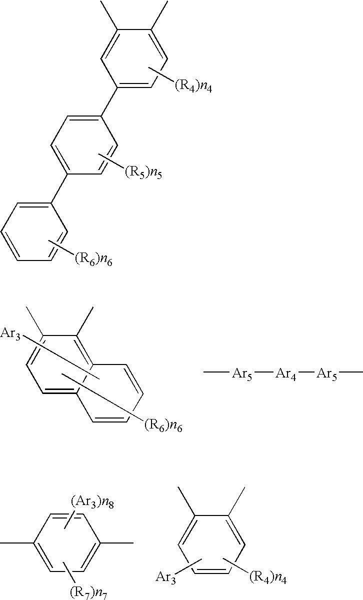

wherein R₄ to R₇ are alkyl group, alkoxy group, a halogen atom, cyano group, or nitro group, Ar₃ represents aromatic or heteroaromatic group, Ar₄ and Ar₅ are phenylene group, n₄ is 0-3, n₅ is 0-4, n₆ is 0-5, and n₇ and n₈ are 0-3 and 1-4, respectively.

### BACKGROUND OF THE INVENTION

The present invention relates to a novel organic methylidene compound useful as functional materials for a sensor in an electronic camera, as functional materials in an organic electroluminescent element such as electric charge transporting materials and luminescent materials, and as functional materials for other various organic semiconductor elements. The present invention also relates to a methylstyryl compound useful for producing the same, production methods therefor, and an organic electroluminescent element.

An electroluminescent element utilizing an electroluminescent phenomenon of substances is self-luminescent unlike a liquid crystal element and thus has a high visibility, which results in a clear view when used as a display device. Since the electroluminescent element is completely in a solid state, the element has properties such as shock-resistant property. It is thus expected that the electroluminescent element will find a variety of uses for, e.g., a thin display, a back light of liquid crystal displays and a plane light source.

One of the electroluminescent elements that are practically used at present is a dispersion electroluminescent element containing inorganic materials such as zinc sulfide. However, the dispersion electroluminescent element requires high a.c. voltage for driving, and therefore have problems such as complicated driving circuits and low brightness. Therefore, such an element is not widely put into practical use.

An organic electroluminescent element using organic materials has been spotlighted since C. W. Tang et al. proposed in 1987 an element having a laminate structure in which an electron-transporting organic fluorescent substance and a positive hole-transporting organic substance are stacked and both carriers for electrons and for positive holes are injected into the fluorescent material layer to generate luminescence (C. W. Tang and S. V. VAN Slyke, Appl. Phys. Lett., Vol. 51, p. 913-915 (1987); JP-A-S63-264629). It is reported that luminescence of at least 1000 cd/m² was obtained under a driving voltage of not more than 10 V in the element. Following this proposal, various investigations for these materials have been carried out actively. Various materials and element structures have been proposed to date and researches for their practical use are being performed actively.

On the other hand, organic electroluminescent elements using the organic materials proposed hitherto still have various problems. For example, functions of the elements may deteriorate even during storing in either driving or non-driving state. Such deterioration may cause lowering in luminescence brightness and generation and growth of a non-luminescent region that is called dark spot in driving or non-driving state, which finally lead to a short circuit and rupture of the element. Such phenomena are considered to be essential problems in the materials used. In the present state, it is hardly recognized that the elements have sufficient lives for their practical use. Therefore, their practical use is restricted to devices in which a short life may be accepted. Further, none of the present systems and luminescent materials are suitable for an element for a color display. In order to solve these problems and to attain their wide practical use, it is an important technical object to seek for new high functional luminescent materials and electric charge transporting materials.

### SUMMARY OF THE INVENTION

The present invention has been made in view of the aforementioned present state of the art of the organic electroluminescent elements. The object of the present invention is to provide an aromatic methylidene compound that is useful as materials, especially an luminescent material, that may give an organic electroluminescent element having bright luminescence at low voltage and high durability. The present invention also relates to a methylstyryl compound useful for producing the same, production methods therefor, and an organic electroluminescent element having high brightness and high durability.

According to the present invention, there is provided a compound represented by the following formula (1):

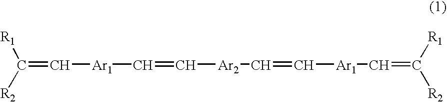

wherein R₁ and R₂ are the same or different from each other and each represents a hydrogen atom (provided that at least one of R₁ and R₂ is not hydrogen atom), a non-substituted or substituted alkyl group (provided that at least one of R₁ and R₂ is not the alkyl group), a non-substituted or substituted cycloalkyl group (provided that at least one of R₁ and R₂ is not the cycloalkyl group), a non-substituted or substituted aromatic group, or a non-substituted or substituted heteroaromatic group; or R₁ and R₂ together form a condensed ring consisting of non-substituted or substituted aromatic rings or non-substituted or substituted heteroaromatic rings;

Ar₁ is a group represented by the following formula:

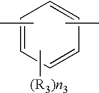

wherein R₃ represents a non-substituted or substituted alkyl group, a non-substituted or substituted alkoxy group, a halogen atom, a cyano group, or a nitro group (provided that, if two or more of R₃ are present, these R₃ groups are the same or different), and n₃ represents an integer of 0 to 4;

Ar₂ is selected from the group consisting of the groups represented by the following formulae:

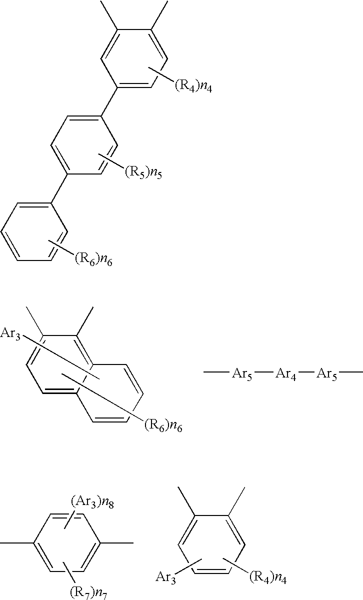

wherein each of R₄ to R₇ represents a non-substituted or substituted alkyl group, a non-substituted or substituted alkoxy group, a halogen atom, a cyano group, or a nitro group (provided that, if two or more of each of R₄ to R₇ are present, these groups are the same or different), Ar₃ represents a non-substituted or substituted aromatic group or non-substituted or substituted heteroaromatic group, each of Ar₄ and Ar₅ is a 1,2-phenylene group with or without substituent group(s), a 1,3-phenylene group with or without substituent group(s), or a 1,4-phenylene group with or without substituent group(s) (provided that at least one of Ar₁, Ar₄ and Ar₅ is not 1,4-phenylene group), n₄, n₅ and n₆ are integers of 0 to 3, 0 to 4 and 0 to 5, respectively, and n₇ and n₈ are integers of 0 to 3 and 1 to 4, respectively (provided that the sum of n₇ and n₈ is 4 or fewer).

According to the present invention, there is further provided an intermediate compound for preparing the compound of the formula (1), said intermediate compound being represented by the following formula (2):

H₃C—Ar₂—CH₃ (2)

wherein Ar₂ is the same as that in the formula (1).

According to the present invention, there is further provided an intermediate compound for preparing the compound of the formula (1), said intermediate compound being represented by the following formula (3):

X₁CH₂—Ar₂—CH₂X₁ (3)

wherein Ar₂ is the same as that in the formula (1), and X₁ represents chlorine, bromine or iodine.

According to the present invention, there is further provided a method for producing the intermediate compound of the formula (3), said method comprising the step of halogenating the intermediate compound represented by the formula (2):

H₃C—Ar₂—CH₃ (2)

wherein Ar₂ is the same as that in the formula (1).

According to the present invention, there is further provided an intermediate compound for preparing the compound of the formula (1), said intermediate compound being represented by the following formula (5):

Z—CH₂—Ar₂—CH₂—Z (5)

wherein Ar₂ is the same as that in the formula (1), and groups Z are the same or different from each other and each represents —PO(OR)₂ or —PA₃⁺ or a salt thereof with a base, wherein R represents a non-substituted or substituted alkyl group, and A represents a non-substituted or substituted aryl group.

According to the present invention, there is further provided a method for producing the intermediate compound of the formula (5), said method comprising the step of reacting the compound represented by the formula (3):

X₁CH₂—Ar₂—CH₂X₁ (3)

wherein Ar₂ is the same as that in the formula (1), and X₁ represents chlorine, bromine or iodine, with a compound represented by the formula P(OR)₃ or P(A)₃, wherein R represents a non-substituted or substituted alkyl group, and A represents a non-substituted or substituted aryl group.

According to the present invention, there is further provided a method for producing the compound of the formula (1), said method comprising the step of reacting the compound represented by the formula (5):

Z—CH₂—Ar₂—CH₂—Z (5)

wherein Ar₂ is the same as that in the formula (1), and groups Z are the same or different from each other and each represents —PO(OR)₂ or —PA₃⁺ or a salt thereof with a base, wherein R represents a non-substituted or substituted alkyl group, and A represents a non-substituted or substituted aryl group, with a compound represented by the following formula (7):

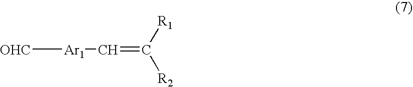

wherein R₁, R₂ and Ar₁ are the same as those in the formula (1).

According to the present invention, there is further provided a method for producing the compound of the formula (1), said method comprising the step of reacting a compound represented by the following formula (8):

OHC—Ar₁—CH═CH—Ar₂—CH═CH—Ar₁—CHO (8)

wherein Ar₁ and Ar₂ are the same as those in the formula (1), with a compound represented by the formula (8-1):

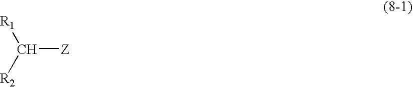

wherein R₁ and R₂ are the same as those in the formula (1), and Z represents —PO(OR)₂ or —PA₃⁺ or a salt thereof with a base, wherein R represents a non-substituted or substituted alkyl group, and A represents a non-substituted or substituted aryl group.

According to the present invention, there is further provided a method for producing the compound of the formula (1), said method comprising the step of reacting the compound represented by the following formula (9):

Z—H₂C—Ar₁—CH═CH—Ar₂—CH═CH—Ar₁—CH₂—Z (9)

wherein Ar₁ and Ar₂ are the same as those in the formula (1), and groups Z are the same or different from each other and each represents —PO(OR)₂ or —PA₃⁺ or a salt thereofwith abase, wherein R represents a non-substituted or substituted alkyl group, and A represents a non-substituted or substituted aryl group,

with a compound represented by the following formula (9-1):

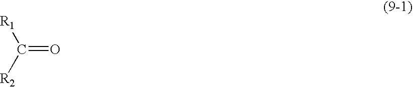

wherein R₁ and R₂ are the same as those in the formula (1).

According to the present invention, there is further provided the compound of the formula (1) wherein Ar₁ is a group represented by the following formula (10) and Ar₂ is a group represented by the formula (10-1):

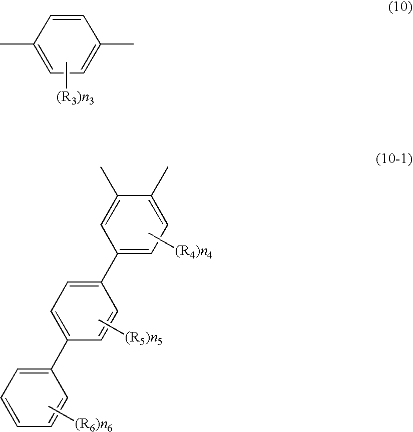

wherein R₃ to R₆ and n₃ to n₆ are the same as those in the formula (1).

According to the present invention, there is further provided a method for producing the compound of the formula (1), said method comprising the step of reacting a compound represented by the formula (11) with a compound represented by the formula (11-1):

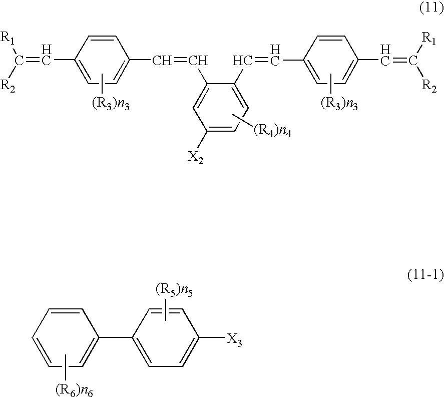

wherein R₁ to R₆ and n₃ to n₆ are the same as those in the formula (1), and one of X₂ and X₃ represents chlorine, bromine, iodine or —OSO₂CF₃, and the other represents —B(OH)₂ or an ester thereof.

According to the present invention, there is further provided an intermediate compound for producing the compound of the formula (1), said intermediate compound being represented by the following formula (12):

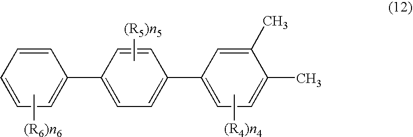

wherein R₄ to R₆ and n₄ to n₆ are the same as those in the formula (1).

According to the present invention, there is further provided a method for producing the intermediate compound of the formula (12), said method comprising the step of reacting the compound represented by the formula (11-1) and a compound represented by the following formula (13):

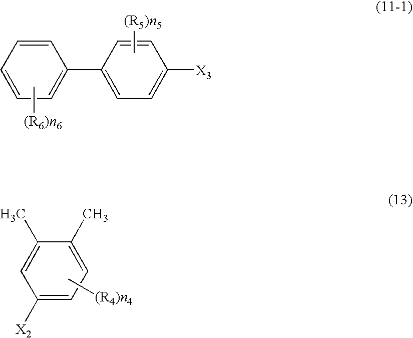

wherein R₄ to R₆ and n₄ to n₆ are the same as those in the formula (1), and one of X₂ and X₃ represents chlorine, bromine, iodine or —OSO₂CF₃, and the other represents —B(OH)₂ or an ester thereof.

According to the present invention, there is further provided a compound of the formula (1) wherein Ar₁ is a group represented by the formula (10), and Ar₂ is a group represented by the following formula (14):

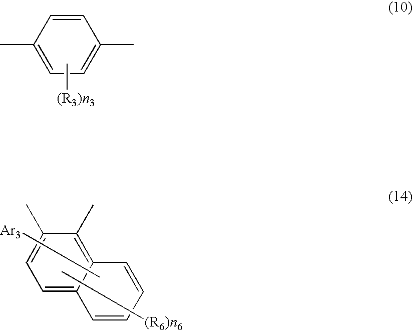

wherein R₃, R₆, n₃, n₆ and Ar₃ are the same as those in the formula (1).

According to the present invention, there is provided a method for producing the compound of the formula (1), said method comprising the step of reacting a compound represented by the following formula (15) and a compound represented by the following formula (15-1):

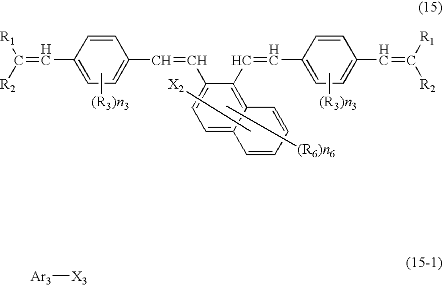

wherein R₁ to R₃, R₆, n₃, n₆ and Ar₃ are the same as those in the formula (1), and one of X₂ and X₃ represents chlorine, bromine, iodine or —OSO₂CF₃, and the other represents —B(OH)₂ or an ester thereof.

According to the present invention, there is further provided an intermediate compound for producing the compound of the formula (1), said intermediate compound being represented by the following formula (16):

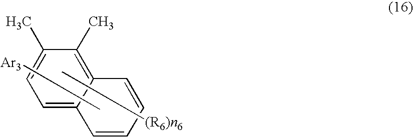

wherein R₆, n₆ and Ar₃ are the same as those in the formula (1).

According to the present invention, there is further provided a method for producing the intermediate compound of claim (16), said method comprising the step of reacting the compound represented by the formula (15-1) with a compound represented by the following formula (17):

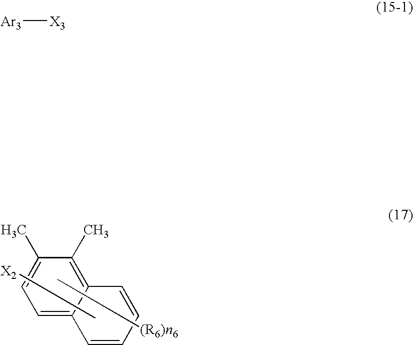

wherein R₆, n₆ and Ar₃ are the same as those in the formula (1), and one of X₂ and X₃ represents chlorine, bromine, iodine or —OSO₂CF₃, and the other represents —B(OH)₂ or an ester thereof.

According to the present invention, there is further provided a compound of the formula (1), wherein Ar₂ is a group represented by the following formula (18):

—Ar₅—Ar₄—Ar₅— (18)

wherein Ar₄ and Ar₅ are the same as those in the formula (1).

According to the present invention, there is further provided an intermediate compound for producing the compound of the formula (1), said intermediate compound being represented by the following formula (19):

OHC—Ar₅—Ar₄—Ar₅—CHO (19)

wherein Ar₄ and Ar₅ are the same as those in the formula (1).

According to the present invention, there is further provided a method for producing the compound of the formula (1), said method comprising the step of reacting a compound represented by the following formula (19) with a compound represented by the following formula (20):

OHC—Ar₅—Ar₄—Ar₅—CHO (19)

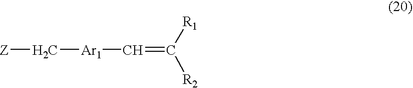

wherein R₁, R₂, Ar₁, Ar₄ and Ar₅ are the same as those in the formula (1), and Z represents —PO(OR)₂ or —PA₃⁺ or a salt of —PA₃⁺ and a base, wherein R represents a non-substituted or substituted alkyl group, and A represents a non-substituted or substituted aryl group.

According to the present invention, there is further provided a method for producing the compound of the formula (1), said method comprising the step of reacting a compound represented by the following formula (21) with a compound represented by the following formula (21-1):

Z—CH₂—Ar₅—Ar₄—Ar₅—CH₂—Z (21)

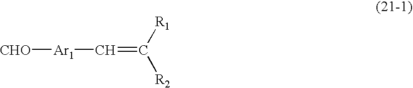

wherein R₁, R₂, Ar₁, Ar₄ and Ar₅ are the same as those in the formula (1), and Z represents —PO(OR)₂ or —PA₃⁺ or a salt of —PA₃⁺ and a base, wherein R represents a non-substituted or substituted alkyl group, and A represents a non-substituted or substituted aryl group.

According to the present invention, there is further provided a method for producing the intermediate compound of the formula (19), said method comprising the step of reacting a compound represented by the following formula (22) with a compound represented by the following formula (22-1):

X₂—Ar₄—X₂ (22)

OHC—Ar₅—X₃ (22-1)

wherein Ar₄ and Ar₅ are the same as those in the formula (1), and one of X₂ and X₃ represents chlorine, bromine, iodine or —OSO₂CF₃, and the other represents —B(OH)₂ or an ester thereof.

According to the present invention, there is further provided the compound of the formula (1) wherein Ar₁ is a group represented by the formula (10), and Ar₂ is a group represented by the following formula (23):

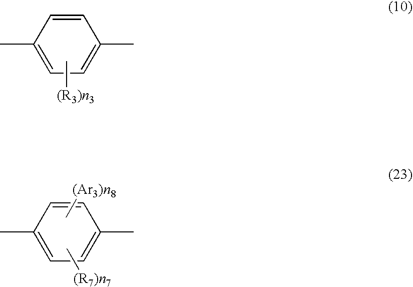

wherein R₃, R₇, Ar₃, n₃, n₇ and n₈ are the same as those in the formula (1).

According to the present invention, there is further provided a method for producing the compound of the formula (1), said method comprising the step of reacting a compound represented by the following formula (24) with a compound represented by the following formula (24-1): 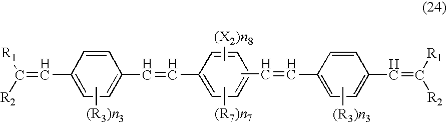 Ar₃—X₃ (24-1)

wherein R₁ to R₃, R₇, Ar₃, n₃, n₇ and n₈ are the same as those in the formula (1), and one of X₂ and X₃ represents chlorine, bromine, iodine or —OSO₂CF₃, and the other represents —B(OH)₂ or an ester thereof.

According to the present invention, there is further provided an intermediate compound for producing the compound of the formula (1), said intermediate compound being represented by the following formula (25):

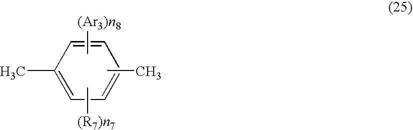

wherein R₇, Ar₃, n₇ and n₈ are the same as those in the formula (1).

According to the present invention, there is further provided a method for producing the intermediate compound of the formula (25), said method comprising the step of reacting the compound represented by the formula (24-1) with a compound represented by the following formula (26):

Ar₃—X₃ (24-1)

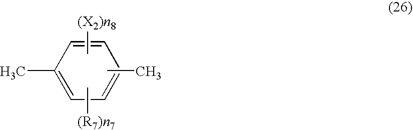

wherein R₇, Ar₃, n₇ and n₈ are the same as those in the formula (1), and one of X₂ and —X₃ represents chlorine, bromine, iodine or —OSO₂CF₃, and the other represents —B(OH)₂ or an ester thereof.

According to the present invention, there is further provided the compound of the formula (1), wherein Ar₁ is a group represented by the formula (10), and Ar₂ is a group represented by the following formula (27):

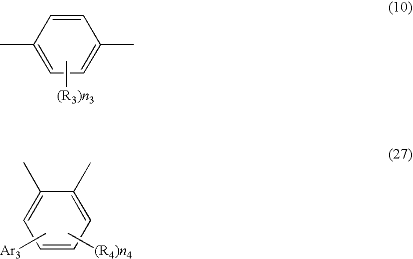

wherein R₃, R₄, Ar₃, n₃ and n₄ are the same as those in the formula (1).

According to the present invention, there is further provided an organic electroluminescent element comprising a layer containing the compound of the formula (1).

The compound represented by the formula (1) according to the present invention is useful as a constituent, particularly as a luminescent material, of an organic electroluminescent element. The compounds represented by the formulae (2), (12), (16), (19) and (25) are useful intermediates for producing the compound represented by the formula (1). The compounds and the production method therefor provided by the present invention enables production of an organic electroluminescent element of the present invention having high brightness and high durability.

### BRIEF DESCRIPTION OF DRAWINGS

FIG. 1 is a schematic sectional view of an element that is an embodiment of the present invention having an anode, a luminescence layer and a cathode.

FIG. 2 is a schematic sectional view of an element that is an embodiment of the present invention having an anode, a positive hole-transporting layer, a luminescence layer and a cathode.

FIG. 3 is a schematic sectional view of an element that is an embodiment of the present invention having an anode, a positive hole-transporting layer, a luminescence layer, an electron-transporting layer and a cathode.

FIG. 4 is a schematic sectional view of an element that is an embodiment of the present invention having an anode, a luminescence layer, an electron-transporting layer and a cathode.

### PREFERRED EMBODIMENT OF THE INVENTION

The first compound of the present invention is a compound represented by the formula (1).

In the formula (1), (i) R₁ and R₂ are the same as or different from each other and each represents a hydrogen atom (provided that one of R₁ and R₂ is not hydrogen atom), a non-substituted or substituted alkyl group (provided that one of R₁ and R₂ is not the alkyl group), a non-substituted or substituted cycloalkyl group (provided that one of R₁ and R₂ is not the cycloalkyl group), a non-substituted or substituted aromatic group, or anon-substituted or substituted heteroaromatic group; or (ii) R₁ and R₂ together form a condensed ring consisting of non-substituted or substituted aromatic rings or non-substituted or substituted heteroaromatic rings. In the case of (i), it is preferable that at least one of R₁ and R₂ is a non-substituted or substituted aromatic group, or a non-substituted or substituted heteroaromatic group. The non-substituted or substituted alkyl group may preferably be those having 1 to 12 carbon atoms, and the non-substituted or substituted cycloalkyl group may preferably be those having 3 to 8 carbon atoms. Examples of the non-substituted or substituted heteroaromatic group may include a phenyl group, a naphthyl group, a phenanthryl group, an anthryl group, pyrenyl group, and these groups substituted by one or more of a methyl group, a t-butyl group, a trifluoromethyl group, a halogen atom, a phenyl group, a methoxy group, a nitro group, a benzyl group, a cyclohexyl group and a cyano group. Examples of the non-substituted or substituted aromatic group may include a thienyl group, a pyridyl group and a quinolyl group. In the case of (ii), examples of the condensed ring that R₁ and R₂ together may form may include a dibenzocycloheptenylidene group, a dibenzocycloheptanylidene group, and a tribenzocycloheptatriene group.

In the formula (1), each of R₃ to R₇ represents a non-substituted or substituted alkyl group, a non-substituted or substituted alkoxy group, a halogen atom, a cyano group, or a nitro group. The non-substituted or substituted alkyl group may be those having 1 to 12 carbon atoms. The non-substituted or substituted alkoxy group may be those having 1 to 12 carbon atoms. Examples of the halogen atom may include —F, —Cl, —Br and —I.

Ar₃ represents a non-substituted or substituted aromatic group or a non-substituted or substituted heteroaromatic group. Examples of the non-substituted or substituted aromatic group may include a phenyl group, a naphthyl group, a phenanthryl group, an anthryl group, pyrenyl group, and these groups substituted by one or more of a methyl group, a t-butyl group, a trifluoromethyl group, a halogen atom, a phenyl group, a methoxy group, a nitro group, a benzyl group, a cyclohexyl group and a cyano group. Examples of the non-substituted or substituted heteroaromatic group may include a thienyl group, a pyridyl group and a quinolyl group.

n₃ represents an integer of 0 to 4, n₄ represents an integer of 0 to 3, n₅ represents an integer of 0 to 4 and n₆ represents an integer of 0 to 5. n₇ and n₈ represent integers of 0 to 3 and 1 to 4, respectively, and the sum of n₇ and n₈ is 4 or fewer. If any one of n₃ to n₈ is an integer of 2 or more, that is, if a plurality of any one of R₃ to R₇ and Ar₃ are present, each of R₃ to R₇ and Ar₃ may be the same substituents or different substituents.

In the formula (1), each of Ar₄ and Ar₅ is a 1,2-phenylene group with or without one or more substituent group(s), a 1,3-phenylene group with or without one or more substituent group(s), or a 1,4-phenylene group with or without one or more substituent group(s) provided that at least one of Ar₁, Ar₄ and Ar₅ is not 1,4-phenylene group. As used herein, that a phenylene group “with a substituent group(s)” means that the phenylene group have one or more substituents at one or more of 3, 4, 5 and 6 position in the case of 1,2-phenylene group, 2, 4, 5 and 6 position in the case of 1,3-phenylene group, or 2, 3, 5 or 6 position in the case of 1,4-phenylene group. The substituent on Ar₄ and Ar₅, if present, maybe anon-substituted or substituted alkyl group, a non-substituted or substituted alkoxy group, a halogen atom, a cyano group, or a nitro group. The non-substituted or substituted alkyl group may be those having 1 to 12 carbon atoms. The non-substituted or substituted alkoxy group may be those having 1 to 12 carbon atoms. Examples of the halogen atom may include —F, —Cl, —Br and —I. If two or more of the substituents are present, they may be the same or different.

Specifically, the compound of the formula (1) may preferably be those in which Ar₂ is the group represented by the formula (18), or those in which Ar₁ is the group represented by the formula (10) and Ar₂ is the group represented by the formula (10-1), (14), (23) or (27)

The compound of the formula (1) of the present invention may readily be produced by any of the synthesis routes as follows. That is, (a) reaction of the methylphosphorus compound represented by the formula (5) with the aldehyde compound represented by the formula (7); (b) reaction of the aldehyde compound represented by the formula (8) with the methylphosphorus compound represented by the formula (8-1); (c) reaction of the methylphosphorus compound represented by the formula (9) with the ketone compound represented by the formula (9-1), and (d) other reactions. (d) other reactions may include (d-1) reaction of the compound represented by the formula (11), (15) or (24) with the compound (11-1), (15-1) or (24-1), respectively, or (d-2) reaction of the compound represented by the formula (19) with the compound represented by the formula (20), or reaction of the compound represented by the formula (21) with the compound represented by the formula (21-1). In the formulae (5), (8-1), (9), (20) and (21), Z represents —PO(OR)₂ or —PA₃⁺ or a salt thereof, wherein “R” represents a non-substituted or substituted alkyl group, preferably a non-substituted or substituted alkyl group having 1 to 4 carbon atoms. “A” of —PA₃⁺ represents a non-substituted or substituted aryl group, preferably a phenyl group, a tolyl group or a naphthyl group. When two or more Z's are present in the formula, these may be the same as or different from each other. The salt of —PA₃⁺ may be those in which —PA₃⁺ and any of suitable base are combined. Examples of the base may include ions of halogen atoms such as fluorine, chlorine, bromine and iodine.

In the formulae (11), (11-1), (15), (15-1), (24) and (24-1), one of X₂ and X₃ is chlorine, bromine, iodine or —OSO₂CF₃. In terms of ready reaction, bromine and iodine are particularly preferable. The other is —B(OH)₂ or an ester thereof. The Example of the combination may include a combination in which X₂ is chlorine, bromine, iodine or —OSO₂CF₃ whereas X₃ is —B(OH)₂ or an ester thereof, and a combination in which X₂ is —B(OH)₂ or an ester thereof whereas X₃ is chlorine, bromine, iodine or —OSO₂CF₃. Examples of those which may be combined with —B(OH)₂ for constituting an ester may include an alcohol having 1 to 4 carbon atoms, a divalent alcohol having 2 to 3 carbon atoms. More specifically, such compounds may include butanol, tetramethyl ethylene glycol, and 2,2-dimethyl propylene glycol. The form of the ester may be a non-cyclic ester with monovalent alcohols, or a cyclic ester with a divalent alcohol.

Among the aforementioned reactions, reactions (a), (b), (c) and (d-2) are those between an aldehyde or ketone and another functional group such as an active methylene, and are usually performed in a solvent such as an organic solvent with a base. Examples of the solvent for reaction may include water; alcohols such as methanol, ethanol, butanol and amyl alcohol; aromatic hydrocarbons such as benzene, toluene, xylene, mesitylene, chlorobenzene and nitrobenzene; ethers such as diethylether, tetrahydrofuran and dioxane; halogenated hydrocarbons such as chloroform, dichlormethane and dichloroethane; heterocyclic aromatic hydrocarbons such as pyridine and quinoline; and other organic solvents such as N,N-dimethylformamide and dimethylsulfoxide. Any of generally used organic solvents may be used. Examples of the bases for reaction may include inorganic bases such as potassium carbonate, sodium carbonate, potassium hydroxide and sodium hydroxide; organic bases such as triethylamine, triethanolamine, pyridine and hexamethylenetetramine; alkali metal salts of alcohols such as sodium methoxide, sodium ethoxide and potassium butoxide; and sodium amides. The amount of the base may suitably adjusted from catalytic amount to chemical equivalent amount.

The temperature for reaction (a), (b), (c) and (d-2) may be from about −10° C. to about 150° C., and preferably from about 0° C. to about 80° C. in most of cases. The reaction time depends upon the reaction temperature, and may usually be 30 minutes to 100 hours, which may suitably be adjusted depending on the combination of the reaction materials.

There is no particular limitation as to the operation for separating the objective compound from the reaction mixture after finishing the reaction. For example, a crude product may be retrieved by concentration or dilution with a poor solvent, preferably followed by washing with water for removing inorganic matters and then followed by any general purification procedures such as column chromatography, re-crystallization, or sublimation purification, for obtaining a pure product.

The reaction (d-1) is a reaction between a halogen compound or a triflate compound with an aryl boronic acid. In general, this reaction is performed using a base in the presence of a catalyst in a solvent such as an organic solvent. In this reaction, the ratio of the halogen or triflate compound with respect to the aryl boronic acid may basically be equal in terms of stochiometrically, i.e., one mole of the aryl boronic acid per one mole of the halogen or triflate compound, which may suitably be adjusted considering the cost of the materials and facility of separation of the objective product.

The catalyst for the reaction (d-1) may include transition metals such as nickel and palladium, transition metal compounds, and complexes thereof. Specific examples thereof may include bis(triphenylphosphine)nickel(II) chloride, bis(triphenylphosphine)palladium(II) chloride, palladium(II) acetate, palladium(II) chloride, tetrakis (triphenylphosphine) palladium(0), tris(dibenzylideneacetone)dipalladium(0) and [1,1′-bis(diphenylphosphino)ferrocene] nickel(II) dichloride. The amount of the catalyst may be 0.001 to 1 mole per 1 mole of the aryl boronic acid. Considering the effect thereof and cost therefor, the amount of the catalyst may preferably be 0.01 to 0.1 mole per 1 mole of the aryl boronic acid.

Examples of the bases for reaction (d-1) may include inorganic base such as cesium fluoride, potassium carbonate, sodium carbonate, sodium hydrogencarbonate, potassium hydroxide, sodium hydroxide, and potassium phosphate; organic bases such as triethylamine, triethanolamine, pyridine and hexamethylenetetramine; and alkali metal salts of alcohols such as sodium methoxide, sodium ethoxide and potassium butoxide. The amount of the base may be equal molar to five times molar amount with respect to the aryl boronic acid.

Examples of the solvent for reaction (d-1) may include water; alcohols such as methanol, ethanol, butanol and amyl alcohol; aromatic hydrocarbons such as benzene, toluene, xylene, mesitylene, chlorobenzene and nitrobenzene; ethers such as diethylether, tetrahydrofuran and dioxane; halogenated hydrocarbons such as chloroform, dichlormethane and dichloroethane; heterocyclic aromatic hydrocarbons such as pyridine and quinoline; and other organic solvents such as N,N-dimethylformamide and dimethylsulfoxide. Any of generally used organic solvents may be used.

The temperature for reaction (d-1) may be from room temperature to about 150° C., and preferably from about 50° C. to about 100° C. in most of cases. The reaction time depends upon the reaction temperature, and may usually be 30 minutes to 100 hours, which may suitably be adjusted depending on the combination of the reaction materials.

After the reaction, the objective compound may be separated by filtration if the objective compound is present as precipitates. If the objective compound is dissolved in the solvent, a crude product may be retrieved by concentration or dilution with a poor solvent, preferably followed by washing with water for removing inorganic matters and then followed by the aforementioned general purification procedures, for obtaining a pure product.

The compound of the formula (19) for the reaction (d-2) may be prepared from the compounds represented by the formulae (22) and (22-1) by the reaction procedure similar to the aforementioned reaction (d-1).

The second compound of the present invention is the compound represented by the formula (2). In the formula (2), Ar₂ is the same as that in the formula (1). Example of the compound represented by the formula (2) may include the compound represented by the formula (12), the compound represented by the formula (16), and the compound represented by the formula (25).

The compound represented by the formula (2) maybe obtained by the reaction of the compound represented by the formula (11-1) with the compound represented by the formula (13), the reaction of the compound represented by the formula (15-1) with the compound represented by the formula (17), or the reaction of the compound represented by the formula (24-1) with the compound represented by the formula (26). X₂ and X₃ in these formulae may be the same as those in the other compounds described above. These reaction maybe performed by the operations that is similar to those for the aforementioned reaction (d-1).

The third compound of the present invention is the compound represented by the formula (3). In the formula (3), Ar₂ is the same as that in the formula (1), and X₁ represents chlorine, bromine or iodine.

The compound represented by the formula (3) maybe produced by halogenating the compound represented by the formula (2). Specifically, the compound represented by the formula (2) may be reacted with a compound containing a halogen species, under the light irradiation and/or in the presence of a radical generator such as benzoyl peroxide or azobisisobutyronitrile, in an organic solvent such as carbon tetrachloride or carbon disulfide at about 30° C. to 100° C. for 30 minutes to 10 hours. The compound containing the halogen species may preferably be a compound containing a bromine atom, such as bromine or N-bromosuccinimide.

The fourth compound of the present invention is the compound represented by the formula (5). In the formula (5), Ar₂ and Z may be the same as those in the aforementioned other compounds.

The compound represented by the forumula (5) of the present invention may be produced by reacting the compound represented by the formula (3) with the compound represented by the formula P(OR₃) or P(A)₃, wherein “R” and “A” may be the same as those in the aforementioned other compounds. Specifically, the compound represented by the formula (5) may be prepared by reacting the compound of the formula (3) with a phosphite triester at 50° C. to 150° C. for 10 minutes to 10 hours; or with a triaryl phosphine compound such as triphenyl phosphine.

Embodiments of the compound represented by the formula (1) of the present invention will be enumerated in Tables 1 to 23, embodiments of the compound represented by the formula (2) in Tables 24 to 28, embodiments of the compound represented by the formula (3) in Tables 29 to 33, embodiments of the compound represented by the formula (5) in Tables 34 to 38, and embodiments of the compound represented by the formula (19) in Tables 39 to 41, although the present invention is not limited thereto.

TABLE 1

| Compound No. | Formula |
|---|---|
| (1-01) | 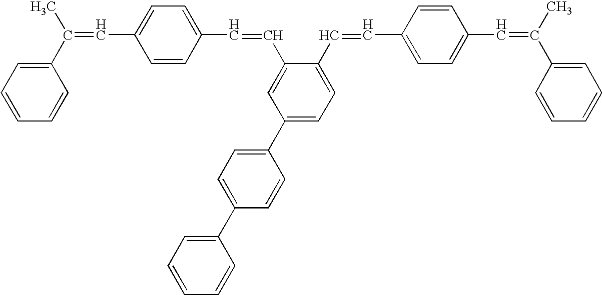 |
| (1-02) | 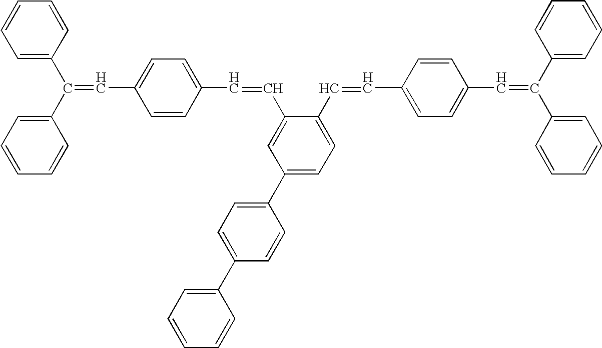 |
| (1-03) | 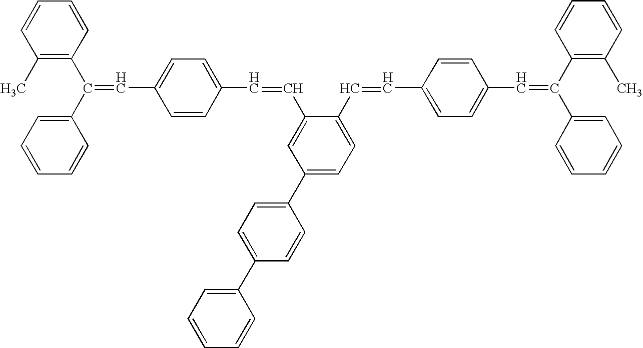 |
| (1-04) | 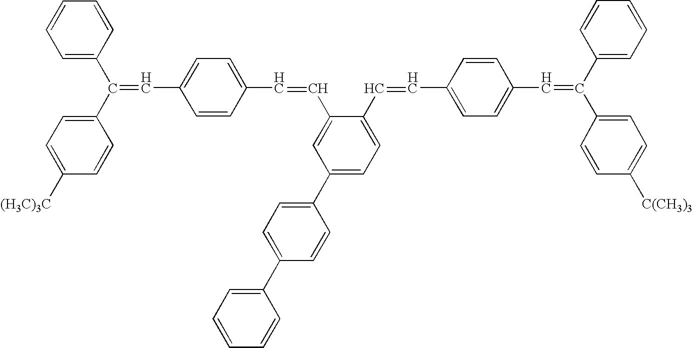 |

TABLE 2

| Compound No. | Formula |
|---|---|
| (1-05) | 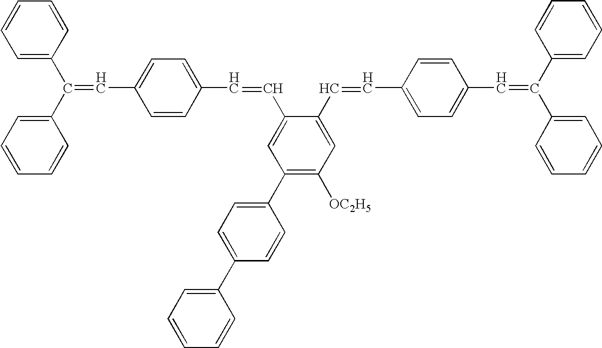 |
| (1-06) | 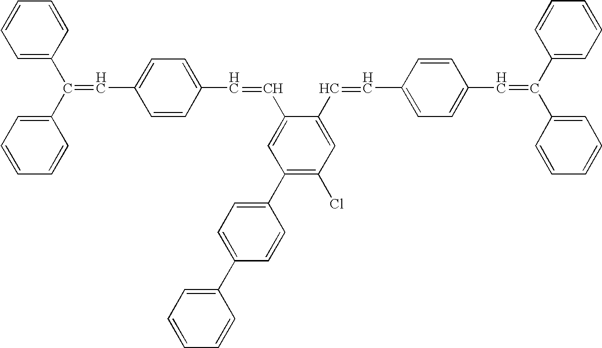 |
| (1-07) | 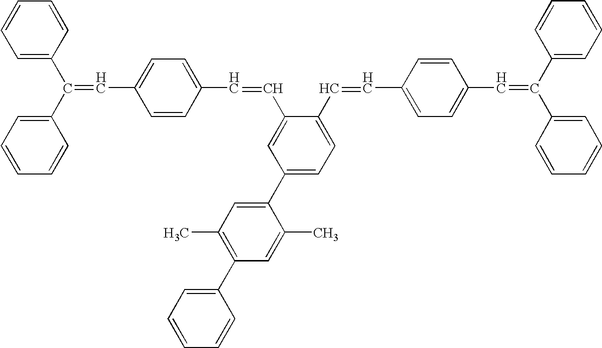 |
| (1-08) | 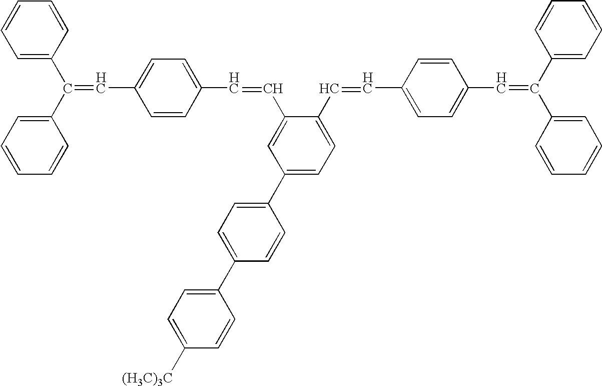 |

TABLE 3

| Compound No. | Formula |
|---|---|
| (1-09) | 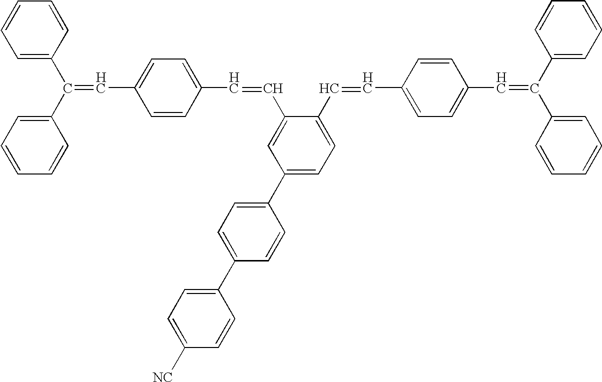 |
| (1-10) | 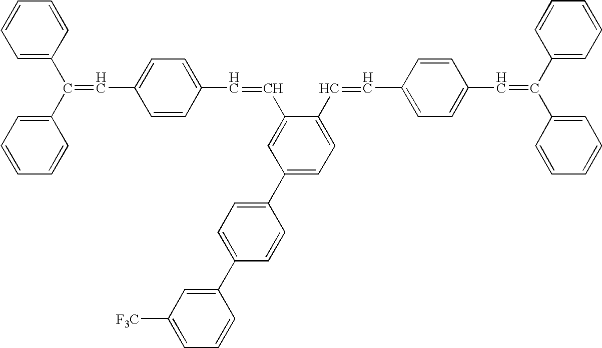 |
| (1-11) | 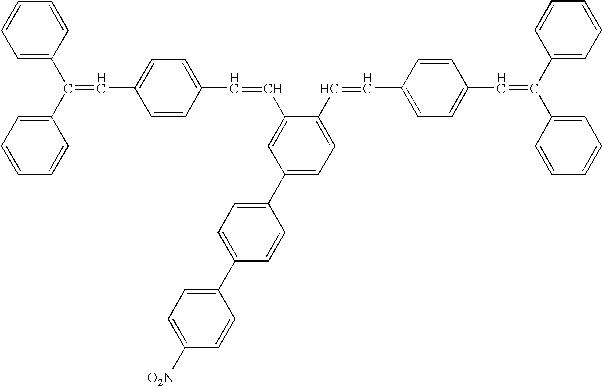 |
| (1-12) | 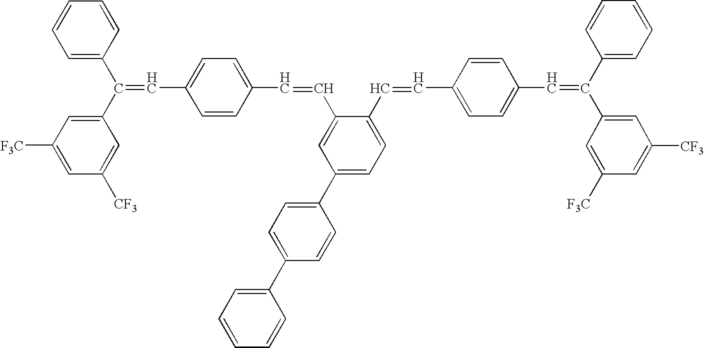 |

TABLE 4

| Compound No. | Formula |
|---|---|
| (1-13) | 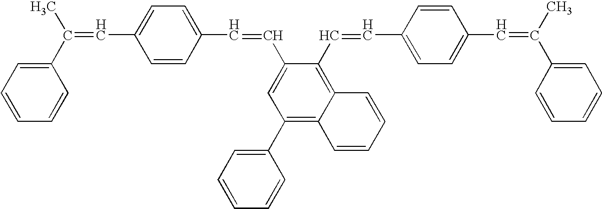 |
| (1-14) | 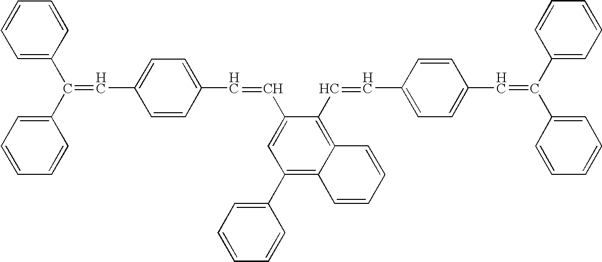 |
| (1-15) | 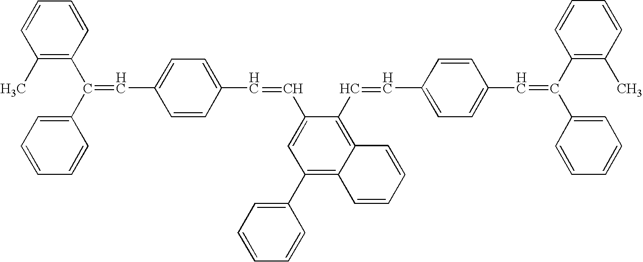 |
| (1-16) | 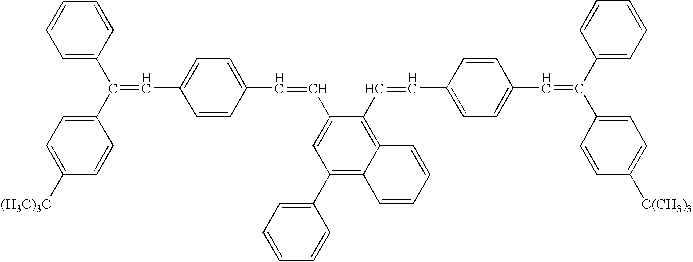 |

TABLE 5

| Compound No. | Formula |
|---|---|
| (1-17) | 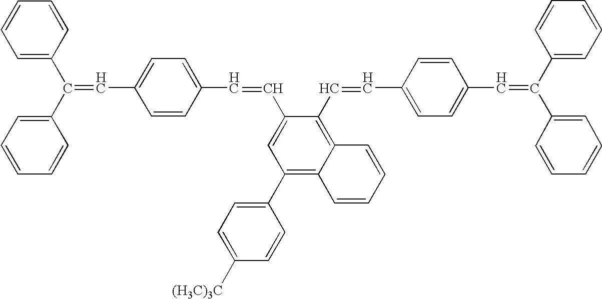 |
| (1-18) | 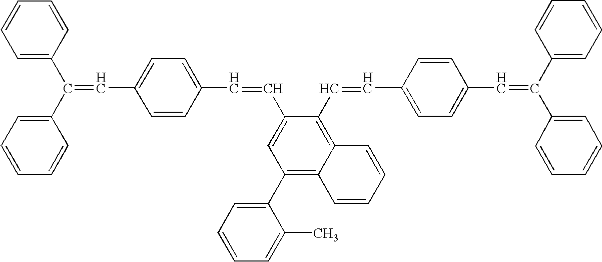 |
| (1-19) | 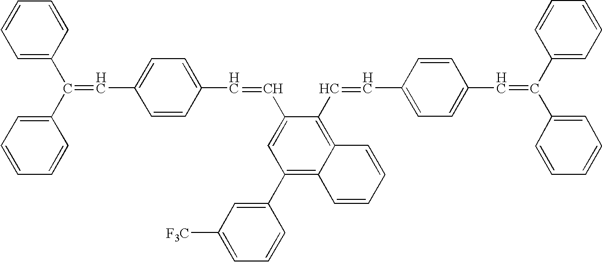 |
| (1-20) | 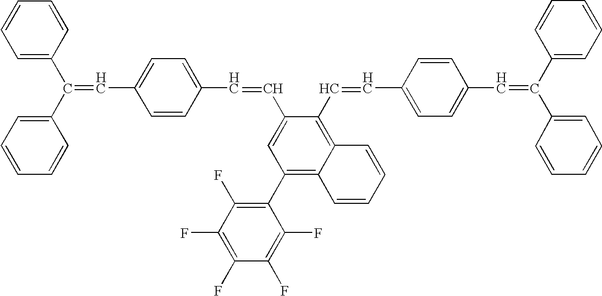 |

TABLE 6

| Compound No. | Formula |
|---|---|
| (1-21) | 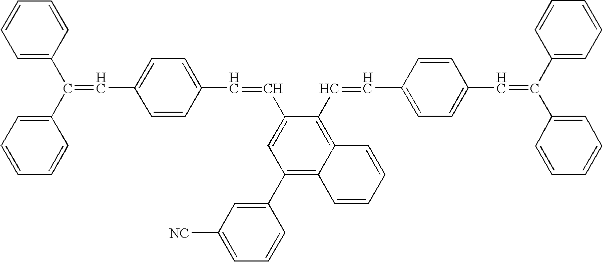 |
| (1-22) | 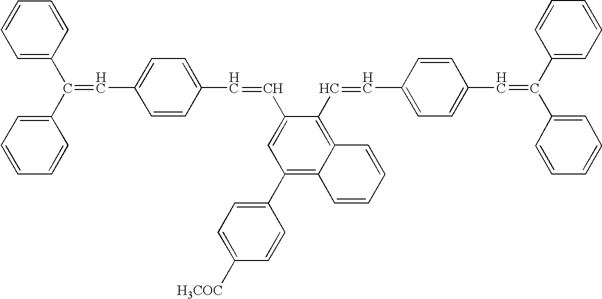 |
| (1-23) | 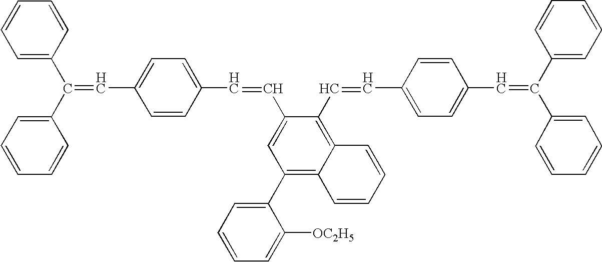 |
| (1-24) | 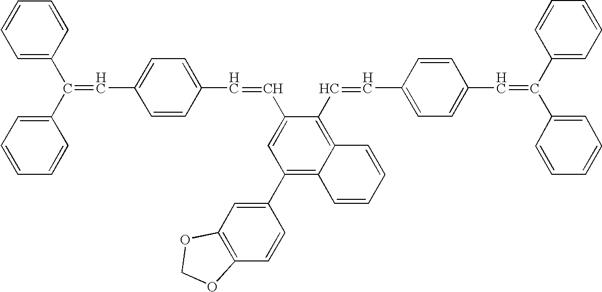 |

TABLE 7

| Compound No. | Formula |
|---|---|
| (1-25) | 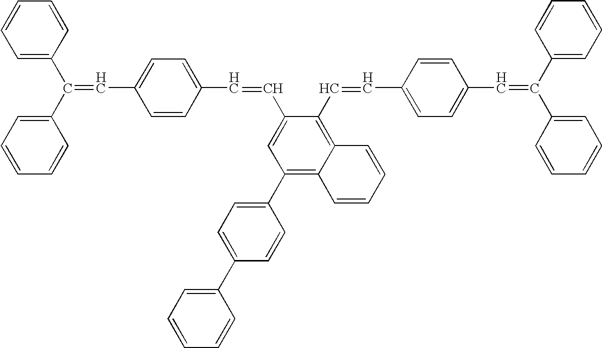 |
| (1-26) | 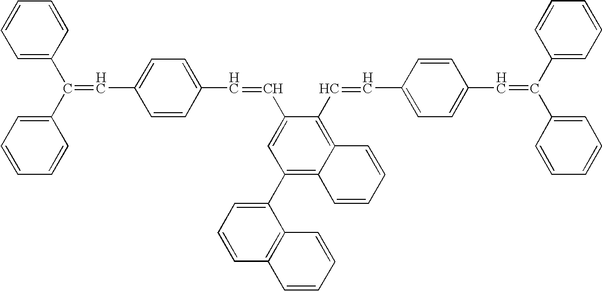 |
| (1-27) | 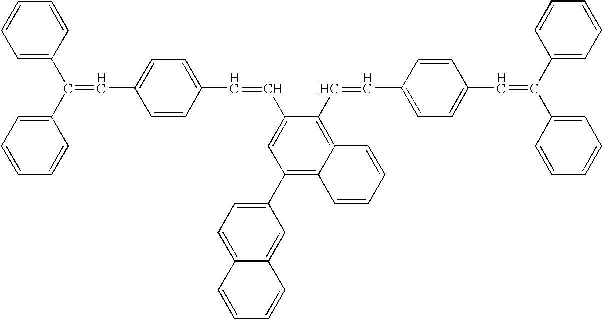 |
| (1-28) | 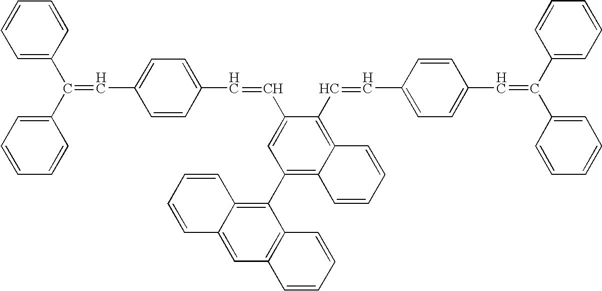 |

TABLE 8

| Compound No. | Formula |
|---|---|
| (1-29) | 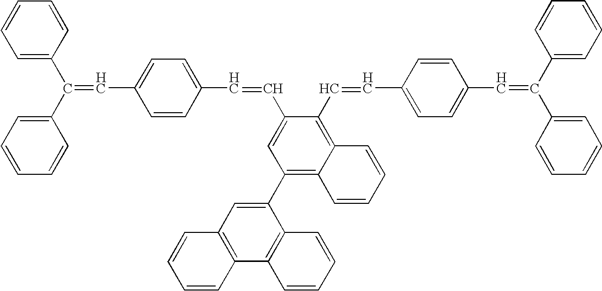 |
| (1-30) | 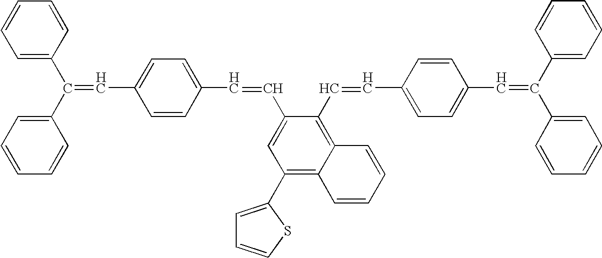 |
| (1-31) | 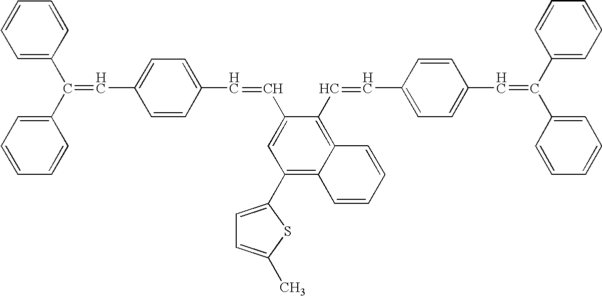 |
| (1-32) | 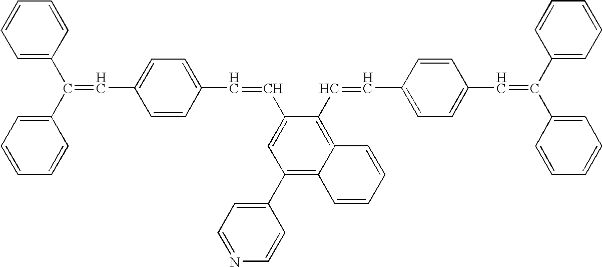 |

TABLE 9

| Compound No. | Formula |
|---|---|
| (1-33) | 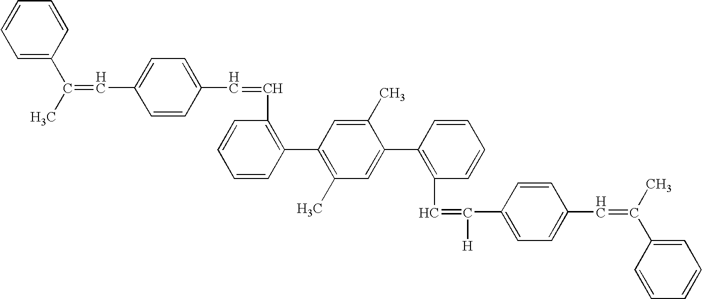 |
| (1-34) | 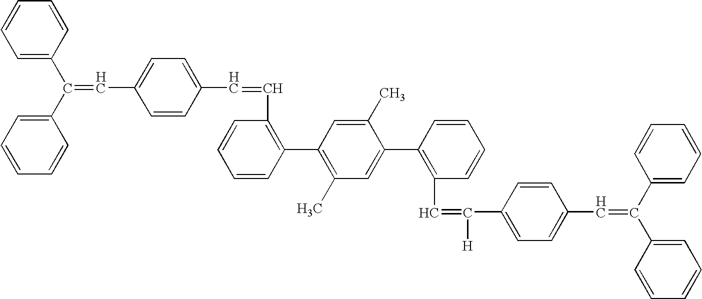 |
| (1-35) | 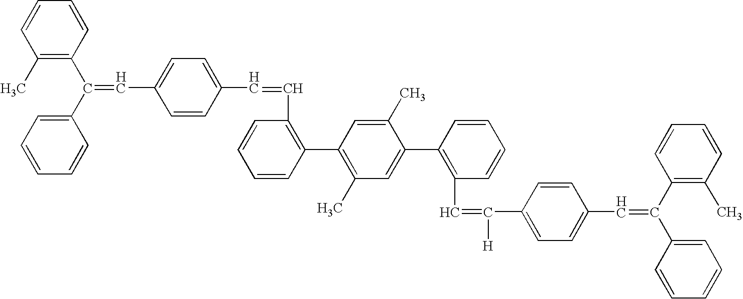 |
| (1-36) | 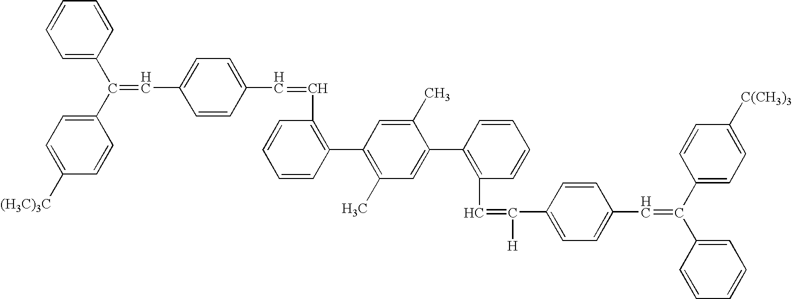 |

TABLE 10

| Compound No. | Formula |
|---|---|
| (1-37) | 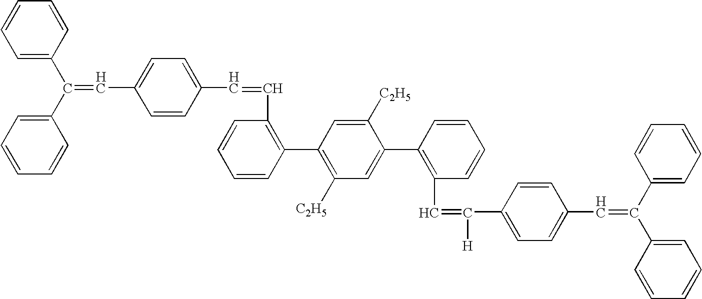 |
| (1-38) | 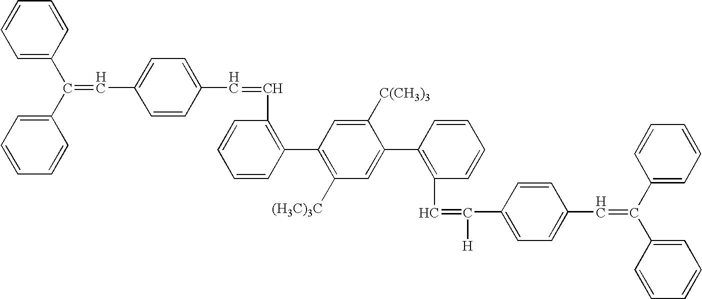 |
| (1-39) | 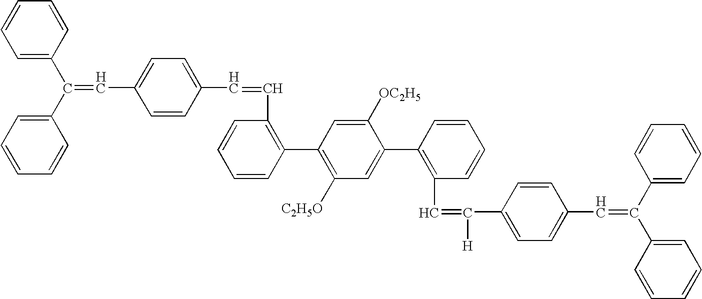 |
| (1-40) | 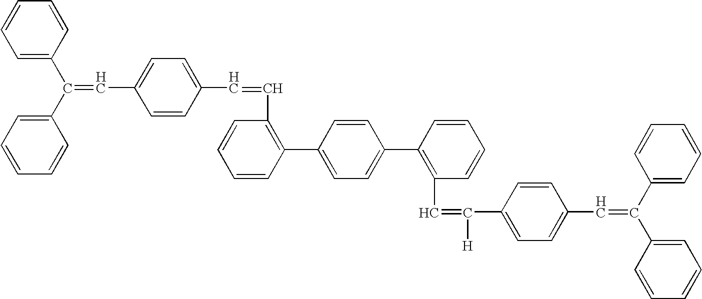 |

TABLE 11

| Com- | |
|---|---|
| pound | |
| No. | Formula |
| (1-41) | 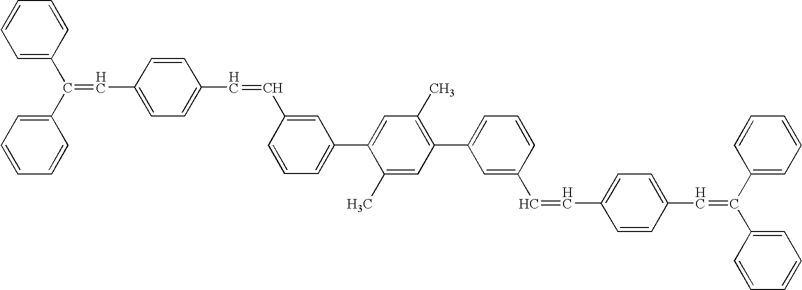 |
| (1-42) | 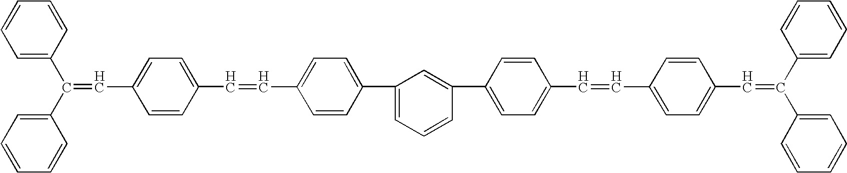 |
| (1-43) | 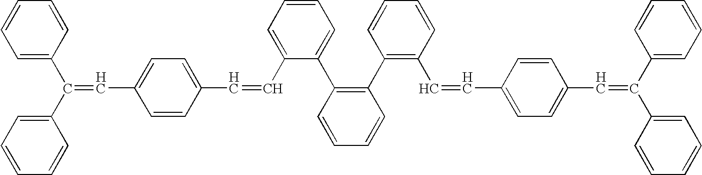 |
| (1-44) | 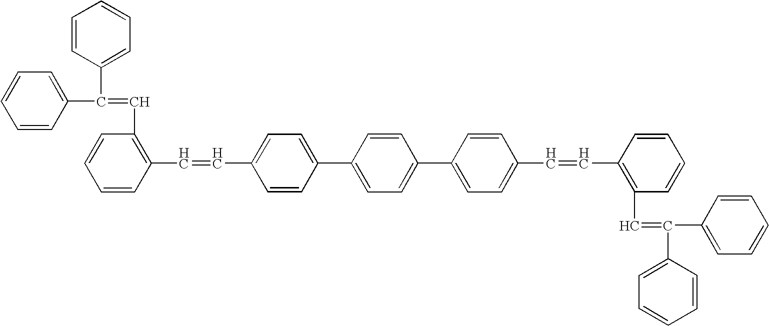 |

TABLE 12

| Com- | |
|---|---|
| pound | |
| No. | Formula |
| (1-45) | 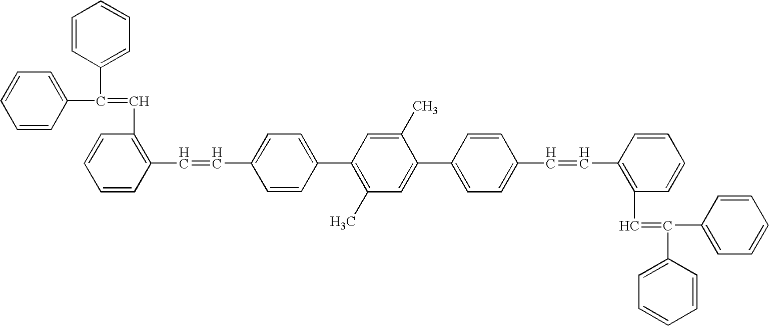 |
| (1-46) | 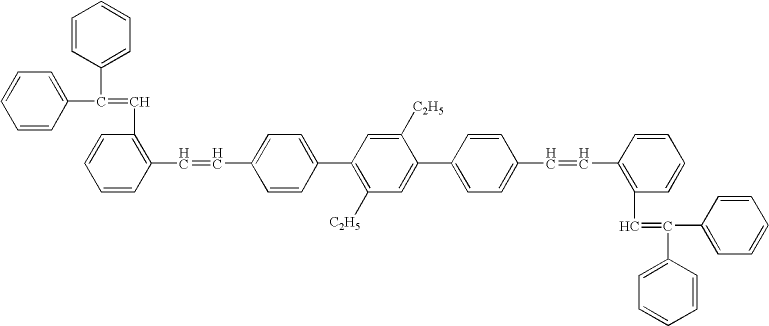 |
| (1-47) | 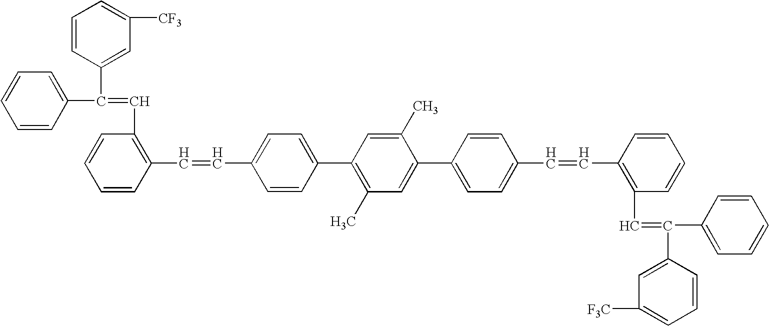 |
| (1-48) | 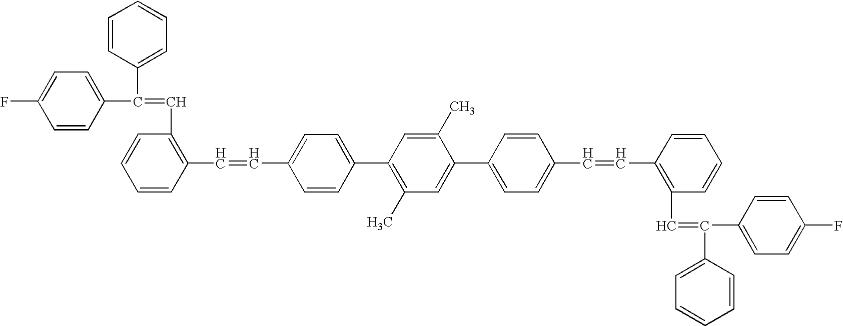 |

TABLE 13

| Compound | |
|---|---|
| No. | Formula |
| (1-49) | 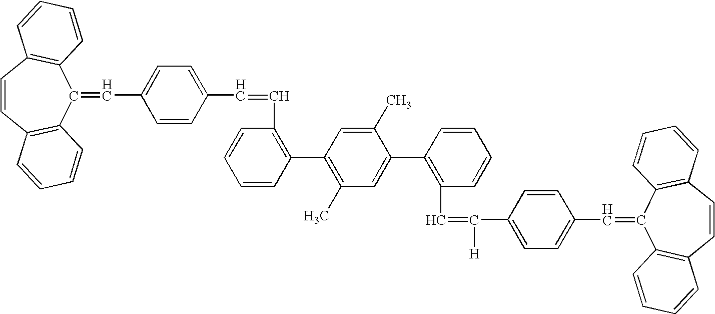 |
| (1-50) | 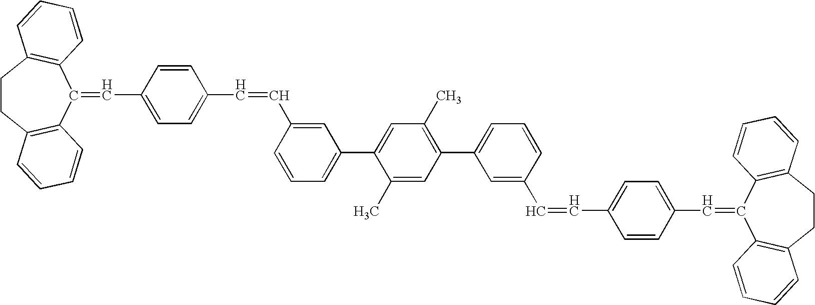 |
| (1-51) | 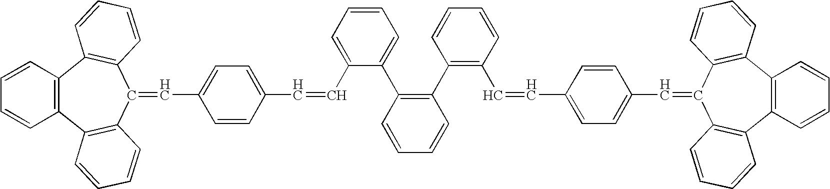 |
| (1-52) | 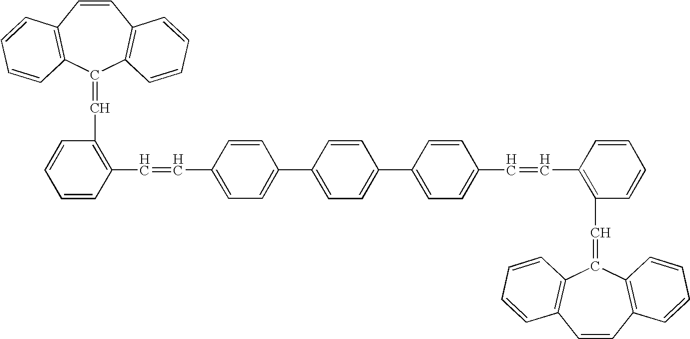 |

TABLE 14

| Compound No. | Formula |
|---|---|
| (1-53) | 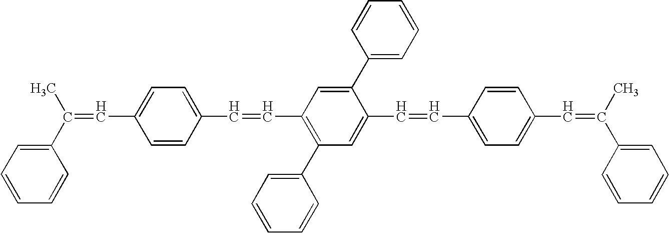 |
| (1-54) | 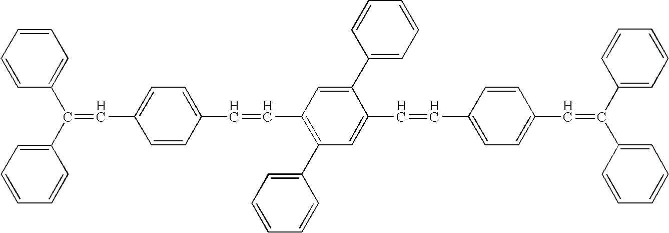 |
| (1-55) | 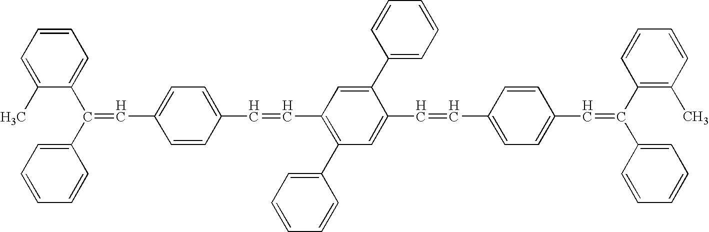 |
| (1-56) | 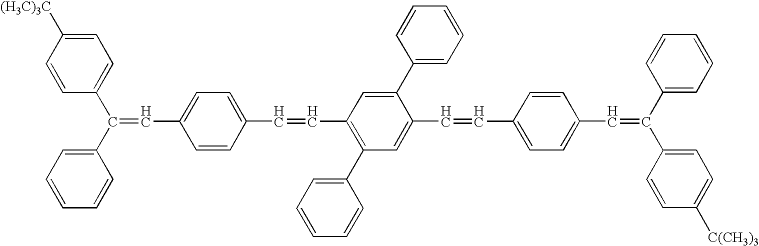 |

TABLE 15

| Compound No. | Formula |
|---|---|
| (1-57) | 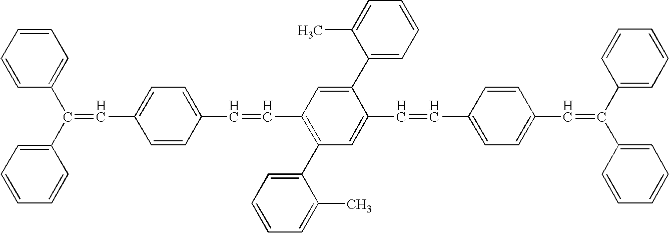 |
| (1-58) | 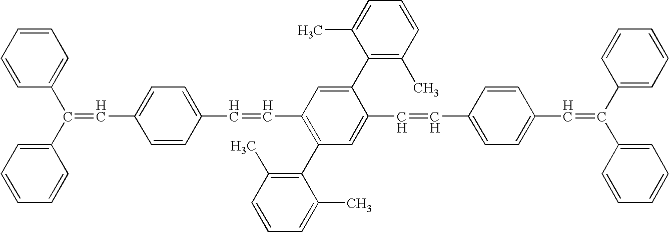 |
| (1-59) | 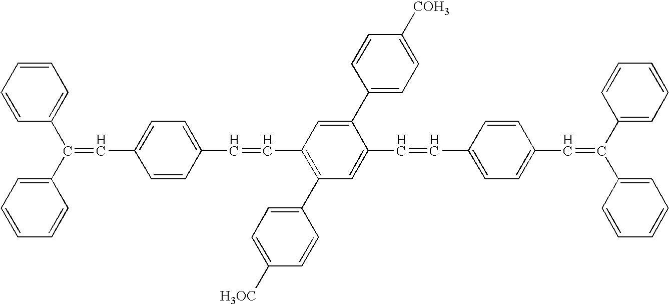 |
| (1-60) | 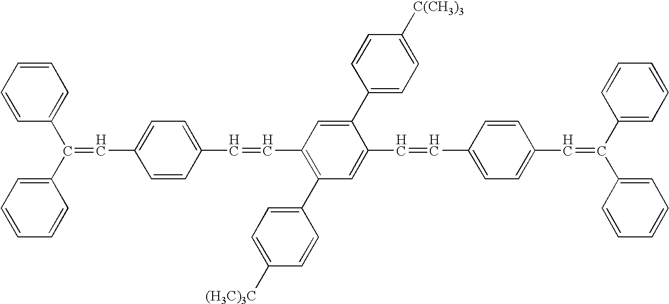 |

TABLE 16

| Compound No. | Formula |
|---|---|
| (1-61) | 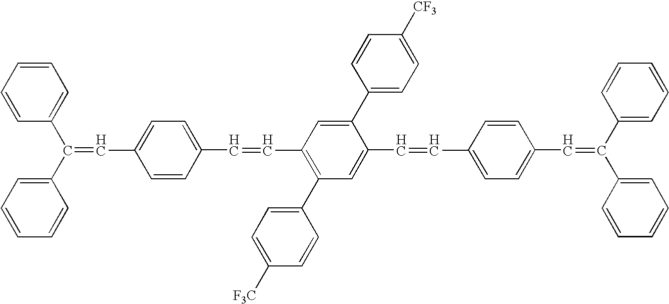 |
| (1-62) | 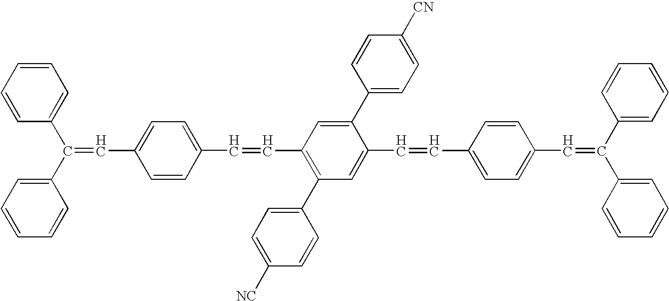 |
| (1-63) | 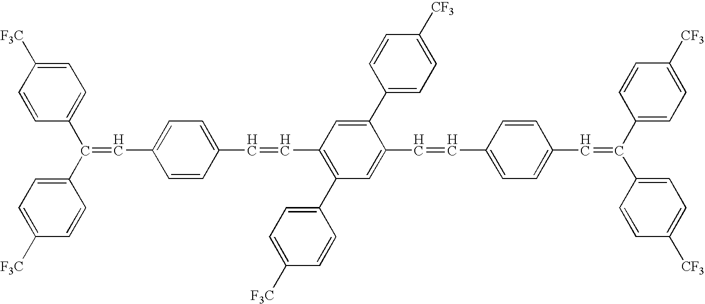 |
| (1-64) | 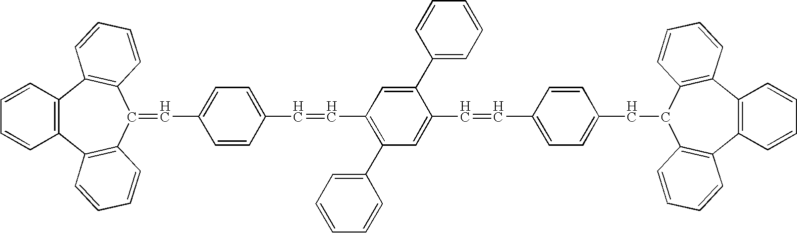 |

TABLE 17

| Compound No. | Formula |
|---|---|
| (1-65) | 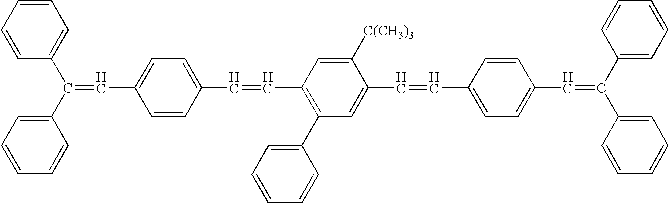 |
| (1-66) | 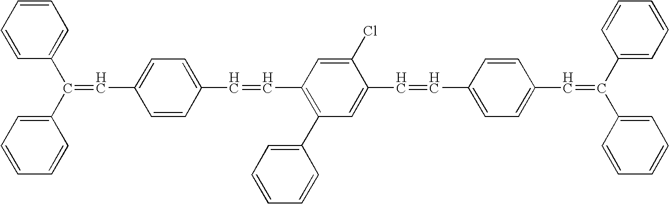 |
| (1-67) | 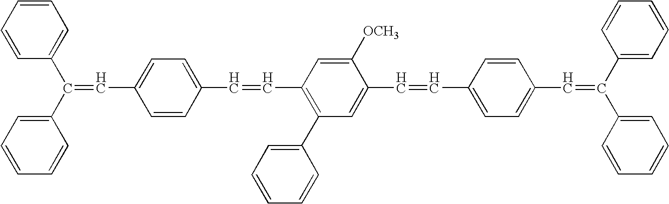 |
| (1-68) | 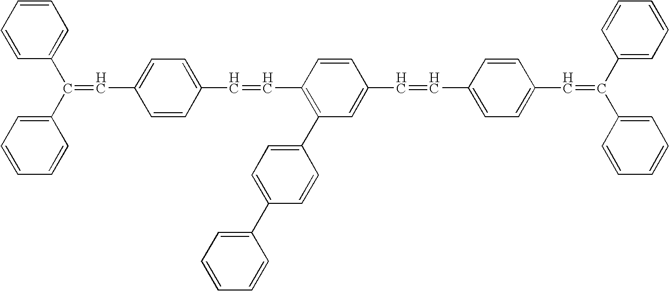 |

TABLE 18

| Compound No. | Formula |
|---|---|
| (1-69) | 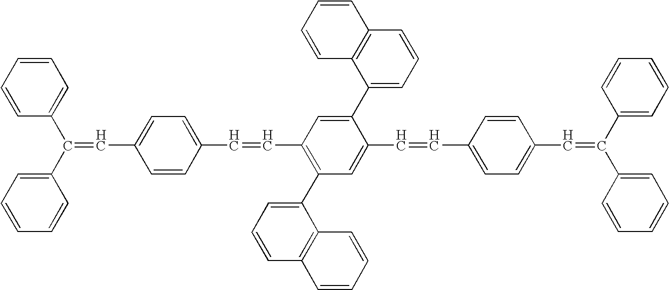 |
| (1-70) | 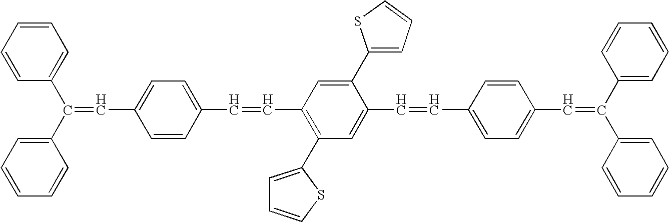 |
| (1-71) | 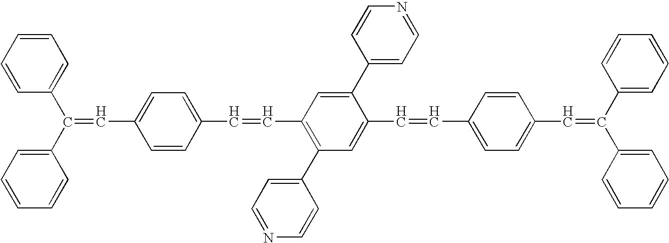 |
| (1-72) | 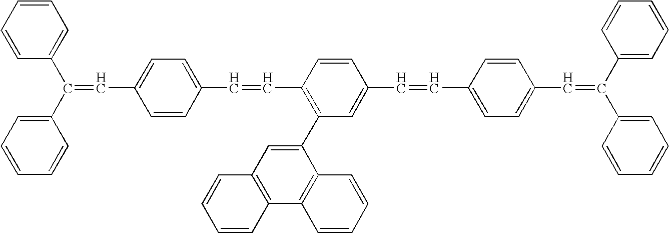 |

TABLE 19

| Compound No. | Formula |
|---|---|
| (1-73) | 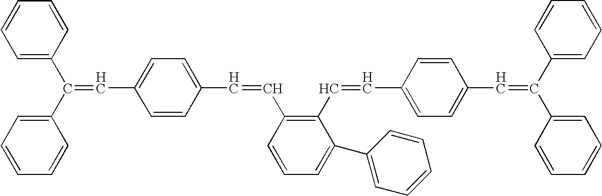 |
| (1-74) | 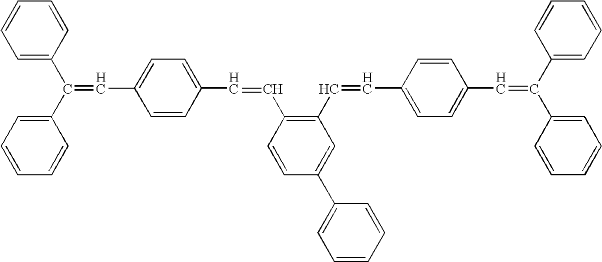 |
| (1-75) | 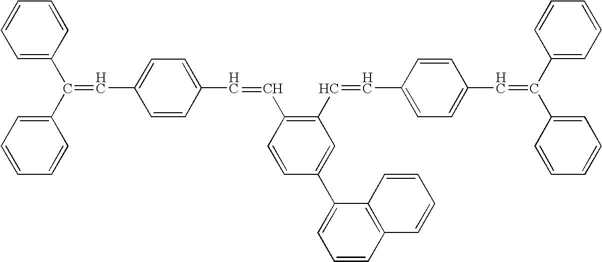 |
| (1-76) | 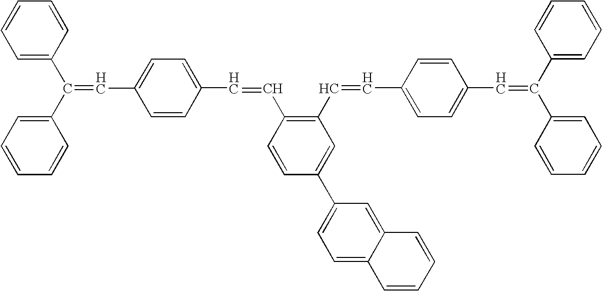 |

TABLE 20

| Compound No. | Formula |
|---|---|
| (1-77) | 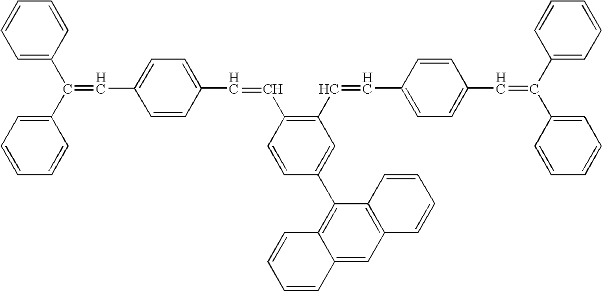 |
| (1-78) | 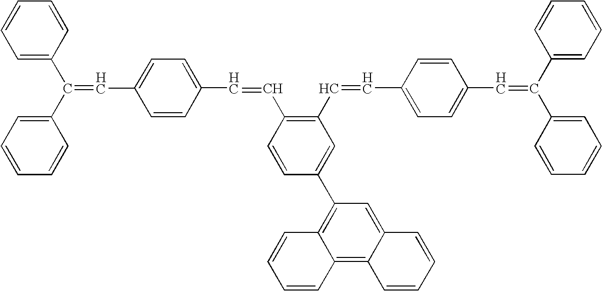 |
| (1-79) | 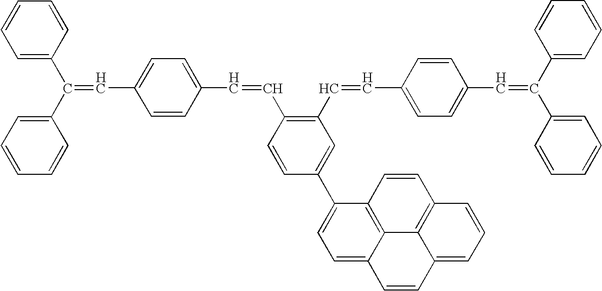 |
| (1-80) | 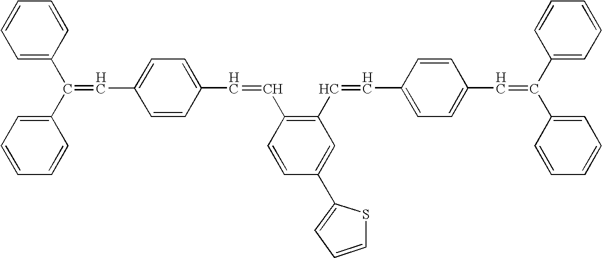 |

TABLE 21

| Compound No. | Formula |
|---|---|
| (1-81) | 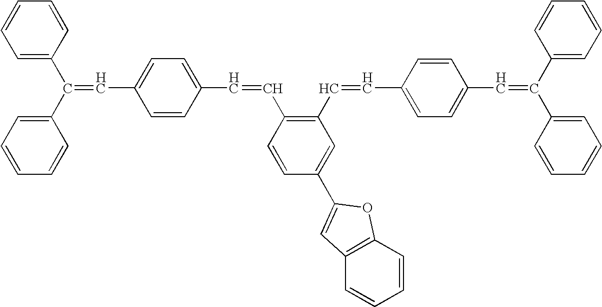 |
| (1-82) | 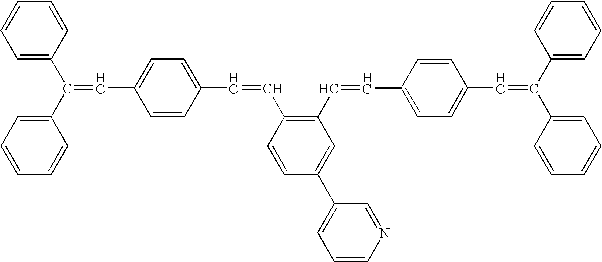 |
| (1-83) | 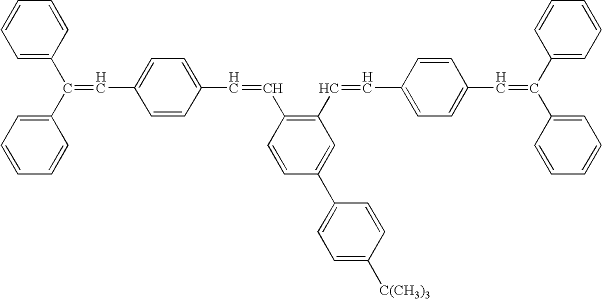 |
| (1-84) | 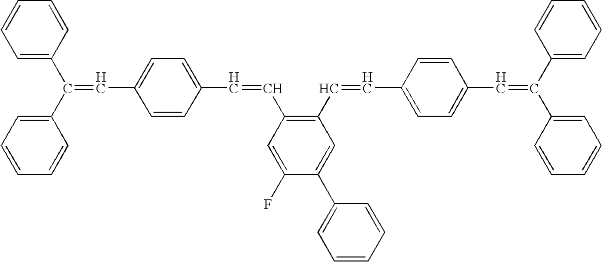 |

TABLE 22

| Compound No. | Formula |
|---|---|
| (1-85) | 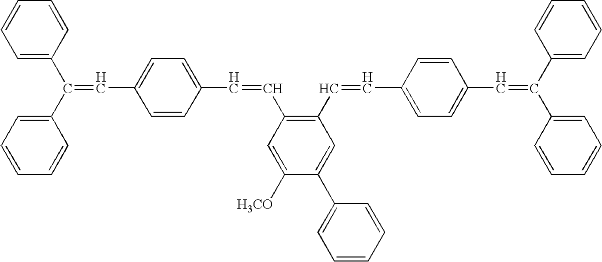 |
| (1-86) | 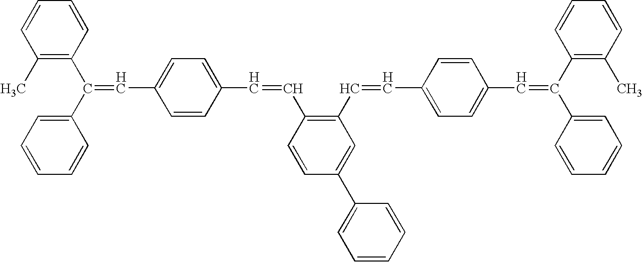 |
| (1-87) | 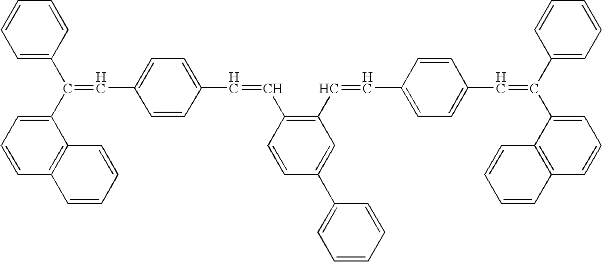 |
| (1-88) | 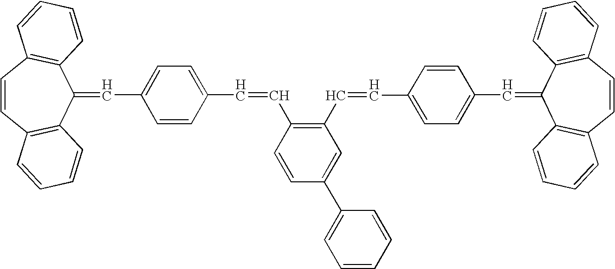 |

TABLE 23

| Compound No. | Formula |
|---|---|
| (1-89) | 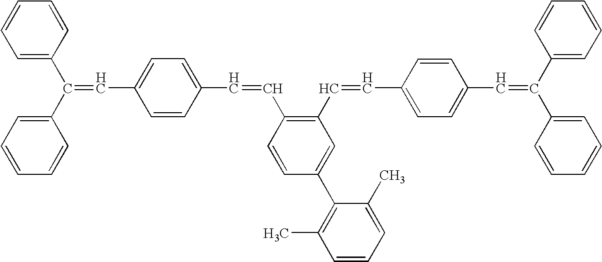 |
| (1-90) | 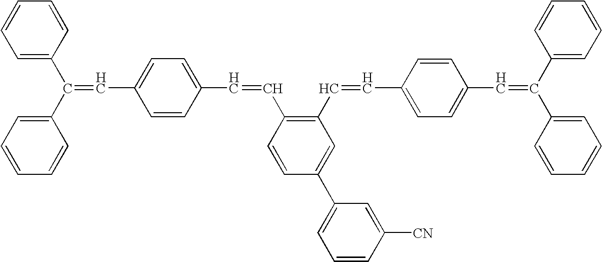 |
| (1-91) | 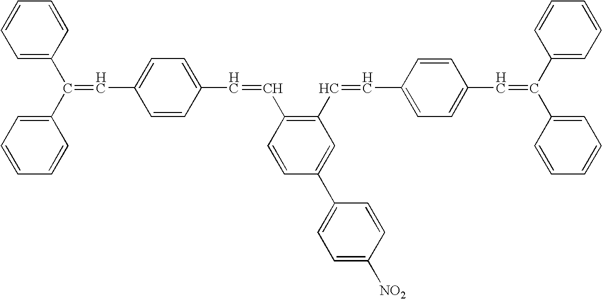 |
| (1-92) | 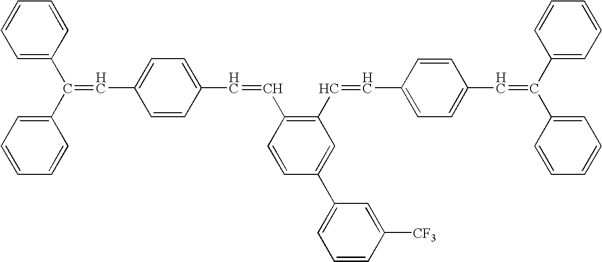 |

TABLE 24

| Compound No. | Formula |
|---|---|
| (2-01) | 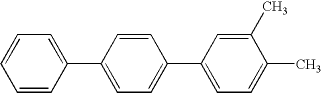 |
| (2-02) | 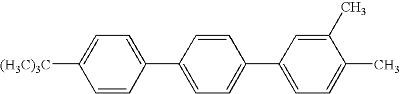 |
| (2-03) | 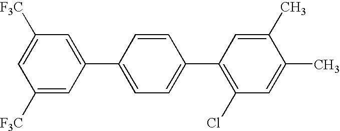 |
| (2-04) | 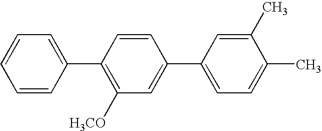 |

TABLE 25

| Compound No. | Formula |
|---|---|
| (2-05) | 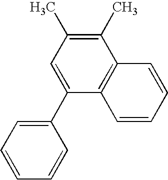 |
| (2-06) | 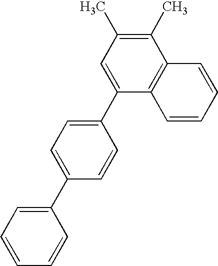 |
| (2-07) | 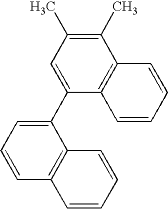 |
| (2-08) | 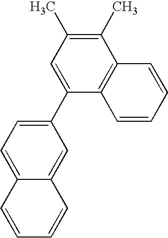 |

TABLE 26

| Compound No. | Formula |
|---|---|
| (2-09) | 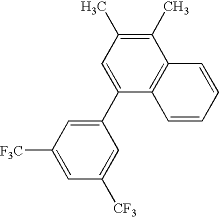 |
| (2-10) | 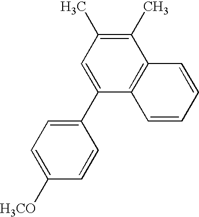 |
| (2-11) | 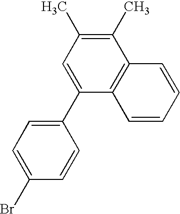 |
| (2-12) | 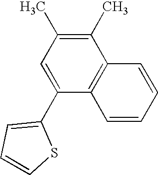 |

TABLE 27

| Compound No. | Formula |
|---|---|
| (2-13) | 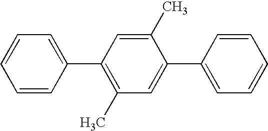 |
| (2-14) | 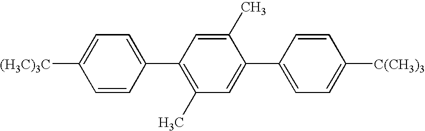 |
| (2-15) | 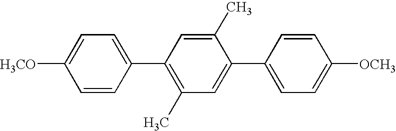 |
| (2-16) | 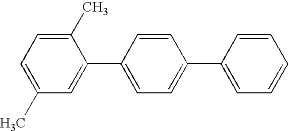 |

TABLE 28

| Com- | |
|---|---|
| pound No. | Formula |
| (2-17) | 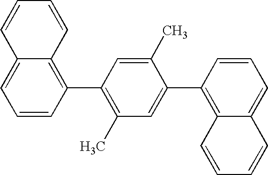 |
| (2-18) | 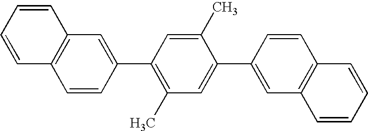 |
| (2-19) | 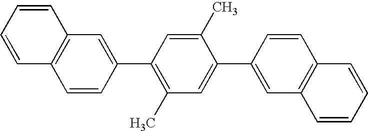 |
| (2-20) | 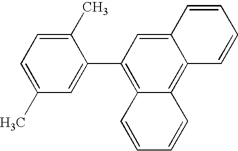 |

TABLE 29

| Compound No. | Formula |
|---|---|
| (3-01) | 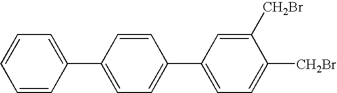 |
| (3-02) | 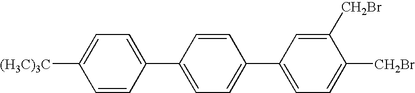 |
| (3-03) | 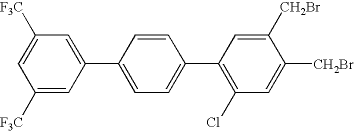 |
| (3-04) | 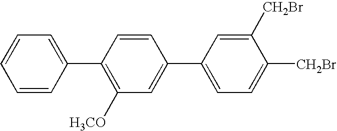 |

TABLE 30

| Compound No. | Formula |
|---|---|
| (3-05) | 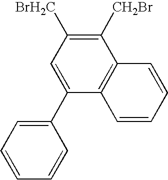 |
| (3-06) | 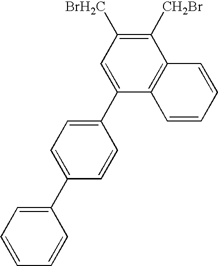 |
| (3-07) | 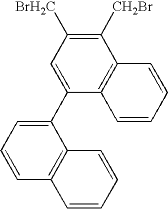 |
| (3-08) | 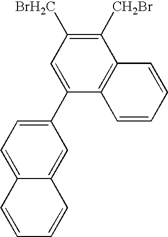 |

TABLE 31

| Compound No. | Formula |
|---|---|
| (3-09) | 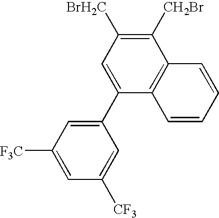 |
| (3-10) | 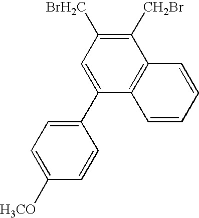 |
| (3-11) | 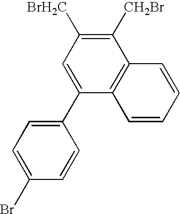 |
| (3-12) | 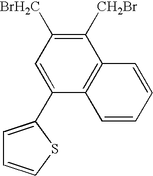 |

TABLE 32

| Compound No. | Formula |
|---|---|
| (3-13) | 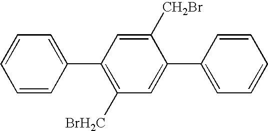 |
| (3-14) | 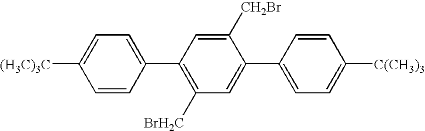 |
| (3-15) | 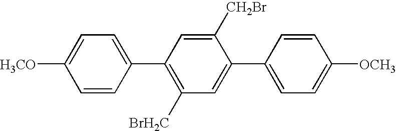 |
| (3-16) | 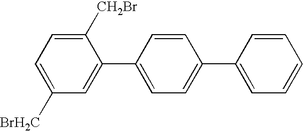 |

TABLE 33

| Com- | |
|---|---|
| pound | |
| No. | Formula |
| (3-17) | 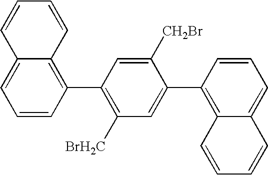 |
| (3-18) | 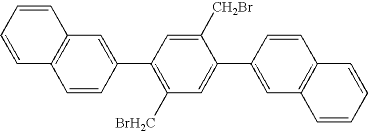 |
| (3-19) | 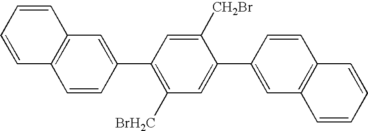 |
| (3-20) | 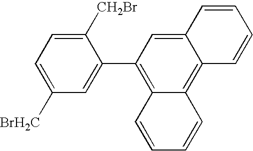 |

TABLE 34

| Compound No. | Formula |
|---|---|
| (5-01) | 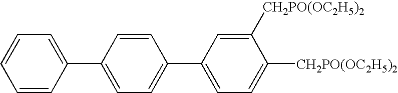 |
| (5-02) | 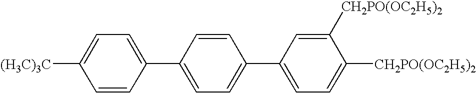 |
| (5-03) | 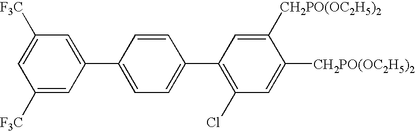 |
| (5-04) | 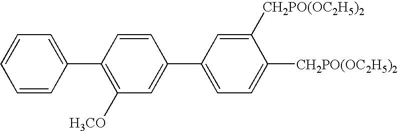 |

TABLE 35

| Compound No. | Formula |
|---|---|
| (5-05) | 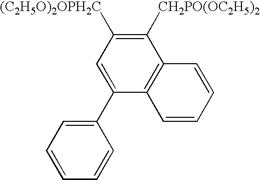 |
| (5-06) | 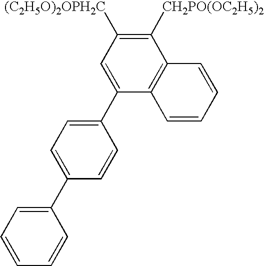 |
| (5-07) | 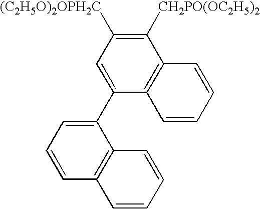 |
| (5-08) | 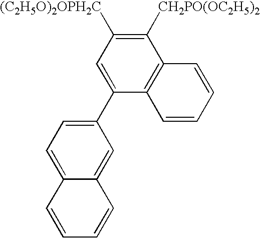 |

TABLE 36

| Compound No. | Formula |
|---|---|
| (5-09) | 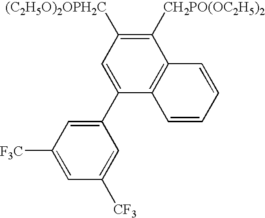 |
| (5-10) | 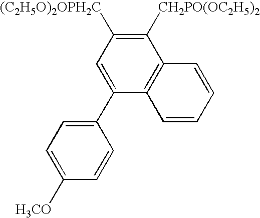 |
| (5-11) | 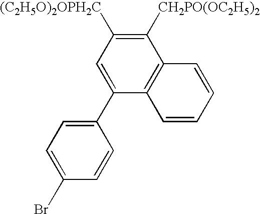 |
| (5-12) | 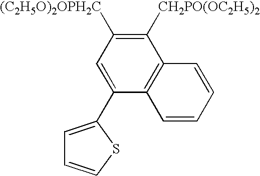 |

TABLE 37

| Compound No. | Formula |
|---|---|
| (5-13) | 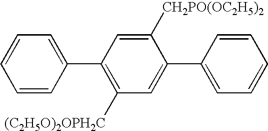 |
| (5-14) | 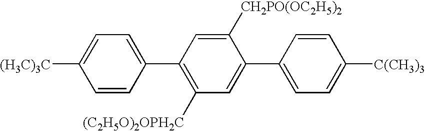 |
| (5-15) | 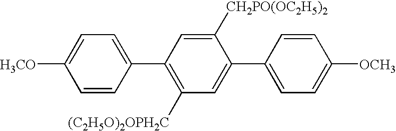 |
| (5-16) | 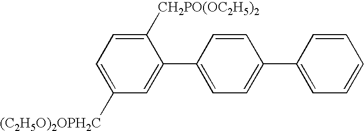 |

TABLE 38

| Com- | |
|---|---|
| pound | |
| No. | Formula |
| (5-17) | 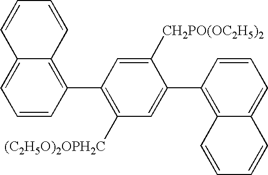 |
| (5-18) | 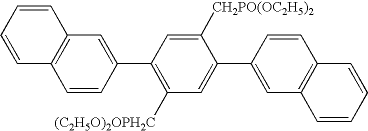 |
| (5-19) | 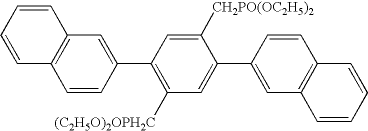 |
| (5-20) | 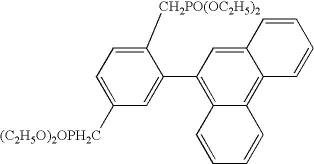 |

TABLE 39

| Com- | |
|---|---|
| pound | |
| No. | Formula |
| (19-01) | 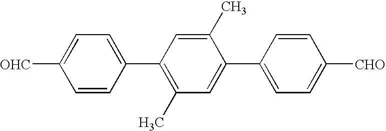 |
| (19-02) | 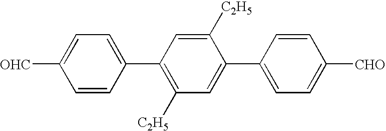 |
| (19-03) | 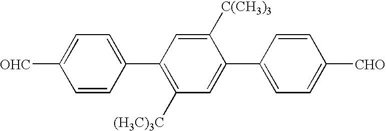 |
| (19-04) | 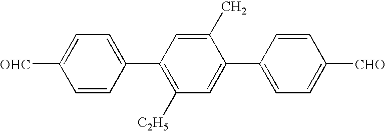 |

TABLE 40

| Compound No. | Formula |
|---|---|
| (19-05) | 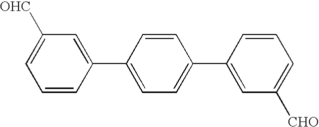 |
| (19-06) | 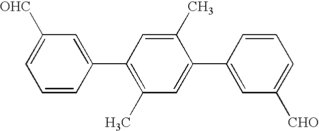 |
| (19-07) | 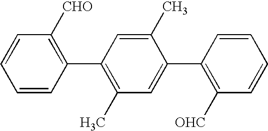 |
| (19-08) | 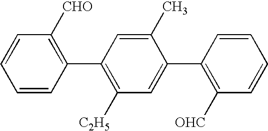 |

TABLE 41

| Compound No. | Formula |
|---|---|
| (19-09) | 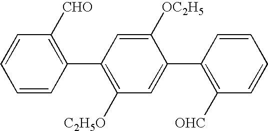 |
| (19-10) | 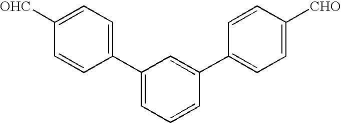 |
| (19-11) | 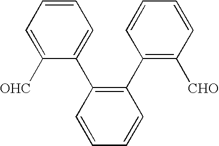 |
| (19-12) | 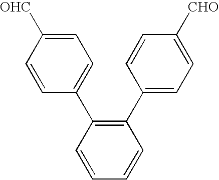 |

The organic electroluminescent element of the present invention comprises a layer containing the compound represented by the formula (1). The organic electroluminescent element of the present invention may be in a variety of embodiments, and may basically have a pair of electrodes (cathode and anode), and a luminescence layer interposed therebetween containing the compound represented by the formula (1). Further, the element may optionally have a positive hole-transporting layer and an electron-transporting layer, which may further improve the luminescent property of the element in most of cases. The organic electroluminescent element of the present invention may preferably comprise a substrate for supporting the layers.

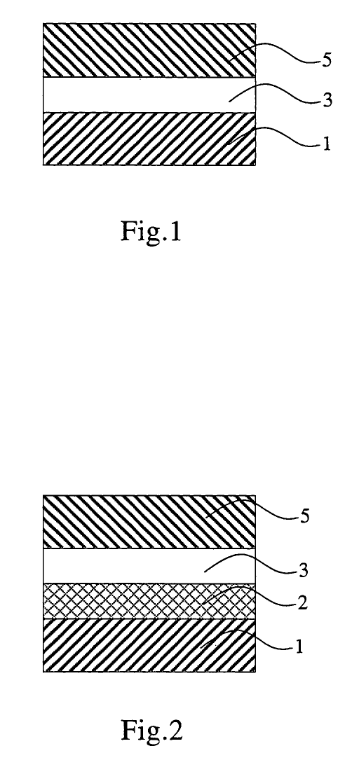

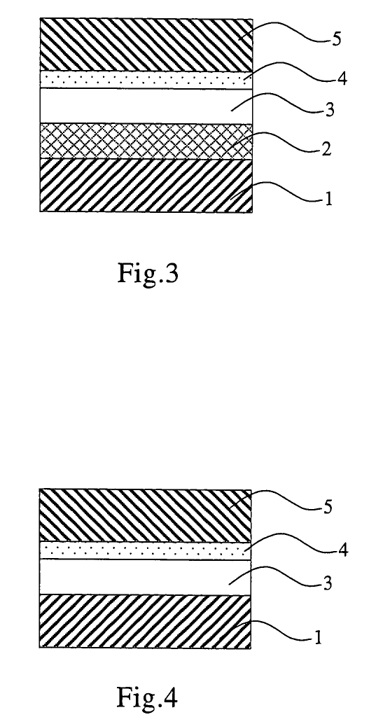

Embodiments of the organic electroluminescent element of the present invention may specifically include (1) an element of the structure shown in FIG. 1 having an anode, a luminescent layer and a cathode, (2) an element of the structure shown in FIG. 2 having an anode, a positive hole-transporting layer, a luminescent layer and a cathode, (3) an element of the structure shown in FIG. 3 having an anode, a positive hole-transporting layer, a luminescent layer, an electron-transporting layer and a cathode, and (4) an element of the structure shown in FIG. 4 having an anode, a luminescent layer, an electron-transporting layer and a cathode.

There is no particular limitation as to the substrate. For example, a glass, a transparent plastic or a silica may be used as the substrate. The material, thickness and shape of the substrate may suitably be selected or determined depending on the requirements for the construction of the element.

The anode may be of a metal, an alloy, an electroconductive substance or combinations thereof having a relatively high work function. Examples of such electrodes may include metals such as Au, and dielectric transparent materials such as CuI, ITO, SnO₂ and ZnO. The anode may usually be produced by vapor deposition or sputtering to be in the form of a thin layer. The sheet resistivity as an electrode may preferably be several hundreds of ohms per square, or less. The thickness of the anode may depend on the material thereof and usually be selected in a range of about 10 nm to 500 nm, and preferably 20 nm to 300 nm.

The cathode may be of a metal, an alloy, an electroconductive substance or combinations thereof having a relatively low work function. Examples of such electrodes may include sodium, sodium-potassium alloy, magnesium, lithium, magnesium/copper mixture, Al/AlO₂, and indium. Similar to the anode, the cathode may also be produced by vapor deposition or sputtering to be in the form of a thin layer. The sheet resistivity as an electrode may preferably be several hundreds of ohms per square, or less. The thickness of the cathode may usually be selected in a range of about 50 nm to 1000 nm, and preferably 100 nm to 500 nm.

The positive hole-transporting layer is a layer consisting of a positive hole-transporting compound, and has a function for transporting and injecting into the luminescent layer a positive hole that has been injected from the anode. In addition to the function of injecting and transporting the electronic charge, the positive hole-transporting layer may further have other functions such as shielding function. There is no particular limitation as to the positive hole-transporting compound as long as it has the aforementioned function. The compound may arbitrarily be selected from various organic or inorganic materials such as those previously employed as positive hole-transporting compounds in organic photoconductive materials, and those publicly known as a positive hole-transporting compounds in an organic electroluminescent element. Examples of the organic material for use as the positive hole-transporting compound may include a triazole derivative, an oxadiazole derivative, an imidazole derivative, a polyaryl alkane derivative, a pyrazoline derivative, a pyrazolone derivative, a phenylenediamine derivative, an arylamine derivative, an amino-substituted chalcone derivative, an oxazole derivative, a styrylanthracene derivative, a fluorenone derivative, a hydrazone derivative, a stilbene derivative, a porphyrin derivative, an aromatic tertiary amine derivative and a styrylamine compound. Examples of the inorganic material for use as the positive hole-transporting compound may include Si, SiC, and CdS. As the positive hole-transporting layer, the element of the present invention may have only one layer containing one or more species of the positive hole-transporting compounds, or may be a plurality of layers that are laminated, each containing one or more species of the positive hole-transporting compounds. The positive hole-transporting layer may be produced by any of well-known film forming processes such as vapor deposition, sputtering or spin-coating. The film thickness thereof may usually be 10 nm to 1 μm, and preferably 20 nm to 500 nm.

The electron-transporting layer is a layer consisting of an electron-transporting compound, and has a function for transporting and injecting into the luminescent layer an electron that has been injected from the cathode. In addition to the function of injecting and transporting the electronic charge, the electron-transporting layer may further have other functions such as shielding function. There is no particular limitation as to the electron-transporting compound as long as it has the aforementioned function. The compound may arbitrarily be selected from the publicly known compounds. Examples of the electron-transporting compound may include organic materials such as a nitro-substituted fluorenone derivative, a thiopyran dioxide derivative, a diphenoquinone derivative, an anthraquinonedimethane derivative, a fluorenylidenemethane derivative, and an anthrone derivative; and inorganic materials such as Si, SiC and CdS. As the electron-transporting layer, the element of the present invention may have only one layer containing one or more species of the electron-transporting compounds, or may be a plurality of layers that are laminated, each containing one or more species of the electron-transporting compounds. The electron-transporting layer may be produced by any of well known film forming processes such as vapor deposition, sputtering or spin-coating. The film thickness thereof may usually be 10 nm to 1 μm, and preferably 20 nm to 500 nm.

The luminescent layer has a function of receiving the electron and positive hole injected from the electrodes or the positive hole-transporting layer and the electron-transporting layer, and emitting light by their recombination. The compound of the formula (1) is particularly suitable for the luminescent layer, and mainly used in this layer. The luminescent layer may contain as the luminescent material only the compound of the formula (1), or may contain other luminescent material such as those publicly known in addition to the compound of the formula (1). The element of the present invention may have as the luminescent layer only one layer containing one luminescent material or a mixture of two or more of the luminescent materials, or a plurality of layers, provided that at least any one of the layers contains the compound of the formula (1).

The luminescent layer may have a so-called “guest-host” construction in which a host compound is doped with a relatively small amount of a guest compound. This construction may contribute to improvement of the luminescent efficiency and driving durability. In the guest-host luminescent layer, the luminescent mainly occurs in the guest compound. In the present element, the guest-host luminescent layer may contain the compound of the formula (1) as the guest compound and/or the host compound. In the guest-host luminescent layer, the guest compound may preferably have a smaller energy gap than the host compound, and preferably has a strong fluorescence. Such a guest compound maybe the compound of the formula (1), as well as various fluorescent dyes and laser pigments, preferably a coumarin derivative or a condensed ring compound. The host compound may be the compound of the formula (1) as well as an aromatic distyryl compound and a metal complex of 8-hydroxyquinoline. Ratio of the guest compound with respect to the host compound may be in the range in which concentration quenching is avoided, and may preferably be about 0.01 to 40 mol per 100 mol of the host compound. Provided that at least one layer contains the compound of the formula (1), the element of the present invention may have both one or more guest-host luminescent layers and one or more luminescent layers of other construction. The sort of the luminescent materials such as host and guest compounds in each layer and the composition ratio thereof may be the same or different.

The luminescent layer may be formed by any of the generally used film forming methods such as vapor deposition or spin coating. The thickness thereof may usually be 10 nm to 500 nm, and preferable 20 nm to 200 nm.

As described above, the compound represented by the formula (1) according to the present invention is useful as a constitutional material of an organic electroluminescent element, particularly as a luminescent material thereof. The compounds and the production method therefor provided by the present invention make a great contribution to production of an organic electroluminescent element having high brightness and high durability.

### EXAMPLES OF THE INVENTION

The present invention will be described more in detail with reference to the Examples, but the present invention is not limited thereto.

### Example 1

Production of Compound No. 2-01

Under an argon stream, 4.21 g of 1,2-dimethyl-4-iodobenzene, 3.60 g of 4-biphenylboronic acid, 11.0 g of tetrakis(triphenylphosphine) palladium(0), 20 ml of ethanol, 50 ml of toluene, and an aqueous solution of sodium carbonate (made of 3.85 g of sodium carbonate and 15.4 g of water) were mixed. The mixture was heated to reflux with stirring for 16 hours. After cooling, extraction with diethyl ether was performed. The ether layer was washed with water and then dried with anhydrous sodium sulfate. Ether was then distilled off under the reduced pressure, to obtain brownish crystals. The crystals were twice re-crystallized from ethanol and dried in vacuo at 60° C. to obtain 2.14 g of white crystals (yield 46%). The melting point thereof was 128.0 to 136.0° C.

### Example 2

Production of Compound No. 3-01

2.14 g of the compound No. 2-01 obtained in the above, 2.98 g of N-bromosuccinimide, 0.2 g of benzoyl peroxide (containing 25% water), and 40 ml of carbon tetrachloride were mixed. The mixture was heat to reflux with vigorous stirring for 4 hours. After cooling, the mixture was admixed with about 100 ml of diethyl ether and then filtered. The filtered liquid was concentrated under the reduced pressure to obtain pale brown powders. The powders were re-crystallized from ethanol to obtain 1.07 g of white crystals (yield 31%). The melting point thereof was 120 to 170° C. with decomposition.

### Example 3

Production of Compound No. 5-01

1.07 g of the compound 3-01 obtained in the above, and 2.14 g of triethyl phosphite were mixed and heated at 140 to 145° C. for 3 hours with stirring. After cooling, triethyl phosphite in excess and generated ethyl bromide were distilled off under the reduced pressure, to obtain 1.23 g of white crystals.

### Example 4

Production of Compound No.1-02 (#1)

1.23 g of the compound 5-01 obtained in the above, and 1.32 g of 4-(2,2-diphenylvinyl)benzaldehyde were dissolved in 14 ml of N,N-dimethylformamide. 0.6 g of potassium tert-butoxide was gradually added thereto under ice cooling, and then stirred at room temperature for 24 hours, to obtain a reaction mixture. The reaction mixture was then admixed with 2 ml of acetic acid and then poured into about 150 ml of ethanol. The precipitates were recovered by filtration, washed with ethanol and then with water, and dried, to obtain yellow powders as a crude product. The yellow powders were then subjected to column chromatography with activated alumina as a stationary phase and a mixture solvent of toluene and acetone as a mobile phase, to fractionate a yellow substance. The yellow substance was again subjected to column chromatograph with silica gel as a stationary phase and toluene as a mobile phase, to obtain 0.19 g of yellow crystals (yield 10%). The melting point thereof was 215.5 to 217.5° C. The elementary analysis of this product resulted in 94.02% carbon (theoretical value as compound 1-02: 94.14%), and 5.81% hydrogen (theoretical value as compound 1-02: 5.86%). In infrared absorption spectrum (KBr tablet), stretching vibration due to aromatic rings was recognized at around 1600 cm⁻¹. In proton nuclear magnetic resonance spectrum (solvent CDCl₃, internal standard TMS), ring protons of aromatic rings and alkene protons were recognized at δ=6.9 to 7.8 ppm (46H). In mass spectrum, a molecular ion peak m/z=790 was recognized. From these results, it was confirmed that the compound thus obtained was compound No.1-02.

### Example 5

Production of Compound No. 1-02 (#2)

A mixture consisting of 1.47 g of an aldehyde represented by the following formula, 1.83 g of diethyl diphenylmethylphosphonate, and 20 ml of N,N-dimethylformamide were prepared. 0.78 g of potassium tert-butoxide was gradually added thereto under ice cooling, and then stirred at room temperature for 24 hours, to obtain a reaction mixture. The reaction mixture was then treated in the same way as in Example 4, to obtain compound No.1-02.

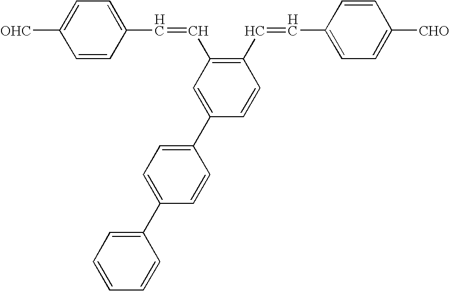

### Example 6

Production of Compound No. 1-02 (#3)

A mixture consisting of 2.20 g of a phosphonate represented by the following formula, 1.09 g of benzophenone, and 20 ml of N,N-dimethylformamide were prepared. 0.78 g of potassium tert-butoxide was gradually added thereto under ice cooling. Reaction was then effected at room temperature for 24 hours, to obtain a reaction mixture. The reaction mixture was then treated in the same way as in Example 4, to obtain compound No.1-02.

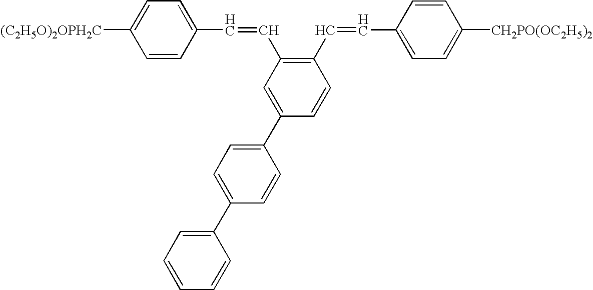

### Example 7

Production of Compound No.1-02 (#4)

Under an argon stream, 3.06 g of an iodobenzene derivative represented by the following formula, 0.79 g of 4-biphenylboronic acid, 0.14 g of tetrakis(triphenylphosphine) palladium(0), 4 ml of ethanol, 20 ml of toluene, and an aqueous solution of sodium carbonate (made of 0.85 g of sodium carbonate and 5 g of water) were mixed. The mixture was heated to reflux with stirring for 20 hours. After cooling, extraction with toluene was performed. The toluene layer was washed with water and then dried with anhydrous sodium sulfate. Toluene was then distilled off under the reduced pressure, to obtain a crude product as a residue. The crude product was treated in the same way as in Example 4, to obtain compound 1-02.

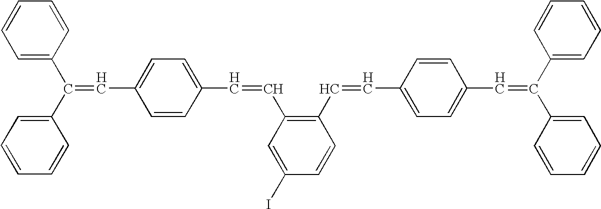

### Example 8

On an electrode of a glass substrate on which a thin layer of indium tin oxide that is a transparent electrode was previously formed as an anode (referred to hereinbelow as “ITO glass substrate”), a positive hole-transporting layer, a luminescent layer, an electron-transporting layer and an aluminum/lithium electrode (referred to hereinbelow as “Al/Li electrode”) as a cathode were formed in this order by vapor deposition, to produce the organic electroluminescent element of the present invention. Specifically, an ITO glass substrate, N,N′-bis[4′-(N,N-diphenylamino)-4-biphenylyl]-N,N′-diphenylbenzidine as a positive hole-transporting material, the aromatic methylidene compound No.1-02 as a luminescent material, and tris(8-hydroxyquinolino) aluminum (referred to hereinbelow as “Alq”) as an electron transporting material were placed in a vacuum vapor deposition system. The air was drawn out to 10⁻⁴ Pa. On the electrode of the ITO glass substrate, N,N′-bis[4′-(N,N-diphenylamino)-4-biphenylyl]-N,N′-diphenylbenzidine was vapor-deposited at the deposition rate of 0.1 to 0.5 nm/sec., to form a positive hole-transporting layer having a thickness of 50 nm. Subsequently, compound No.1-02 was vapor-deposited at the deposition rate of 0.1 to 0.5 nm/sec., to form a luminescent layer having a thickness of 50 nm. Alq was then deposited at the rate of 0.1 nm/sec., to form an electron transporting layer having a thickness of 10 nm. Further, deposition of Al/Li electrode was performed at the deposition rate of 0.5 nm/sec., to form the electrode having a thickness of 150 nm. These vapor deposition steps were performed continuously keeping the vacuum. The thickness of each layer was monitored with a quartz oscillator for controlling the thickness. After forming all of the layers, the electrode was immediately taken out in a dry nitrogen atmosphere, to produce the organic electroluminescent element. Application of a voltage to the element thus produced resulted in uniform light blue luminescent. Peak wavelength of the luminescent spectrum was at 490 nm. A current of 100 mA/cm² was applied to the element for measuring the drive voltage and luminescence intensity, which were found out to be 6.4V and 2900 cd/m², respectively. As an evaluation of the life of this element, a constant current of 2 mA/cm² was applied for constantly driving the element to measure the half life of the luminescence intensity. As a result, the luminescence intensity was reduced by half at the lapse of 520 hours.

### Comparative Example 1

An element was produced in the same way as in Example 8 except that 4,4′-bis(2,2-diphenylvinyl)biphenyl that is described in the Japanese Patent Publication JP-P-H03-231970A was employed as a luminescent material in place of the compound No.1-02. Application of a voltage to the element thus produced resulted in uniform blue luminescent. Peak wavelength of the luminescent spectrum was at 450 nm. When a current of 100 mA/cm² was applied to the element, the drive voltage and luminescence intensity were 6.2V and 1100 cd/m², respectively. As an evaluation of the life of this element, a constant current of 20 mA/cm² was applied for constantly driving the element to measure the half life of the luminescence intensity. At the lapse of 5 hours, coagulation was occurred at a part of organic layers that lead to electrical short circuit between electrodes and termination of luminescence.

### Comparative Example 2

An element was produced in the same way as in Example 8 except that 1,2′-bis[(2-[4-(2,2-diphenylvinyl)phenyl]vinyl]benzene that is described in the Japanese Patent Publication JP-P-H11-317290A was employed in place of the compound No.1-02. Application of a voltage to the element thus produced resulted in uniform blue luminescent. Peak wavelength of the luminescent spectrum was at 470 nm. When a current of 100 mA/cm² was applied to the element, the drive voltage and luminescence intensity were 8.2V and 1900 cd/m², respectively. As an evaluation of the life of this element, a constant current of 20 mA/cm² was applied for constantly driving the element to measure the half life of the luminescence intensity. The luminescence intensity was reduced by half at the lapse of 40 hours.

### Example 9

Compound No.1-03 was prepared in the same way as in Example 4 except that 1.39 g of 4-(2-phenyl-2-(2-methylphenyl)vinyl)benzaldehyde was used in place of 4-(2,2-diphenylvinyl)benzaldehyde. An organic electroluminescent element was produced in the same way as in Example 8 except that compound No.1-03 prepared in the above was employed in place of compound No.1-02. Application of a voltage to the element thus produced resulted in uniform light blue luminescent.

### Example 10

Compound No.1-04 was prepared in the same way as in Example 4 except that 1.58 g of 4-(2-phenyl-2-(4-t-butylphenyl)vinyl)benzaldehyde was used in place of 4-(2,2-diphenylvinyl)benzaldehyde. An organic electroluminescent element was produced in the same way as in Example 8 except that compound No.1-04 prepared in the above was employed in place of compound No.1-02. Application of a voltage to the element thus produced resulted in uniform light blue luminescent.

### Example 11

Compound No.4-02 was prepared in the same way as in Examples 1, 2 and 3 except that 4.62 g of 4-(4-(4-t-butyl)phenyl)phenylboronic acid was employed in place of 4-biphenylboronic acid in Example 1. With 1.36 g of that compound, a synthesis reaction was performed in the same way as in Example 4, to prepare compound No.1-08. An organic electroluminescent element was produced in the same way as in Example 8 except that compound No.1-08 prepared in the above was employed in place of compound No.1-02. Application of a voltage to the element thus produced resulted in uniform light blue luminescent.

### Example 12

Compound No.1-12 was prepared in the same way as in Example 4 except that 1.58 g of 4-(2-phenyl-2-(3,5-di(trifluoromethyl)phenyl)vinyl)benzaldehyde was used in place of 4-(2,2-diphenylvinyl)benzaldehyde. An organic electroluminescent element was produced in the same way as in Example 8 except that compound No.1-12 prepared in the above was employed in place of compound No.1-02. Application of a voltage to the element thus produced resulted in uniform light blue luminescent.

### Example 13

On an electrode of an ITO glass substrate, a positive hole-transporting layer, a luminescent layer, and a cathode were formed, to produce the organic electroluminescent element of the present invention. Specifically, an ITO glass substrate, N,N′-bis[4′-(N,N-diphenylamino)-4-biphenylyl]-N,N′-diphenylbenzidine as a positive hole-transporting material, and compound No.1-02 as a luminescent material were placed in a vacuum vapor deposition system. The air was drawn out to 10⁻⁴ Pa. On the electrode of the ITO glass substrate, the positive hole-transporting layer was deposited to a thickness of 50 nm. Subsequently, compound No.1-02 was vapor-deposited to a thickness of 50 nm to obtain the luminescent layer. Further, Al/Li electrode was deposited to a thickness of 150 nm. These vapor deposition steps were performed continuously keeping the vacuum. The thickness of each layer was monitored with a quartz oscillator for controlling the thickness. After forming all of the layers, the electrode was immediately taken out in a dry nitrogen atmosphere, to produce the organic electroluminescent element. Application of a voltage to the element thus produced resulted in uniform light blue luminescent. The drive voltage was 8V, and the luminescence intensity was 1900 cd/m².

### Example 14

On an electrode of an ITO glass substrate, a luminescent layer and a cathode were formed, to produce the organic electroluminescent element of the present invention. Specifically, an ITO glass substrate and compound No.1-02 as a luminescent material were placed in a vacuum vapor deposition system. The air was drawn out to 10⁻⁴ Pa. On the electrode of the ITO glass substrate, compound No.1-02 was vapor-deposited to a thickness of 100 nm. Further, Al/Li electrode was deposited to a thickness of 150 nm. These vapor deposition steps were performed continuously keeping the vacuum. The thickness of each layer was monitored with a quartz oscillator for controlling the thickness. After forming all of the layers, the electrode was immediately taken out in adry nitrogen atmosphere, to produce the organic electroluminescent element. Application of a voltage to the element thus produced resulted in uniform light blue luminescent. The drive voltage was 9.7V, and the luminescence intensity was 940 cd/m².

### Example 15

On an electrode of an ITO glass substrate, a luminescent layer, an electron-transporting layer and a cathode were formed, to produce the organic electroluminescent element of the present invention. Specifically, an ITO glass substrate, compound No.1-02 as a luminescent material, and 2-(biphenyl-4-yl)-5-(4-tert-butylphenyl)-1,3,4-oxadiazole as an electron transporting material were placed in a vacuum vapor deposition system. The air was drawn out to 10⁻⁴ Pa. On the electrode of the ITO glass substrate, compound No.1-02 was deposited to a thickness of 50 nm as the luminescent layer. The electron transporting layer was then deposited to a thickness of 50 nm. Further, the Al/Li electrode was deposited to a thickness of 150 nm. These vapor deposition steps were performed continuously keeping the vacuum. The thickness of each layer was monitored with a quartz oscillator for controlling the thickness. After forming all of the layers, the electrode was immediately taken out in a dry nitrogen atmosphere, to produce the organic electroluminescent element. Application of a voltage to the element thus produced resulted in uniform light blue luminescent. The drive voltage was 7.9V, and the luminescence intensity was 1400 cd/m².

### Example 16

On an electrode of an ITO glass substrate, a positive hole-transporting layer, a luminescent layer, and a cathode were formed, to produce the organic electroluminescent element of the present invention. Specifically, an ITO glass substrate, N,N′-bis[4′-(N,N-diphenylamino)-4-biphenylyl]-N,N′-diphenylbenzidine as a positive hole-transporting material, compound No.1-02 as a host compound and 1,4-bis[4-di(4-tolyl)aminostyryl]benzene (referred to hereinbelow as EM-1) as a guest compound were placed in a vacuum vapor deposition system. The air was drawn out to 10⁻⁴ Pa. On the electrode of the ITO glass substrate, the positive hole-transporting layer was deposited to a thickness of 50 nm. Subsequently, compound No.1-02 and EM-1 were deposited as the luminescent layer to a thickness of 50 nm in a manner of co-vapordeposition. The concentration of EM-1 with respect to compound 1-02 was 3 mol per 100 mol of compound 1-02. Further, Al/Li electrode was deposited to a thickness of 150 nm. These vapor deposition steps were performed continuously keeping the vacuum. The thickness of each layer was monitored with a quartz oscillator for controlling the thickness. After forming all of the layers, the electrode was immediately taken out in a dry nitrogen atmosphere, to produce the organic electroluminescent element. Application of a voltage to the element thus produced resulted in uniform blue-green luminescent. The drive voltage was 7.4 V, and the luminescence intensity was 7800 cd/m². The element was driven with a current intensity of 20 mA/cm² in a dry nitrogen atmosphere. The luminescence thereof was reduced by half at the lapse of 1250 hours.

### Example 17

An ITO glass substrate was placed in a vacuum chamber. The air was drawn out to 10⁻⁴ Pa. N,N′-bis[4′-(N,N-diphenylamino)-4-biphenylyl]-N,N′-diphenylbenzidine was deposited as the positive hole-transporting layer to a thickness of 50 nm. Compound No.1-02 as the host compound of the luminescent layer and rubrene as the guest compound were co-vapor deposited to form the luminescent layer having a thickness of 25 nm. The concentration of rubrene with respect to the compound No.1-02 was 5 mol of rubrene per 100 mol of compound 1-02. Further, Alq as the electron-transporting layer was deposited to the thickness of 25 nm, and Al/Li electrode as the cathode was deposited to a thickness of 150 nm, to form the element. These vapor deposition steps were performed continuously keeping the vacuum. The thickness of each layer was monitored with a quartz oscillator for controlling the thickness. After forming the element, the electrode was immediately taken out in a dry nitrogen atmosphere, and subsequently subjected to measurements of properties. Application of a voltage to the element thus produced resulted in uniform yellow luminescent having a peak at 560 nm. A current of 100 mA/cm² was applied to the element for measuring the drive voltage and luminescence, which were found out to be 7.2 V and 4700 cd/m², respectively. When this element was constantly driven with a current intensity of 20 mA/cm², the luminescence was reduced by half at the lapse of 1000 hours.

### Example 18

Production of Compound 2-05

Under an argon stream, 6.00 g of 1,2-dimethyl-4-bromonaphthalene, 3.26 g of phenylboronic acid, 11.0 g of tetrakis(triphenylphosphine) palladium(0), 20 ml of ethanol, 50 ml of toluene, and an aqueous solution of sodium carbonate (made of 5.41 g of sodium carbonate and 21.6 g of water) were mixed. The mixture was heated to reflux with stirring for 10 hours. After cooling, extraction with diethyl ether was performed. The ether layer was washed with water and then dried with anhydrous sodium sulfate. Ether was then distilled off under the reduced pressure, to obtain yellow-brown viscous oil. The yellow-brown viscous oil were then subjected to column chromatography with silica gel as a stationary phase and a mixture solvent of toluene and hexane (volume ratio 1:1) as a mobile phase, to obtain 5.71 g of white crystals (yield 97%). The melting point thereof was 69.5 to 73.5° C. The elementary analysis of this product resulted in 93.00% carbon (theoretical value as compound 2-05: 93.06%), and 6.78% hydrogen (theoretical value as compound 2-05: 6.94%). In infrared absorption spectrum (KBr tablet), stretching vibration due to aromatic rings was recognized at around 1590 cm⁻¹. In proton nuclear magnetic resonance spectrum (solvent CDCl₃, internal standard TMS), alkane protons were recognized at δ=2.5 ppm (3H) and δ=2.65 ppm (3H), and ring protons of aromatic rings at δ=7.26 ppm (1H), δ=7.3 to 7.6 ppm (7H), δ=7.87 ppm (1H) and δ=8.08 ppm (1H). In mass spectrum, a molecular ion peak m/z=232 was recognized. From these results, it was confirmed that the compound thus obtained was compound No.2-05.

### Example 19

Production of Compound 3-05

5.58 g of the compound No.2-05 obtained in the above, 8.64 g of N-bromosuccinimide, 0.78 g of benzoyl peroxide (containing 25% water), and 100 ml of carbon tetrachloride were mixed. The mixture was heated to reflux with vigorous stirring for 4 hours. After cooling, the mixture was admixed with about 100 ml of diethyl ether and then filtered. The filtered liquid was washed with water, dried and then concentrated under the reduced pressure to obtain a slightly brownish white crystals.

### Example 20

Production of Compound 5-05

10.76 g of the compound 3-05 obtained in the above, and 27.50 g of triethyl phosphite were mixed and heated at 140 to 145° C. for 5 hours. After cooling, triethyl phosphite in excess and generated ethyl bromide were distilled off under the reduced pressure, to obtain 13.17 g of pale brown highly viscous liquid (yield 95%).

### Example 21

Production of Compound No.1-14 (#1)

1.51 g of the compound No.5-05 obtained in the above and 1.71 g of 4-(2,2-diphenylvinyl)benzaldehyde were dissolved in 20 ml of N,N-dimethylformamide. 0.8 g of potassium tert-butoxide was gradually added thereto under ice cooling, and then stirred at room temperature for 17 hours, to obtain a reaction mixture. The reaction mixture was then admixed with about 200 ml of ethanol and about 200 ml of water. The precipitate was recovered by filtration, washed with water and dried to obtain yellow powders as a crude product. The yellow powder crude product was dissolved in 150 ml of hot toluene and admixed with 10 g of Florisil (manufactured by Wako Pure Chemical Industries, Ltd.). The mixture was heated to reflux for one hours. After cooling, the mixture was subjected to filtration. The filtered liquid was concentrated, and the resulting yellow crystals were re-crystallized three times from a mixed solvent of toluene and hexane and then dried, to obtain 1.51 g of yellow crystals (yield 66%). The melting point of the crystals was 177.0 to 187.0° C. The elementary analysis of this product resulted in 94.00% carbon (theoretical value as compound 1-14: 94.20%), and 5.77% hydrogen (theoretical value as compound 1-14: 5.80%). In infrared absorption spectrum (KBr tablet), stretching vibration due to aromatic rings was recognized at around 1600 cm⁻¹. In proton nuclear magnetic resonance spectrum (solvent CDCl₃, internal standard TMS), ring protons of aromatic rings and alkene protons were recognized at 6=6.7 to 8.2 ppm (44H). In mass spectrum, a molecular ion peak m/z=764 was recognized. From these results, it was confirmed that the compound thus obtained was compound No.1-14.

### Example 22

Production of Compound No.1-14 (#2)

A mixture consisting of 1.39 g of an aldehyde represented by the following formula, 1.83 g of diethyl diphenylmethylphosphonate, and 20 ml of N,N-dimethylformamide were prepared. 0.78 g of potassium tert-butoxide was gradually added thereto under ice cooling, and then reacted at room temperature for 24 hours, to obtain a reaction mixture. The reaction mixture was then treated in the same way as in Example 21, to obtain compound No.1-14.

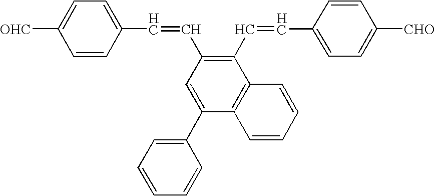

### Example 23

Production of Compound 1-14 (#3)

A mixture consisting of 2.13 g of a phosphonate represented by the following formula, 1.09 g of benzophenone, and 20 ml of N,N-dimethylformamide were prepared. 0.78 g of potassium tert-butoxide was gradually added thereto under ice cooling. Reaction was then effected at room temperature for 24 hours, to obtain a reaction mixture. The reaction mixture was then treated in the same way as in Example 21, to obtain compound No.1-14.

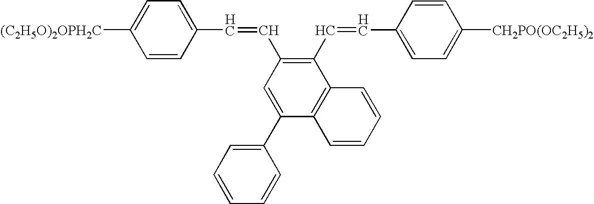

### Example 24

Production of Compound No.1-14 (#4)

Under an argon stream, 3.07 g of a bromobenzene derivative represented by the following formula, 0.49 g of phenylboronic acid, 0.14 g of tetrakis(triphenylphosphine) palladium(0), 4 ml of ethanol, 20 ml of toluene, and an aqueous solution of sodium carbonate (made of 0.85 g of sodium carbonate and 5 g of water) were mixed. The mixture was heated to reflux with stirring for 20 hours. After cooling, extraction with toluene was performed. The toluene layer was washed with water and then dried with anhydrous sodium sulfate. Toluene was then distilled off under the reduced pressure, to obtain a residue as a crude product. The crude product was treated in the same way as in Example 21, to obtain compound No.1-14.

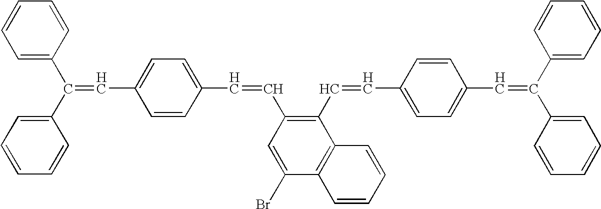

### Example 25

Production of Compound No.2-07

Under an argon stream, 6.00 g of 1,2-dimethyl-4-bromonaphthalene, 4.61 g of 1-naphthaleneboronic acid, 11.0 g of tetrakis(triphenylphosphine) palladium(0), 20 ml of ethanol, 50 ml of toluene, and an aqueous solution of sodium carbonate (made of 5.41 g of sodium carbonate and 21.6 g of water) were mixed. The mixture was heated to reflux with stirring for 10 hours. After cooling, extraction with diethyl ether was performed. The ether layer was washed with water and then dried with anhydrous sodium sulfate. Ether was then distilled off under the reduced pressure, to obtain yellow-brown glass substance. The yellow-brown glass substance were then subjected to column chromatography with silica gel as a stationary phase and a mixture solvent of toluene and hexane (volume ratio 1:1) as a mobile phase, to obtain 6.80 g of clear colorless glass substance (yield 94%). The elementary analysis of this product resulted in 93.38% carbon (theoretical value as compound 2-07: 93.57%), and 6.25% hydrogen (theoretical value as compound 2-07: 6.43%). In infrared absorption spectrum (KBr tablet), stretching vibration due to aromatic rings was recognized at around 1590 cm⁻¹. In proton nuclear magnetic resonance spectrum (solvent CDCl₃, internal standard TMS), alkane protons were recognized at δ=2.5 ppm (3H) and δ=2.65 ppm (3H), and ring protons of aromatic rings at δ=7.2 to 8.15 ppm (18H). In mass spectrum, a molecular ion peak m/z=282 was recognized. From these results, it was confirmed that the compound thus obtained was compound No.2-07.

### Example 26

Production of Compound No.3-07

6.66 g of the compound No.2-07 obtained in the above, 8.48 g of N-bromosuccinimide, 0.77 g of benzoyl peroxide (containing 25% water), and 100 ml of carbon tetrachloride were mixed. The mixture was heated to reflux with vigorous stirring for 4 hours. After cooling, the mixture was admixed with about 100 ml of diethyl ether and then filtered. The filtered liquid was washed with water, dried and then concentrated under the reduced pressure to obtain a slightly brownish glass substance.

### Example 27

Production of Compound 5-07

12.03 g of the compound 3-07 obtained in the above, and 27.25 g of triethyl phosphite were mixed and heated at 140 to 145° C. with stirring for 5 hours. After cooling, triethyl phosphite in excess and generated ethyl bromide were distilled off under the reduced pressure, to obtain 15.11 g of pale brown highly viscous liquid (quantitative yield).

### Example 28

Production of Compound No.1-26 (#1)

1.66 g of the compound No.5-07 obtained in the above and 1.71 g of 4-(2,2-diphenylvinyl)benzaldehyde were dissolved in 20 ml of N,N-dimethylformamide. 0.8 g of potassium tert-butoxide was gradually added thereto under ice cooling, and then stirred at room temperature for 17 hours, to obtain a reaction mixture. The reaction mixture was then admixed with about 200 ml of ethanol and about 200 ml of water. The precipitate was taken by filtration, washed with water and dried to obtain yellow powders as a crude product. The yellow powder crude product was subjected to column chromatography with silica gel as a stationary phase and a mixture solvent of toluene and hexane (volume ratio 1:1) as a mobile phase. The resulting yellow glass substance was re-crystallized from a mixture solvent of toluene and hexane, and then from a mixture solvent of 1,2-dichloroethane and ethanol, to obtain 1.37 g of yellow crystals (yield 56%). The melting point thereof was 217.0 to 219.0° C. The elementary analysis of this product resulted in 94.14% carbon (theoretical value as compound 1-26: 94.31%), and 5.60% hydrogen (theoretical value as compound 1-26: 5.69%). In infrared absorption spectrum (KBr tablet), stretching vibration due to aromatic rings was recognized at around 1600 cm⁻¹. In proton nuclear magnetic resonance spectrum (solvent CDCl₃, internal standard TMS), ring protons of aromatic rings and alkene protons were recognized at 6=6.7 to 8.2 ppm (46H). In mass spectrum, a molecular ion peak m/z=814 was recognized. From these results, it was confirmed that the compound thus obtained was compound No.1-26.

### Example 29

Production of Compound No.1-26 (#2)

A mixture consisting of 1.54 g of an aldehyde represented by the following formula, 1.83 g of diethyl diphenylmethylphosphonate, and 20 ml of N,N-dimethylformamide were prepared. 0.78 g of potassium tert-butoxide was gradually added thereto under ice cooling, and then reacted at room temperature for 24 hours, to obtain a reaction mixture. The reaction mixture was then treated in the same way as in Example 28, to obtain compound No.1-26.

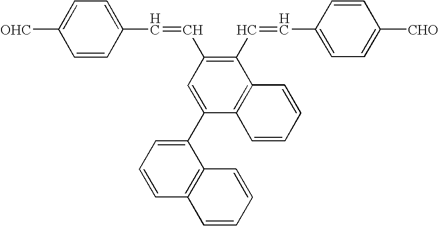

### Example 30

Production of Compound No.1-26 (#3)

A mixture consisting of 2.27 g of a phosphonate represented by the following formula, 1.09 g of benzophenone, and 20 ml of N,N-dimethylformamide were prepared. 0.78 g of potassium tert-butoxide was gradually added thereto under ice cooling. Reaction was then effected at room temperature for 24 hours, to obtain a reaction mixture. The reaction mixture was then treated in the same way as in Example 28, to obtain compound No.1-26.

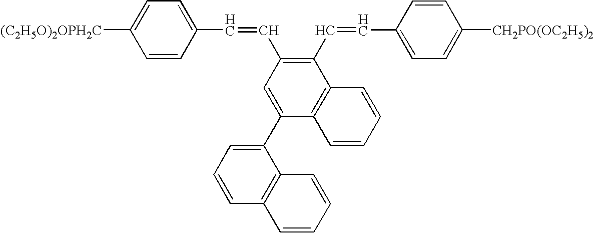

### Example 31

Production of Compound No.1-26 (#4)

Under an argon stream, 3.07 g of a bromobenzene derivative represented by the following formula, 0.69 g of 1-naphthaleneboronic acid, 0.14 g of tetrakis (triphenylphosphine) palladium(0), 4 ml of ethanol, 20 ml of toluene, and an aqueous solution of sodium carbonate (made of 0.85 g of sodium carbonate and 5 g of water) were mixed. The mixture was heated to reflux with stirring for 20 hours. After cooling, extraction with toluene was performed. The toluene layer was washed with water and then dried with anhydrous sodium sulfate. Toluene was then distilled off under the reduced pressure, to obtain a residue as a crude product. The crude product was treated in the same way as in Example 28, to obtain compound No.1-26.

### Example 32

On an electrode of an ITO glass substrate, a positive hole-transporting layer, a luminescent layer, an electron-transporting layer and an Al/Li electrode as a cathode were formed in this order by vapor deposition, to produce the organic electroluminescent element of the present invention. Specifically, an ITO glass substrate, N,N′-bis[4′-(N,N-diphenylamino)-4-biphenylyl]-N,N′-diphenylbenzidine as a positive hole-transporting material, the aromatic methylidene compound No.1-14 as a luminescent material, and Alq as an electron transporting material were placed in a vacuum vapor deposition system. The air was drawn out to 10⁻⁴ Pa. On the electrode of the ITO glass substrate, N,N′-bis[4′-(N,N-diphenylamino)-4-biphenylyl]-N,N′-diphenylbenzidine was vapor-deposited at the deposition rate of 0.1 to 0.5 nm/sec., to form a positive hole-transporting layer having a thickness of 50 nm. Subsequently, compound No.1-14 was vapor-deposited at the deposition rate of 0.1 to 0.5 nm/sec., to form a luminescent layer having a thickness of 50 nm. Alq was then deposited at the rate of 0.1 nm/sec., to form an electron transporting layer having a thickness of 10 nm. Further, deposition of Al/Li electrode was performed at the deposition rate of 0.5 nm/sec., to form the electrode having a thickness of 150 nm. These vapor deposition steps were performed continuously keeping the vacuum. The thickness of each layer was monitored with a quartz oscillator for controlling the thickness. After forming all of the layers, the electrode was immediately taken out in a dry nitrogen atmosphere, to produce the organic electroluminescent element. Application of a voltage to the element thus produced resulted in uniform light blue luminescent. Peak wavelength of the luminescent spectrum was at 490 nm. A current of 100 mA/cm² was applied to the element for measuring the drive voltage and luminescence intensity, which were found out to be 6.3V and 3000 cd/m², respectively. As an evaluation of the life of this element, a constant current of 20 mA/cm² was applied for constantly driving the element to measure the half life of the luminescence. As a result, the luminescence was reduced by half at the lapse of 550 hours.

### Comparative Example 3

An element was produced in the same way as in Example 32 except that 4,4′-bis(2,2-diphenylvinyl)biphenyl that is described in the Japanese Patent Publication JP-P-H03-231970A was employed as a luminescent material in place of the compound No.1-14. Application of a voltage to the element thus produced resulted in uniform blue luminescent. Peak wavelength of the luminescent spectrum was at 450 nm. When a current of 100 mA/cm² was applied to the element, the drive voltage and luminescence intensity were 6.2V and 1100 cd/m², respectively. As an evaluation of the life of this element, a constant current of 20 mA/cm² was applied for constantly driving the element to measure the half life of the luminescence intensity. At the lapse of 5 hours, coagulation was occurred at a part of organic layers that lead to electrical short circuit between electrodes and termination of luminescence.

### Comparative Example 4

(01131 An element was produced in the same way as in Example 32 except that 1,2′-bis[2-[4-(2,2-diphenylvinyl)phenyl]vinyl]benzene that is described in the Japanese Patent Publication JP-P-H11-317290A was employed in place of the compound No.1-14. Application of a voltage to the element thus produced resulted in uniform blue luminescent. Peak wavelength of the luminescent spectrum was at 470 nm. When a current of 100 mA/cm² was applied to the element, the drive voltage and luminescence intensity were 8.2V and 1900 cd/m², respectively. As an evaluation of the life of this element, a constant current of 20 mA/cm² was applied for constantly driving the element to measure the half life of the luminescence intensity. The luminescence intensity was reduced by half at the lapse of 40 hours.

### Example 33

Compound No.1-15 was prepared in the same way as in Example 21 except that 1.79 g of 4-(2-phenyl-2-(2-methylphenyl)vinyl)benzaldehyde was used in place of 4-(2,2-diphenylvinyl)benzaldehyde. An organic electroluminescent element was produced in the same way as in Example 32 except that compound No.1-15 prepared in the above was employed in place of compound No.1-14. Application of a voltage to the element thus produced resulted in uniform light blue luminescent.

### Example 34

Compound No.1-16 was prepared in the same way as in Example 21 except that 2.04 g of 4-(2-phenyl-2-(4-t-butylphenyl)vinyl)benzaldehyde was used in place of 4-(2,2-diphenylvinyl)benzaldehyde. An organic electroluminescent element was produced in the same way as in Example 32 except that compound No.1-16 prepared in the above was employed in place of compound No.1-14. Application of a voltage to the element thus produced resulted in uniform light blue luminescent.

### Example 35

Synthesis reaction was performed in the same way as in Examples 18, 19 and 20 except that 4.76 g of 4-t-butylphenylboronic acid was employed in place of the phenylboronic acid in Example 18, to obtain a compound having a structure which is the same as compound No.5-05 except that 4-position of the phenyl group is substituted by t-butyl group. With 1.68 g of this compound, the synthesis reaction was performed in the same way as in Example 21, to prepare compound No.1-17. An organic electroluminescent element was produced in the same way as in Example 32 except that compound No.1-17 prepared in the above was employed in place of compound No. 1-14. Application of a voltage to the element thus produced resulted in uniform light blue luminescent.

### Example 36

An organic electroluminescent element was produced in the same way as in Example 32 except that compound No.1-26 was employed in place of compound No.1-14. Application of a voltage to the element thus produced resulted in uniform light blue luminescent.

### Example 37

On an electrode of an ITO glass substrate, a positive hole-transporting layer, a luminescent layer, and a cathode were formed, to produce the organic electroluminescent element of the present invention. Specifically, an ITO glass substrate, N,N′-bis[4′-(N,N-diphenylamino)-4-biphenylyl]-N,N′-diphenylbenzidine as a positive hole-transporting material, and compound No.1-14 as a luminescent material were placed in a vacuum vapor deposition system. The air was drawn out to 10⁻⁴ Pa. On the electrode of the ITO glass substrate, the positive hole-transporting layer was deposited to a thickness of 50 nm. Subsequently, compound No.1-14 was vapor-deposited to a thickness of 50 nm to obtain the luminescent layer. Further, Al/Li electrode was deposited to a thickness of 150 nm. These vapor deposition steps were performed continuously keeping the vacuum. The thickness of each layer was monitored with a quartz oscillator for controlling the thickness. After forming all of the layers, the electrode was immediately taken out in a dry nitrogen atmosphere, to produce the organic electroluminescent element. Application of a voltage to the element thus produced resulted in uniform light blue luminescent. The drive voltage was 7.9V, and the luminescence intensity was 1800 cd/m².

### Example 38

On an electrode of an ITO glass substrate, a luminescent layer and a cathode were formed, to produce the organic electroluminescent element of the present invention. Specifically, an ITO glass substrate and compound No.1-14 as a luminescent material were placed in a vacuum vapor deposition system. The air was drawn out to 10⁻⁴ Pa. On the electrode of the ITO glass substrate, compound No.1-14 was vapor-deposited to a thickness of 100 nm. Further, Al/Li electrode was deposited to a thickness of 150 nm. These vapor deposition steps were performed continuously keeping the vacuum. The thickness of each layer was monitored with a quartz oscillator for controlling the thickness. After forming all of the layers, the electrode was immediately taken out in a dry nitrogen atmosphere, to produce the organic electroluminescent element. Application of a voltage to the element thus produced resulted in uniform light blue luminescent. The drive voltage was 9.8V, and the luminescence intensity was 850 cd/m².

### Example 39

On a electrode of an ITO glass substrate, a luminescent layer, an electron-transporting layer and a cathode were formed, to produce the organic electroluminescent element of the present invention. Specifically, an ITO glass substrate, compound No.1-14 as a luminescent material, and 2-(biphenyl-4-yl)-5-(4-tert-butylphenyl)-1,3,4-oxadiazole as an electron transporting material were placed in a vacuum vapor deposition system. The air was drawn out to 10⁻⁴ Pa. On the electrode of the ITO glass substrate, compound No.1-14 was deposited to a thickness of 50 nm. The electron transporting layer was then deposited to a thickness of 50 nm. Further, the Al/Li electrode was deposited to a thickness of 150 nm. These vapor deposition steps were performed continuously keeping the vacuum. The thickness of each layer was monitored with a quartz oscillator for controlling the thickness. After forming all of the layers, the electrode was immediately taken out in a dry nitrogen atmosphere, to produce the organic electroluminescent element. Application of a voltage to the element thus produced resulted in uniform light blue luminescent. The drive voltage was 8V, and the luminescence intensity was 1500 cd/m².

### Example 40

On an electrode of an ITO glass substrate, a positive hole-transporting layer, a luminescent layer, and a cathode were formed, to produce the organic electroluminescent element of the present invention. Specifically, an ITO glass substrate, N,N′-bis[4′-(N,N-diphenylamino)-4-biphenylyl]-N,N′-diphenylbenzidine as a positive hole-transporting material, compound No.1-14 as a host compound and EM-1 as a guest compound were placed in a vacuum vapor deposition system. The air was drawn out to 10⁻⁴ Pa. On the electrode of the ITO glass substrate, the positive hole-transporting layer was deposited to a thickness of 50 nm. Subsequently, compound No.1-14 and EM-1 were deposited as the luminescent layer to a thickness of 50 nm in a manner of co-vapor deposition. The concentration of EM-1 with respect to compound 1-14 was 3 mol per 100 mol of compound 1-14. Further, Al/Li electrode was deposited to a thickness of 150 nm. These vapor deposition steps were performed continuously keeping the vacuum. The thickness of each layer was monitored with a quartz oscillator for controlling the thickness. After forming all of the layers, the electrode was immediately taken out in a dry nitrogen atmosphere, to produce the organic electroluminescent element. Application of a voltage to the element thus produced resulted in uniform blue-green luminescent. The drive voltage was 7.6 V, and the luminescence intensity was 7500 cd/m². The element was constantly driven with a current intensity of 20 mA/cm² in a dry nitrogen atmosphere. The luminescence thereof was reduced by half at the lapse of 1400 hours.

### Example 41

An ITO glass substrate was placed in a vacuum chamber. The air was drawn out to 10⁻⁴ Pa. N,N′-bis[4′-(N,N-diphenylamino)-4-biphenylyl]-N,N′-diphenylbenzidine was deposited as the positive hole-transporting layer to a thickness of 50 nm. Compound No.1-14 as the host compound of the luminescent layer and rubrene as the guest compound were co-vapor deposited to form the luminescent layer having a thickness of 25 nm. The concentration of rubrene with respect to compound No.1-14 was 5 mol of rubrene per 100 mol of compound 1-14. Further, Alq as the electron-transporting layer was deposited to the thickness of 25 nm, and Al/Li electrode as the cathode was deposited to a thickness of 150 nm, to form the element. These vapor deposition steps were performed continuously keeping the vacuum. The thickness of each layer was monitored with a quartz oscillator for controlling the thickness. After forming the element, the electrode was immediately taken out in a dry nitrogen atmosphere, and subsequently subjected to measurements of properties. Application of a voltage to the element thus produced resulted in uniform yellow luminescent having a peak at 560 nm. A current of 100 mA/cm² was applied to the element for measuring the drive voltage and luminescence, which were found out to be 7.2 V and 4500 cd/m², respectively. When this element was constantly driven with a constant current of 20 mA/cm², the luminescence was reduced by half at the lapse of 1200 hours.

### Example 42

Production of Compound No.19-07

Under an argon stream, 4.57 g of 1,4-dibromo-2,5-dimethylbenzene, 5.19 g of 2-formylbenzeneboronic acid, 1.19 g of tetrakis(triphenylphosphine) palladium(0), 24 ml of ethanol, 70 ml of toluene, and an aqueous solution of sodium carbonate (made of 7.33 g of sodium carbonate and 29.3 g of water) were mixed. The mixture was heated to reflux with stirring for 22 hours. After cooling, extraction with toluene was performed. The toluene layer was washed with water and then dried with anhydrous sodium sulfate. Toluene was then distilled off under the reduced pressure, to obtain pale brown crystals. The crystals were twice re-crystallized from cyclohexane to obtain 2.31 g of pale yellow-brown crystals (yield 43%). The melting point thereof was 162.0 to 165.5° C. The elementary analysis of this product resulted in 83.88% carbon (theoretical value as compound 19-07: 84.05%), and 5.63% hydrogen (theoretical value as compound 19-07: 5.77%). In infrared absorption spectrum (KBr tablet), stretching vibration due to carbonyl groups was recognized at around 1700 cm⁻¹. In proton nuclear magnetic resonance spectrum (solvent CDCl₃, internal standard TMS), methyl protons were recognized at δ=2.1 ppm (6H), ring protons of aromatic rings were recognized at δ=7.1 to 8.1 ppm (10H), and aldehyde protons were recognized at δ=9.8 ppm (2H). From these results, it was confirmed that the compound thus obtained was compound No.19-07.

### Example 43

Production of Compound No.1-34 (#1)

0.943 g of the compound 19-07 obtained in the above, 2.93 g of diethyl 4-(2,2-diphenylvinyl)benzyl phosphonate were dissolved in 20 ml of N,N-dimethylformamide. 0.85 g of potassium tert-butoxide was gradually added thereto under ice cooling, and then stirred at room temperature for 24 hours, to obtain a reaction mixture. The reaction mixture was then admixed with about 30 ml of ethanol. The precipitate was recovered by filtration, washed with ethanol and then with water, and dried to obtain pale yellow powders. The pale yellow powders were dissolved in 100 ml of hot toluene and admixed with 4 g of Florisil (manufactured by Wako Pure Chemical Industries, Ltd.). The mixture was heated to reflux for one hours, and then filtered keeping the mixture warm. 100 ml of hexane was added to the filtered liquid while the liquid was still warm. The liquid was then allowed to cool down, to precipitate crystals. The crystals were recovered by filtration, dried in vacuo at 150° C., to obtain 1.55 g of pale yellow crystals (yield 63%). The melting point of the crystals was 261.0 to 263.5° C. The elementary analysis of this product resulted in 93.70% carbon (theoretical value as compound 1-34: 93.85%), and 6.10% hydrogen (theoretical value as compound 1-34: 6.15%). In infrared absorption spectrum (KBr tablet), stretching vibration due to aromatic rings was recognized at around 1600 cm⁻¹. In proton nuclear magnetic resonance spectrum (solvent CDCl₃, internal standard TMS), methyl protons were recognized at δ=2.0 ppm (6H), and ring protons of aromatic rings and alkene protons were recognized at δ=6.7 to 7.8 ppm (44H). In mass spectrum, a molecular ion peak m/z=818 was recognized. From these results, it was confirmed that the compound thus obtained was compound No.1-34.

### Example 44

Production of Compound No.1-34 (#2)

A mixture consisting of 1.68 g of a methyl phosphorus compound represented by the following formula, 1.71 g 4-(2,2-diphenylvinyl)benzaldehyde and 20 ml of N,N-dimethylformamide were prepared. 0.78 g of potassium tert-butoxide was gradually added thereto under ice cooling, and then stirred at room temperature for 24 hours, to obtain a reaction mixture. The reaction mixture was then treated in the same way as in Example 43, to obtain compound No.1-34.

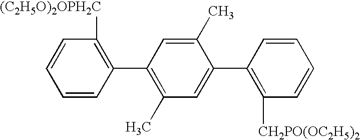

### Example 45

Production of Compound 1-34 (#3)

A mixture consisting of 1.56 g of an aldehyde represented by the following formula, 1.83 g of diethyl diphenylmethylphosphonate, and 20 ml of N,N-dimethylformamide were prepared. 0.78 g of potassium tert-butoxide was gradually added thereto under ice cooling, and then stirred at room temperature for 24 hours, to obtain a reaction mixture. The reaction mixture was then treated in the same way as in Example 43, to obtain compound No.1-34.

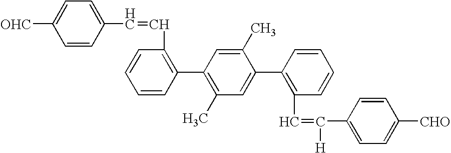

### Example 46

Production of Compound 1-34 (#4)

A mixture consisting of 2.29 g of a methylphosphorus compound represented by the following formula, 1.09 g of benzophenone, and 20 ml of N,N-dimethylformamide were prepared. 0.78 g of potassium tert-butoxide was gradually added thereto under ice cooling. Reaction was then effected at room temperature for 24 hours, to obtain a reaction mixture. The reaction mixture was then treated in the same way as in Example 43, to obtain compound No.1-34.

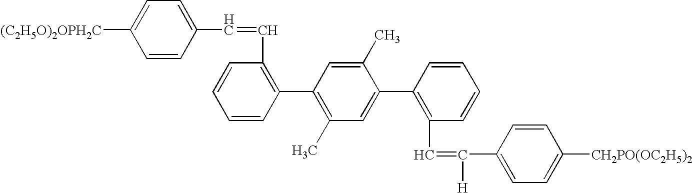

### Example 47

On an electrode of ITO glass substrate, a positive hole-transporting layer, a luminescent layer, an electron-transporting layer and an Al/Li electrode as a cathode were formed in this order by vapor deposition, to produce the organic electroluminescent element of the present invention. Specifically, an ITO glass substrate, N,N′-bis[4′-(N,N-diphenylamino)-4-biphenylyl]-N,N′-diphenylbenzidine as a positive hole-transporting material, the aromatic methylidene compound No.1-34 as a luminescent material, and Alq as an electron transporting material were placed in a vacuum vapor deposition system. The air was drawn out to 10⁻⁴ Pa. On the electrode of the ITO glass substrate, N,N′-bis[4′-(N,N-diphenylamino)-4-biphenylyl]-N,N′-diphenylbenzidine was vapor-deposited at the deposition rate of 0.1 to 0.5 nm/sec., to form a positive hole-transporting layer having a thickness of 50 nm. Subsequently, compound No.1-34 was vapor-deposited at the deposition rate of 0.1 to 0.5 nm/sec., to form a luminescent layer having a thickness of 50 nm. Alq was then deposited at the rate of 0.1 nm/sec., to form an electron transporting layer having a thickness of 10 nm. Further, deposition of Al/Li electrode was performed at the deposition rate of 0.5 nm/sec., to form the electrode having a thickness of 150 nm. These vapor deposition steps were performed continuously keeping the vacuum. The thickness of each layer was monitored with a quartz oscillator for controlling the thickness. After forming all of the layers, the electrode was immediately taken out in a dry nitrogen atmosphere, to produce the organic electroluminescent element. Application of a voltage to the element thus produced resulted in uniform blue luminescent. Peak wavelength of the luminescent spectrum was at 480 nm. A current of 100 mA/cm² was applied to the element for measuring the drive voltage and luminescence intensity, which were found out to be 5.8V and 3200 cd/m², respectively. As an evaluation of the life of this element, a constant current of 20 mA/cm² was applied for constantly driving the element to measure the half life of the luminescence intensity. As a result, the luminescence intensity was reduced by half at the lapse of 600 hours.

### Comparative Example 5

An element was produced in the same way as in Example 47 except that 4,4′-bis(2,2-diphenylvinyl)biphenyl that is described in the Japanese Patent Publication JP-P-H03-231970 A was employed as a luminescent material in place of the compound No.1-34. Application of a voltage to the element thus produced resulted in uniform blue luminescent. Peak wavelength of the luminescent spectrum was at 450 nm. When a current of 100 mA/cm² was applied to the element, the drive voltage and luminescence intensity were 6.2V and 1100 cd/m², respectively. As an evaluation of the life of this element, a constant current of 20 mA/cm² constant current was applied for constantly driving the element to measure the half life of the luminescence intensity. At the lapse of 5 hours, coagulation was occurred at a part of organic layers that lead to electrical short circuit between electrodes and termination of luminescence.

### Comparative Example 6

An element was produced in the same way as in Example 47 except that 1,2′-bis[2-[4-(2,2-diphenylvinyl)phenyl]vinyl]benzene that is described in the Japanese Patent Publication JP-P-H11-317290 A was employed in place of the compound No.1-34. Application of a voltage to the element thus produced resulted in uniform blue luminescent. Peak wavelength of the luminescent spectrum was at 470 nm. When a current of 100 mA/cm² was applied to the element, the drive voltage and luminescence intensity were 8.2V and 1900 cd/m², respectively. As an evaluation of the life of this element, a constant current of 20 mA/cm² was applied for constantly driving the element to measure the half life of the luminescence intensity. The luminescence intensity was reduced by half at the lapse of 40 hours.

### Example 48

Compound No.1-35 was prepared in the same way as in Example 44 except that 1.79 g of 4-(2-phenyl-2-(2-methylphenyl)vinyl)benzaldehyde was used in place of 4-(2,2-diphenylvinyl)benzaldehyde. An organic electroluminescent element was produced in the same way as in Example 47 except that compound No.1-35 prepared in the above was employed in place of compound No.1-34. Application of a voltage to the element thus produced resulted in uniform blue luminescent.

### Example 49

Synthesis reaction was performed in the same way as in Examples 44 except that 1.76 g of a compound having a structure which is the same as the methylphosphorus compound shown in Example 44 but the methyl group therein was substituted by ethyl group, to obtain compound No.1-37. An organic electroluminescent element was produced in the same way as in Example 47 except that compound No.1-37 prepared in the above was employed in place of compound No.1-34. Application of a voltage to the element thus produced resulted in uniform blue luminescent.

### Example 50

Synthesis reaction was performed in the same way as in Examples 44 except that 1.71 g of a compound having a structure which is the same as the methylphosphorus compound shown in Example 44 but the group —CH₂PO(C₂H₅)₂ is not on ortho-position but on meta-position, to obtain compound No.1-41. An organic electroluminescent element was produced in the same way as in Example 47 except that compound No.1-41 prepared in the above was employed in place of compound No.1-34. Application of a voltage to the element thus produced resulted in uniform blue luminescent.

### Example 51

Synthesis reaction was performed in the same way as in Examples 44 except that 1.59 g of a compound having a structure represented by the following formula was employed as a methylphosphorus compound, to obtain compound No.1-43. An organic electroluminescent element was produced in the same way as in Example 47 except that compound No.1-43 prepared in the above was employed in place of compound No.1-34. Application of a voltage to the element thus produced resulted in uniform blue luminescent.

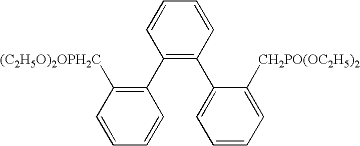

### Example 52

On an electrode of an ITO glass substrate, a positive hole-transporting layer, a luminescent layer, and a cathode were formed, to produce the organic electroluminescent element of the present invention. Specifically, an ITO glass substrate, N,N′-bis[41-(N,N-diphenylamino)-4-biphenylyl]-N,N′-diphenylbenzidine as a positive hole-transporting material, and compound No.1-34 as a luminescent material were placed in a vacuum vapor deposition system. The air was drawn out to 10⁻⁴ Pa. On the electrode of the ITO glass substrate, the positive hole-transporting layer was deposited to a thickness of 50 nm. Subsequently, compound No.1-34 was vapor-deposited to a thickness of 50 nm to obtain the luminescent layer. Further, Al/Li electrode was deposited to a thickness of 150 nm. These vapor deposition steps were performed continuously keeping the vacuum. The thickness of each layer was monitored with a quartz oscillator for controlling the thickness. After forming all of the layers, the electrode was immediately taken out in a dry nitrogen atmosphere, to produce the organic electroluminescent element. Application of a voltage to the element thus produced resulted in uniform blue luminescent.

### Example 53

On an electrode of an ITO glass substrate, a luminescent layer and a cathode were formed, to produce the organic electroluminescent element of the present invention. Specifically, an ITO glass substrate and compound No.1-34 as a luminescent material were placed in a vacuum vapor deposition system. The air was drawn out to 10⁻⁴ Pa. On the electrode of the ITO glass substrate, compound No.1-34 was vapor-deposited to a thickness of 100 nm. Further, Al/Li electrode was deposited to a thickness of 150 nm. These vapor deposition steps were performed continuously keeping the vacuum. The thickness of each layer was monitored with a quartz oscillator for controlling the thickness. After forming all of the layers, the electrode was immediately taken out in a dry nitrogen atmosphere, to produce the organic electroluminescent element. Application of a voltage to the element thus produced resulted in uniform blue luminescent.

### Example 54

On an electrode of an ITO glass substrate, a luminescent layer, an electron-transporting layer and a cathode were formed, to produce the organic electroluminescent element of the present invention. Specifically, an ITO glass substrate, compound No.1-34 as a luminescent material, and 2-(biphenyl-4-yl)-5-(4-tert-butylphenyl)-1,3,4-oxadiazole as an electron transporting material were placed in a vacuum vapor deposition system. The air was drawn out to 10⁻⁴ Pa. On the electrode of the ITO glass substrate, compound No.1-34 was deposited to a thickness of 50 nm as the luminescent layer. The electron transporting layer was then deposited to a thickness of 50 nm. Further, the Al/Li electrode was deposited to a thickness of 150 nm. These vapor deposition steps were performed continuously keeping the vacuum. The thickness of each layer was monitored with a quartz oscillator for controlling the thickness. After forming all of the layers, the electrode was immediately taken out in a dry nitrogen atmosphere, to produce the organic electroluminescent element. Application of a voltage to the element thus produced resulted in uniform blue luminescent.

### Example 55

On an electrode of an ITO glass substrate, a positive hole-transporting layer, a luminescent layer, and a cathode were formed, to produce the organic electroluminescent element of the present invention. Specifically, an ITO glass substrate, N,N′-bis[4′-(N,N-diphenylamino)-4-biphenylyl]-N,N′-diphenylbenzidine as a positive hole-transporting material, compound No.1-34 as a host compound and EM-1 as a guest compound were placed in a vacuum vapor deposition system. The air was drawn out to 10⁻⁴ Pa. On the electrode of the ITO glass substrate, the positive hole-transporting layer was deposited to a thickness of 50 nm. Subsequently, compound No.1-34 and EM-1 were deposited as the luminescent layer to a thickness of 50 nm in a manner of co-vapor deposition. The concentration of EM-1 with respect to compound 1-34 was 3 mol per 100 mol of compound 1-34. Further, Al/Li electrode was deposited to a thickness of 150 nm. These vapor deposition steps were performed continuously keeping the vacuum. The thickness of each layer was monitored with a quartz oscillator for controlling the thickness. After forming all of the layers, the electrode was immediately taken out in a dry nitrogen atmosphere, to produce the organic electroluminescent element. Application of a voltage to the element thus produced resulted in uniform blue-green luminescent.

### Example 56

An ITO glass substrate was placed in a vacuum chamber. The air was drawn out to 10⁴ Pa. N,N′-bis[4′-(N,N-diphenylamino)-4-biphenylyl]-N,N′-diphenylbenzidine was deposited as the positive hole-transporting layer to a thickness of 50 nm. Compound No.1-34 as the host compound and rubrene as the guest compound were co-vapor deposited to form the luminescent layer having a thickness of 25 nm. The concentration of rubrene with respect to compound No.1-34 was 5 mol of rubrene per 100 mol of compound 1-34. Further, Alq as the electron-transporting layer was deposited to the thickness of 25 nm, and Al/Li electrode as the cathode was deposited to a thickness of 150 nm, to form the element. These vapor deposition steps were performed continuously keeping the vacuum. The thickness of each layer was monitored with a quartz oscillator for controlling the thickness. After forming the element, the electrode was immediately taken out in a dry nitrogen atmosphere, and subsequently subjected to measurements of properties. Application of a voltage to the element thus produced resulted in uniform yellow luminescent having a peak at 560 nm.

### Example 57

Production of Compound No.2-13

Under an argon stream, 21.12 g of 1,4-dibromo-2,5-dimethylbenzene, 19.51 g of phenylboronic acid, 5.55 g of tetrakis(triphenylphosphine) palladium(0), 80 ml of ethanol, 240 ml of toluene, and an aqueous solution of sodium carbonate (made of 33.92 g of sodium carbonate and 136 g of water) were mixed. The mixture was heated to reflux with stirring for 24 hours. After cooling, extraction with toluene was performed. The toluene layer was washed with water and then dried with anhydrous sodium sulfate. Toluene was then distilled off under the reduced pressure, and the resulting crystals were re-crystallized from cyclohexane and dried in vacuo at 50° C. to obtain 17.05 g of colorless crystals (yield 82.5%). The melting point thereof was 186.0 to 187.0° C.

### Example 58

Production of Compound No. 3-13

16.97 g of the compound No.2-13 obtained in the above, 23.61 g of N-bromosuccinimide, 1.71 g of benzoyl peroxide (containing 25% water), and 260 ml of carbon tetrachloride were mixed. The mixture was heated to reflux with vigorous stirring for 4 hours. After cooling, the precipitated crystals were filtered off, and the filtered liquid was concentrated to obtain white crystals. The crystals were re-crystallized from cyclohexane to obtain 19.56 g of white crystals (yield 71.6%). The melting point thereof was 164.0 to 172.0° C. The elementary analysis of this product resulted in 57.49% carbon (theoretical value as compound 3-13: 57.72%), and 3.61% hydrogen (theoretical value as compound 3-13: 3.88%). In proton nuclear magnetic resonance spectrum (solvent CDCl₃, internal standard TMS), ring protons of aromatic rings were recognized at δ=7.4 to 7.6 ppm (12H), and methylene protons were recognized at δ=4.5 ppm (4H). From these results, it was confirmed that the compound thus obtained was compound No.3-13.

### Example 59

Production of Compound No.5-13

19.26 g of the compound 3-13 obtained in the above, and 30.76 g of triethyl phosphite were mixed and heated at 120 to 125° C. for 3 hours with stirring. After cooling, triethyl phosphite in excess and generated ethyl bromide were distilled off under the reduced pressure. The residue was re-crystallized from cyclohexane, to obtain 18.02 g of white crystals (yield 73.4%). The melting point thereof was 91.0 to 92.5° C. In proton nuclear magnetic resonance spectrum (solvent CDCl₃, internal standard TMS), ring protons of aromatic rings were recognized at δ=7.3 to 7.5 ppm (12H), methylene protons (ester) were recognized at δ=3.9 to 4.1 ppm (8H), methylene protons were recognized at δ=3.1 to 3.3 ppm (4H), and methyl protons (ester) were recognized at δ=1.1 to 1.3 ppm (12H). From these results, it was confirmed that the compound thus obtained was compound No.5-13.

### Example 60

Production of Compound No.1-54 (#1)

1.59 g of the compound 5-13 obtained in the above, and 1.71 g of 4-(2,2-diphenylvinyl)benzaldehyde were dissolved in 20 ml of N,N-dimethylformamide. 0.8 g of potassium tert-butoxide was gradually added thereto under ice cooling, and then stirred at room temperature for 24 hours, to obtain a reaction mixture. The reaction mixture was then admixed with about 30 ml of ethanol and the resulting crystals were recovered by filtration. The crystals were washed with ethanol, then washed with water, and then again with ethanol, and dried under the reduced pressure to obtain crystals as a crude product. The crystals were re-crystallized from mesitylene, and dried under the reduced pressure to obtain 1.29 g of yellow crystals (yield 54%). The melting point thereof were 291.0 to 296.0° C. The elementary analysis of this product resulted in 94.00% carbon (theoretical value as compound 1-54: 94.14%), and 5.74% hydrogen (theoretical value as compound 1-54: 5.86%). In infrared absorption spectrum (KBr tablet), stretching vibration due to aromatic rings was recognized at around 1600 cm⁻¹. In proton nuclear magnetic resonance spectrum (solvent CDCl₃, internal standard TMS), ring protons of aromatic rings and alkene protons were recognized at δ=6.8 to 7.7 ppm (46H). In mass spectrum, a molecular ion peak m/z=790 was recognized. From these results, it was confirmed that the compound thus obtained was compound No.1-54.

### Example 61

Production of Compound No. 1-54 (#2)

A mixture consisting of 1.47 g of an aldehyde represented by the following formula, 1.83 g of diethyl diphenylmethylphosphonate, and 20 ml of N,N-dimethylformamide were prepared. 0.78 g of potassium tert-butoxide was gradually added thereto under ice cooling, and then stirred at room temperature for 24 hours, to obtain a reaction mixture. The reaction mixture was then treated in the same way as in Example 60, to obtain compound No.1-54.

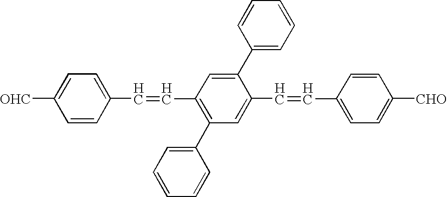

### Example 62

Production of Compound No. 1-54 (#3)

A mixture consisting of 2.20 g of a phosphonate represented by the following formula, 1.09 g of benzophenone, and 20 ml of N,N-dimethylformamide were prepared. 0.78 g of potassium tert-butoxide was gradually added thereto under ice cooling. Reaction was then effected at room temperature for 24 hours, to obtain a reaction mixture. The reaction mixture was then treated in the same way as in Example 60, to obtain compound No.1-54.

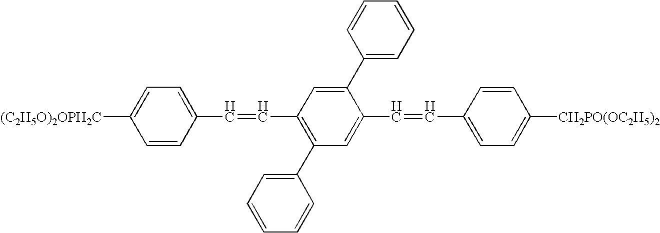

### Example 63

Production of Compound No.1-54 (#4)

Under an argon stream, 1.59 g of an 1,4-dibromobenzene derivative represented by the following formula, 0.49 g of phenylboronic acid, 0.14 g of tetrakis(triphenylphosphine) palladium(0), 4 ml of ethanol, 50 ml of toluene, and an aqueous solution of sodium carbonate (made of 0.85 g of sodium carbonate and 5 g of water) were mixed. The mixture was heated to reflux with stirring for 20 hours. After cooling, the precipitated crystals were recovered by filtration, washed with ethanol and then with water, and dried, to obtain to obtain crystals as a crude product. The crude product crystals were treated in the same way as in Example 60, to obtain compound 1-54.

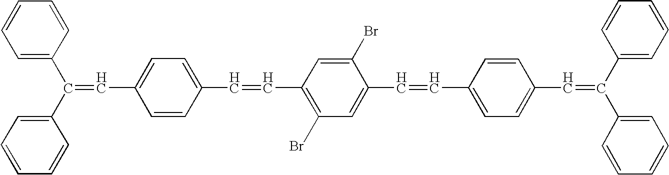

### Example 64

On an electrode of an ITO glass substrate, a positive hole-transporting layer, a luminescent layer, an electron-transporting layer and an Al/Li electrode as a cathode were formed in this order by vapor deposition, to produce the organic electroluminescent element of the present invention. Specifically, an ITO glass substrate, N,N′-bis[4′-(N,N-diphenylamino)-4-biphenylyl]-N,N′-diphenylbenzidine as a positive hole-transporting material, the aromatic methylidene compound No.1-54 as a luminescent material, and Alq as an electron transporting material were placed in a vacuum vapor deposition system. The air was drawn out to 10⁻⁴ Pa. On the electrode of the ITO glass substrate, N,N′-bis[4′-(N,N-diphenylamino)-4-biphenylyl]-N,N′-diphenylbenzidine was vapor-deposited at the deposition rate of 0.1 to 0.5 nm/sec., to form a positive hole-transporting layer having a thickness of 50 nm. Subsequently, compound No.1-54 was vapor-deposited at the deposition rate of 0.1 to 0.5 nm/sec., to form a luminescent layer having a thickness of 50 nm. Alq was then deposited at the rate of 0.1 nm/sec., to form an electron transporting layer having a thickness of 10 nm. Further, deposition of Al/Li electrode was performed at the deposition rate of 0.5 nm/sec., to form the electrode having a thickness of 150 nm. These vapor deposition steps were performed continuously keeping the vacuum. The thickness of each layer was monitored with a quartz oscillator for controlling the thickness. After forming all of the layers, the electrode was immediately taken out in a dry nitrogen atmosphere, to produce the organic electroluminescent element. Application of a voltage to the element thus produced resulted in uniform green luminescent.

### Example 65

Compound No.1-55 was prepared in the same way as in Example 60 except that 1.79 g of 4-(2-phenyl-2-(2-methylphenyl)vinyl)benzaldehyde was used in place of 4-(2,2-diphenylvinyl)benzaldehyde. An organic electroluminescent element was produced in the same way as in Example 64 except that compound No.1-55 prepared in the above was employed in place of compound No.1-54. Application of a voltage to the element thus produced resulted in uniform green luminescent.

### Example 66

Compound No.1-56 was prepared in the same way as in Example 60 except that 2.04 g of 4-(2-phenyl-2-(4-t-butylphenyl)vinyl)benzaldehyde was used in place of 4-(2,2-diphenylvinyl)benzaldehyde. An organic electroluminescent element was produced in the same way as in Example 64 except that compound No.1-56 prepared in the above was employed in place of compound No.1-54. Application of a voltage to the element thus produced resulted in uniform green luminescent.

### Example 67

Compound No.1-57 was prepared in the same way as in Example 63 except that 0.54 g of 2-methylphenylboronic acid was employed in place of phenylboronic acid. An organic electroluminescent element was produced in the same way as in Example 64 except that compound No.1-57 prepared in the above was employed in place of compound No.1-54. Application of a voltage to the element thus produced resulted in uniform light blue luminescent.

### Example 68

Compound No.1-58 was prepared in the same way as in Example 63 except that 0.60 g of 2,6-dimethylphenylboronic acid was employed in place of phenylboronic acid. An organic electroluminescent element was produced in the same way as in Example 64 except that compound No.1-58 prepared in the above was employed in place of compound No.1-54. Application of a voltage to the element thus produced resulted in uniform light blue luminescent.

### Example 69

On an electrode of an ITO glass substrate, a positive hole-transporting layer, a luminescent layer, and a cathode were formed, to produce the organic electroluminescent element of the present invention. Specifically, an ITO glass substrate, N,N′-bis[4′-(N,N-diphenylamino)-4-biphenylyl]-N,N′-diphenylbenzidine as a positive hole-transporting material, and compound No.1-54 as a luminescent material were placed in a vacuum vapor deposition system. The air was drawn out to 10⁻⁴ Pa. On the electrode of the ITO glass substrate, the positive hole-transporting layer was deposited to a thickness of 50 nm. Subsequently, compound No.1-54 was vapor-deposited to a thickness of 50 nm to obtain the luminescent layer. Further, Al/Li electrode was deposited to a thickness of 150 nm. These vapor deposition steps were performed continuously keeping the vacuum. The thickness of each layer was monitored with a quartz oscillator for controlling the thickness. After forming all of the layers, the electrode was immediately taken out in a dry nitrogen atmosphere, to produce the organic electroluminescent element. Application of a voltage to the element thus produced resulted in uniform green luminescent.

### Example 70

On an electrode of an ITO glass substrate, a luminescent layer and a cathode were formed, to produce the organic electroluminescent element of the present invention. Specifically, an ITO glass substrate and compound No.1-54 as a luminescent material were placed in a vacuum vapor deposition system. The air was drawn out to 10⁻⁴ Pa. On the electrode of the ITO glass substrate, compound No.1-54 was vapor-deposited to a thickness of 100 nm. Further, Al/Li electrode was deposited to a thickness of 150 nm. These vapor deposition steps were performed continuously keeping the vacuum. The thickness of each layer was monitored with a quartz oscillator for controlling the thickness. After forming all of the layers, the electrode was immediately taken out in a dry nitrogen atmosphere, to produce the organic electroluminescent element. Application of a voltage to the element thus produced resulted in uniform green luminescent.

### Example 71

On an electrode of an ITO glass substrate, a luminescent layer, an electron-transporting layer and a cathode were formed, to produce the organic electroluminescent element of the present invention. Specifically, an ITO glass substrate, compound No.1-54 as a luminescent material, and 2-(biphenyl-4-yl)-5-(4-tert-butylphenyl)-1,3,4-oxadiazole as an electron transporting material were placed in a vacuum vapor deposition system. The air was drawn out to 10⁻⁴ Pa. On the electrode of the ITO glass substrate, compound No.1-54 was deposited to a thickness of 50 nm. The electron transporting layer was then deposited to a thickness of 50 nm. Further, the Al/Li electrode was deposited to a thickness of 150 nm. These vapor deposition steps were performed continuously keeping the vacuum. The thickness of each layer was monitored with a quartz oscillator for controlling the thickness. After forming all of the layers, the electrode was immediately taken out in a dry nitrogen atmosphere, to produce the organic electroluminescent element. Application of a voltage to the element thus produced resulted in uniform green luminescent.

### Example 72

On an electrode of an ITO glass substrate, a positive hole-transporting layer, a luminescent layer, and a cathode were formed, to produce the organic electroluminescent element of the present invention. Specifically, an ITO glass substrate, N,N′-bis[4′-(N,N-diphenylamino)-4-biphenylyl]-N,N′-diphenylbenzidine as a positive hole-transporting material, compound No.1-54 as a host compound and EM-1 as a guest compound were placed in a vacuum vapor deposition system. The air was drawn out to 10⁻⁴ Pa. On the electrode of the ITO glass substrate, the positive hole-transporting layer was deposited to a thickness of 50 nm. Subsequently, compound No.1-54 and EM-1 were deposited as the luminescent layer to a thickness of 50 nm in a manner of co-vapordeposition. The concentration of EM-1 with respect to compound 1-54 was 3 mol per 100 mol of compound 1-54. Further, Al/Li electrode was deposited to a thickness of 150 nm. These vapor deposition steps were performed continuously keeping the vacuum. The thickness of each layer was monitored with a quartz oscillator for controlling the thickness. After forming all of the layers, the electrode was immediately taken out in a dry nitrogen atmosphere, to produce the organic electroluminescent element. Application of a voltage to the element thus produced resulted in uniform green luminescent.

### Example 73

An ITO glass substrate was placed in a vacuum chamber. The air was drawn out to 10⁻⁴ Pa. N,N′-bis[4′-(N,N-diphenylamino)-4-biphenylyl]-N,N′-diphenylbenzidine was deposited as the positive hole-transporting layer to a thickness of 50 nm. Compound No.1-54 as the host compound of the luminescent layer and rubrene as the guest compound were co-vapor deposited to form the luminescent layer having a thickness of 25 nm. The concentration of rubrene with respect to compound No.1-54 was 5 mol of rubrene per 100 mol of compound 1-54. Further, Alq as the electron-transporting layer was deposited to the thickness of 25 nm, and Al/Li electrode as the cathode was deposited to a thickness of 150 nm, to form the element. These vapor deposition steps were performed continuously keeping the vacuum. The thickness of each layer was monitored with a quartz oscillator for controlling the thickness. After forming the element, the electrode was immediately taken out in a dry nitrogen atmosphere, and subsequently subjected to measurements of properties. Application of a voltage to the element thus produced resulted in uniform yellow luminescent having a peak at 560 nm.

### Example 74

An organic electroluminescent element having the structure shown in FIG. 3 containing as the luminescent material the aromatic methylidene compound represented by the aforementioned formula.

An ITO glass substrate as an anode 1 was prepared, and a positive hole-transporting layer 2, a luminescent layer 3, an electron-transporting layer 4 and a cathode 5 were formed thereon in this order by vapor deposition, to produce an element.

Specifically, an ITO glass substrate, N,N′-bis[4′-(N,N-diphenylamino)-4-biphenylyl]-N,N′-diphenylbenzidine as a positive hole-transporting material, the aromatic methylidene compound No.1-74 shown in Table 19 as a luminescent material, and Alq as an electron transporting material were placed in a vacuum vapor deposition system. The air was drawn out to 10⁻⁴ Pa. On the electrode of the ITO glass substrate, N,N′-bis[4′-(N,N-diphenylamino)-4-biphenylyl]-N,N′-diphenylbenzidine was vapor-deposited at the deposition rate of 0.1 to 0.5 nm/sec., to form a positive hole-transporting layer having a thickness of 50 nm. Subsequently, compound No.1-74 was vapor-deposited at the deposition rate of 0.1 to 0.5 nm/sec., to form a luminescent layer having a thickness of 50 nm. Alq was then deposited at the rate of 0.1 nm/sec., to form an electron transporting layer having a thickness of 10 nm. Further, deposition of Al/Li electrode was performed at the deposition rate of 0.5 nm/sec., to form the electrode having a thickness of 150 nm. These vapor deposition steps were performed continuously keeping the vacuum. The thickness of each layer was monitored with a quartz oscillator for controlling the thickness. After forming all of the layers, the electrode was immediately taken out in a dry nitrogen atmosphere, to produce the organic electroluminescent element.

Application of a voltage to the element thus produced resulted in uniform blue luminescent. A current of 100 mA/cm² was applied to the element for measuring the drive voltage and luminescence intensity, which were found out to be 6.4V and 2600 cd/m², respectively. As an evaluation of the life of this element, a constant current of 20 mA/cm² was applied for constantly driving the element to measure the half life of the luminescence intensity. As a result, the luminescence intensity was reduced by half at the lapse of about 500 hours.

### Comparative Example 7

An element was produced in the same way as in Example 74 except that 4,4′-bis(2,2-diphenylvinyl)biphenyl that is described in the Japanese Patent Publication JP-P-H03-231970 A was employed as a luminescent material in place of the compound No.1-74. Application of a voltage to the element thus produced resulted in uniform blue luminescent. Peak wavelength of the luminescent spectrum was at 450 nm. When a current of 100 mA/cm² was applied to the element, the drive voltage and luminescence intensity were 6.2V and 1100 cd/m², respectively. As an evaluation of the life of this element, a constant current of 20 mA/cm² was applied for constantly driving the element to measure the half life of the luminescence intensity. At the lapse of 5 hours, coagulation was occurred at a part of organic layers that lead to electrical short circuit between electrodes and termination of luminescence.

### Comparative Example 8

An element was produced in the same way as in Example 74 except that 1,2′-bis[2-[4-(2,2-diphenylvinyl)phenyl]vinyl]benzene that is described in the Japanese Patent Publication JP-P-H11-317290 A was employed in place of the compound No.1-74. Application of a voltage to the element thus produced resulted in uniform blue luminescent. Peak wavelength of the luminescent spectrum was at 470 nm. When a current of 100 mA/cm² was applied to the element, the drive voltage and luminescence intensity were 8.2V and 1900 cd/m², respectively. As an evaluation of the life of this element, a constant current of 20 mA/cm² was applied for constantly driving the element to measure the half life of the luminescence intensity. The luminescence intensity was reduced by half at the lapse of 40 hours.

### Example 75

An organic electroluminescent element was produced in the same way as in Example 74 except that compound No.1-73 shown in Table 19 was employed in place of compound No.1-74. Application of a voltage to the element thus produced resulted in uniform blue luminescent.

### Example 76

An organic electroluminescent element was produced in the same way as in Example 74 except that compound No.1-75 shown in Table 19 was employed in place of compound No.1-74. Application of a voltage to the element thus produced resulted in uniform blue luminescent.

### Example 77

An organic electroluminescent element was produced in the same way as in Example 74 except that compound No.1-76 shown in Table 19 was employed in place of compound No.1-74. Application of a voltage to the element thus produced resulted in uniform green luminescent.

### Example 78

An organic electroluminescent element was produced in the same way as in Example 74 except that compound No.1-83 shown in Table 21 was employed in place of compound No.1-74. Application of a voltage to the element thus produced resulted in uniform blue luminescent.

### Example 79

An organic electroluminescent element having the structure shown in FIG. 2 containing as the luminescent material the aromatic methylidene compound of the present invention.

An ITO glass substrate as an anode 1 was prepared, and a positive hole-transporting layer 2, a luminescent layer 3, and a cathode 5 were formed thereon in this order by vapor deposition, to produce an element.

Specifically, an ITO glass substrate, N,N′-bis[4′-(N,N-diphenylamino)-4-biphenylyl]-N,N′-diphenylbenzidine as a positive hole-transporting material, and compound No.1-74 shown in Table 19 as a luminescent material were placed in a vacuum vapor deposition system. The air was drawn out to 10⁻⁴ Pa. On the electrode of the ITO glass substrate, the positive hole-transporting layer was deposited to a thickness of 50 nm. Subsequently, compound No.1-74 was deposited to form the luminescent layer having a thickness of 50 nm. Further, Al/Li electrode was deposited to a thickness of 150 nm. These vapor deposition steps were performed continuously keeping the vacuum. The thickness of each layer was monitored with a quartz oscillator for controlling the thickness. After forming all of the layers, the electrode was immediately taken out in a dry nitrogen atmosphere, to produce the organic electroluminescent element. Application of a voltage to the element thus produced resulted in uniform blue luminescent. The drive voltage was 8V, and the luminescent intensity was 1800 cd/m².

### Example 80

An organic electroluminescent element having the structure shown in FIG. 1 containing as the luminescent material the aromatic methylidene compound of the present invention.

An ITO glass substrate as an anode 1 was prepared, and a luminescent layer 3, and a cathode 5 were formed thereon in this order by vapor deposition, to produce an element.

Specifically, an ITO glass substrate, and the aromatic methylidene compound No.1-74 shown in Table 19 as a luminescent material were placed in a vacuum vapor deposition system. The air was drawn out to 10⁻⁴ Pa. On the electrode of the ITO glass substrate, compound No.1-74 was deposited to form the luminescent layer having a thickness of 100 nm. Further, Al/Li electrode was deposited to a thickness of 150 nm. These vapor deposition steps were performed continuously keeping the vacuum. The thickness of each layer was monitored with a quartz oscillator for controlling the thickness. After forming all of the layers, the electrode was immediately taken out in a dry nitrogen atmosphere, to produce the organic electroluminescent element. Application of a voltage to the element thus produced resulted in uniform blue luminescent. The drive voltage was 9.5V, and the luminescent intensity was 900 cd/m².

### Example 81

An organic electroluminescent element having the structure shown in FIG. 4 containing as the luminescent material the aromatic methylidene compound of the present invention.

An ITO glass substrate as an anode 1 was prepared, and a luminescent layer 3, an electron-transporting layer 4 and a cathode 5 were formed thereon in this order by vapor deposition, to produce an element.

Specifically, an ITO glass substrate, the aromatic methylidene compound No.1-74 shown in Table 19 as a luminescent material, and 2-(biphenyl-4-yl)-5-(4-tert-butylphenyl)-1,3,4-oxadiazole as an electron transporting material were placed in a vacuum vapor deposition system. The air was drawn out to 10⁻⁴ Pa. On the electrode of the ITO glass substrate, compound No.1-74 was deposited to a thickness of 50 nm. The electron-transporting layer was then deposited to a thickness of 50 nm. Further, Al/Li electrode was deposited to a thickness of 150 nm. These vapor deposition steps were performed continuously keeping the vacuum. The thickness of each layer was monitored with a quartz oscillator for controlling the thickness. After forming all of the layers, the electrode was immediately taken out in a dry nitrogen atmosphere, to produce the organic electroluminescent element. Application of a voltage to the element thus produced resulted in uniform light blue luminescent. The drive voltage was 8V, and the luminescence intensity was 1000 cd/m².

### Example 82

An organic electroluminescent element having the structure shown in FIG. 2 containing as a host material of the luminescent layer the aromatic methylidene compound of the present invention.

An ITO glass substrate as an anode 1 was prepared, and a positive hole-transporting layer 2, the luminescent layer 3, and a cathode 5 were formed thereon in this order by vapor deposition, to produce an element.

Specifically, an ITO glass substrate, N,N′-bis[4′-(N,N-diphenylamino)-4-biphenylyl]-N,N′-diphenylbenzidine as a positive hole-transporting material, compound No.1-74 shown in Table 19 as a host compound and EM-1 as a guest compound were placed in a vacuum vapor deposition system. The air was drawn out to 10⁻⁴ Pa. On the electrode of the ITO glass substrate, the positive hole-transporting layer was deposited to a thickness of 50 nm. Subsequently, compound No.1-74 and EM-1 were deposited as the luminescent layer to a thickness of 50 nm in a manner of co-vapordeposition. The concentration of EM-1 with respect to compound 1-74 was 3 mol per 100 mol of compound 1-74. Further, Al/Li electrode was deposited to a thickness of 150 nm. These vapor deposition steps were performed continuously keeping the vacuum. The thickness of each layer was monitored with a quartz oscillator for controlling the thickness. After forming all of the layers, the electrode was immediately taken out in a dry nitrogen atmosphere, to produce the organic electroluminescent element. Application of a voltage to the element thus produced resulted in uniform blue-green luminescent. The drive voltage was 7.1 V, and the luminescence intensity was 8000 cd/m². The element was driven with a current intensity of 20 mA/cm² in a dry nitrogen atmosphere. The luminescence thereof was reduced by half at the lapse of 1300 hours.

### Example 83

An organic electroluminescent element having the structure shown in FIG. 3 containing as a host material of the luminescent layer the aromatic methylidene compound of the present invention.

An ITO glass substrate as an anode 1 was prepared, and a positive hole-transporting layer 2, the luminescent layer 3, an electron-transporting layer 4 and a cathode 5 were formed thereon in this order by vapor deposition, to produce an element.

Specifically, the ITO glass substrate, N,N′-bis[4′-(N,N-diphenylamino)-4-biphenylyl]-N,N′-diphenylbenzidine as a positive hole-transporting material, the aromatic methylidene compound No.1-74 shown in Table 19 as a host material, rubrene as a guest material, and Alq as an electron-transporting material were placed in a vacuum vapor deposition system. The air was drawn out to 10⁻⁴ Pa. On the electrode of the ITO glass substrate, N,N′-bis[4′-(N,N-diphenylamino)-4-biphenylyl]-N,N′-diphenylbenzidine as a positive hole-transporting was deposited as the positive hole-transporting layer to a thickness of 50 nm. Subsequently, compound No.1-74 as the host compound of the luminescent layer, and rubrene as the guest compound were co-vapor deposited to form the luminescent layer having a thickness of 25 nm. The concentration of rubrene with respect to compound 1-74 was 5 mol per 100 mol of compound 1-74. Further, Alq was deposited to a thickness of 25 nm as the electron-transporting layer, and Al/Li electrode was deposited to a thickness of 150 nm as the cathode, to form the element. These vapor deposition steps were performed continuously keeping the vacuum. The thickness of each layer was monitored with a quartz oscillator for controlling the thickness. After forming the element, the electrode was immediately taken out in a dry nitrogen atmosphere, and subsequently subjected to measurement of properties. Application of a voltage to the element thus produced resulted in uniform yellow luminescence having a peak at 560 nm. A current of 100 mA/cm² was applied to the element for measuring the drive voltage and luminescence, which were found out to be 7.2 V and 4800 cd/m², respectively. When this element was constantly driven with a constant current of 20 mA/cm² in dry nitrogen atmosphere, the luminescence was reduced by half at the lapse of 1000 hours.

As described above, the organic electroluminescent element of the present invention having the aromatic methylidene compound of the present invention has superior luminescent property. Further, the element is stable and has long life. Therefore, the element, compound of the present invention and production method thereof is very useful in the industry.

Although the present invention has been described with reference to the preferred examples, it should be understood that various modifications and variations can be easily made by those skilled in the art without departing from the spirit of the invention. Accordingly, the foregoing disclosure should not be interpreted in a limiting sense. The present invention is limited only by the scope of the following claims.

What is claimed is:

1. A compound represented by the following formula (1): 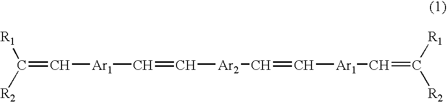
wherein R₁ and R₂ are the same or different from each other and each represents a hydrogen atom provided that at least one of R₁ and R₂ is not hydrogen atom, a non-substituted or substituted alkyl group provided that at least one of R₁ and R₂ is not the alkyl group, a non-substituted or substituted cycloalkyl group provided that at least one of R₁ and R₂ is not the cycloalkyl group, a non-substituted or substituted aromatic group, or a non-substituted or substituted heteroaromatic group; or R₁ and R₂ together form a condensed ring consisting of non-substituted or substituted aromatic rings or non-substituted or substituted heteroaromatic rings;
Ar₁ is a group represented by the following formula: 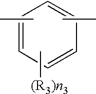
wherein R₃ represents a non-substituted or substituted alkyl group, a non-substituted or substituted alkoxy group, a halogen atom, a cyano group, or a nitro group provided that, if two or more of R₃ are present, these R₃ groups are the same or different, and n₃ represents an integer of 0 to 4;
Ar₂ is selected from the group consisting of the groups represented by the following formulae: 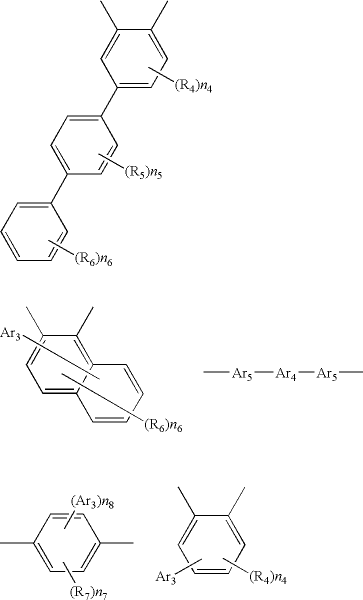
wherein each of R₄ to R₇ represents a non-substituted or substituted alkyl group, anon-substituted or substituted alkoxy group, a halogen atom, a cyano group, or a nitro group provided that, if two or more of each of R₄ to R₇ are present, these groups are the same or different, Ar₃ represents a non-substituted or substituted aromatic group or non-substituted or substituted heteroaromatic group, each of Ar₄ and Ar₅ is a 1,2-phenylene group with or without substituent group(s), a 1,3-phenylene group with or without substituent group(s), or a 1,4-phenylene group with or without substituent group(s) provided that at least one of Ar₁, Ar₄ and Ar₅ is not 1,4-phenylene group, n₄, n₅ and n₆ are integers of 0 to 3, 0 to 4 and 0 to 5, respectively, and n₇ and n₈ are integers of 0 to 3 and 1 to 4, respectively, provided that the sum of n₇ and n₈ is 4 or fewer.

2. An intermediate compound for preparing the compound of claim 1, said intermediate compound being represented by the following formula (2):
H₃C—Ar₂—CH₃ (2)
wherein Ar₂ is the same as that in the formula (1).

3. An intermediate compound for preparing the compound of claim 1, said intermediate compound being represented by the following formula (3):
X₁CH₂—Ar₂—CH₂X₁ (3)
wherein Ar₂ is the same as that in the formula (1), and X₁ represents chlorine, bromine or iodine.

4. A method for producing the intermediate compound of claim 3, said method comprising the step of halogenating the intermediate compound represented by the formula (2):
H₃C—Ar₂—CH₃ (2)
wherein Ar₂ is the same as that in the formula (1).

5. An intermediate compound for preparing the compound of claim 1, said intermediate compound being represented by the following formula (5):
Z—CH₂—Ar₂—CH₂—Z (5)
wherein Ar₂ is the same as that in the formula (1), and groups Z are the same or different from each other and each represents —PO(OR)₂ or —PA₃⁺ or a salt thereof with a base, wherein R represents a non-substituted or substituted alkyl group, and A represents a non-substituted or substituted aryl group.

6. A method for producing the intermediate compound of claim 5, said method comprising the step of reacting the compound represented by the formula (3):
X₁CH₂—Ar₂—CH₂X₁ (3)
wherein Ar₂ is the same as that in the formula (1), and X₁ represents chlorine, bromine or iodine, with a compound represented by the formula P(OR)₃ or P (A)₃, wherein R represents a non-substituted or substituted alkyl group, and A represents a non-substituted or substituted aryl group.

7. A method for producing the compound of claim 1, said method comprising the step of reacting the compound represented by the formula (5):
Z—CH₂—Ar₂—CH₂—Z (5)
wherein Ar₂ is the same as that in the formula (1), and groups Z are the same or different from each other and each represents —PO(OR)₂ or —PA₃⁺ or a salt thereof with a base, wherein R represents a non-substituted or substituted alkyl group, and A represents a non-substituted or substituted aryl group, with a compound represented by the following formula (7): 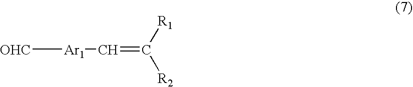
wherein R₁, R₂ and Ar₁ are the same as those in the formula (1).

8. A method for producing the compound of claim 1, said method comprising the step of reacting a compound represented by the following formula (8):
OHC—Ar₁—CH═CH—Ar₂—CH═CH—Ar₁—CHO (8)
wherein Ar₁ and Ar₂ are the same as those in the formula (1), with a compound represented by the formula (8-1): 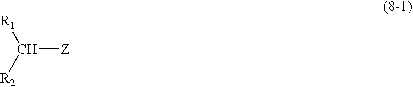
wherein R₁ and R₂ are the same as those in the formula (1), and Z represents —PO(OR)₂ or —PA₃⁺ or a salt thereof with a base, wherein R represents a non-substituted or substituted alkyl group, and A represents a non-substituted or substituted aryl group.

9. A method for producing the compound of claim 1, said method comprising the step of reacting the compound represented by the following formula (9):
Z—H₂C—Ar₁—CH═CH—Ar₂—CH═CH—Ar₁—CH₂—Z (9)
wherein Ar₁ and Ar₂ are the same as those in the formula (1), and groups Z are the same or different from each other and each represents —PO(OR)₂ or —PA₃⁺ or a salt thereof with abase, wherein R represents a non-substituted or substituted alkyl group, and A represents a non-substituted or substituted aryl group,
with a compound represented by the following formula (9-1): 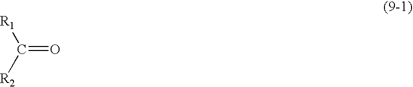
wherein R₁ and R₂ are the same as those in the formula (1).

10. The compound of claim 1 wherein Ar₁ is a group represented by the following formula (10) and Ar₂ is a group represented by the formula (10-1): 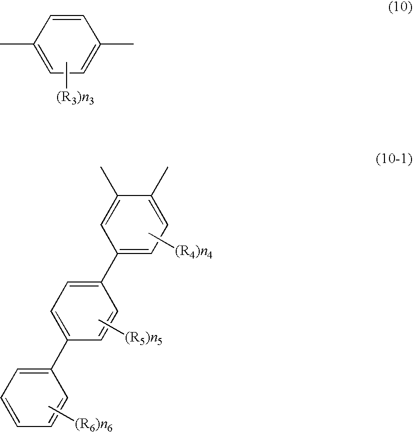
wherein R₃ to R₆ and n₃ to n₆ are the same as those in the formula (1).

11. A method for producing the compound of claim 10, said method comprising the step of reacting a compound represented by the formula (11) with a compound represented by the formula (11-1): 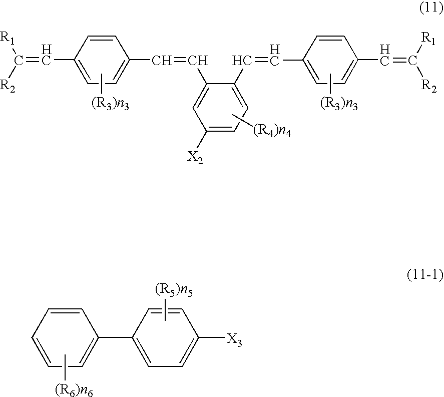
wherein R₁ to R₆ and n₃ to n₆ are the same as those in the formula (1), and one of X₂ and X₃ represents chlorine, bromine, iodine or —OSO₂CF₃, and the other represents —B(OH) 2 or an ester thereof.

12. An intermediate compound for producing the compound of claim 10, said intermediate compound being represented by the following formula (12): 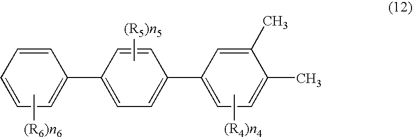
wherein R₄ to R₆ and n₄ to n₆ are the same as those in the formula (1).

13. A method for producing the intermediate compound of claim 12, said method comprising the step of reacting the compound represented by the formula (11-1) and a compound represented by the following formula (13): 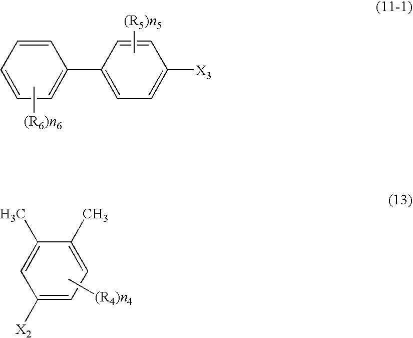
wherein R₄ to R₆ and n₄ to n₆ are the same as those in the formula (1), and one of X₂ and X₃ represents chlorine, bromine, iodine or —OSO₂CF₃, and the other represents —B(OH)₂ or an ester thereof.

14. The compound of claim 1 wherein Ar₁ is a group represented by the formula (10), and Ar₂ is a group represented by the following formula (14): 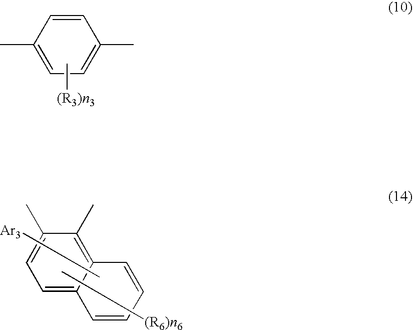
wherein R₃, R₆, n₃, n₆ and Ar₃ are the same as those in the formula (1).

15. A method for producing the compound of claim 14, said method comprising the step of reacting a compound represented by the following formula (15) and a compound represented by the following formula (15-1): 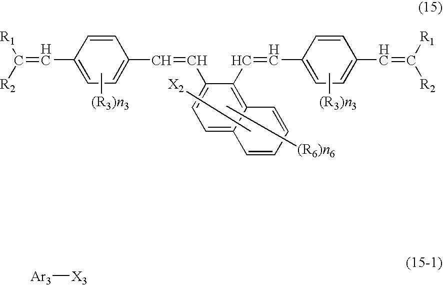
wherein R₁ to R₃, R₆, n₃, n₆ and Ar₃ are the same as those in the formula (1), and one of X₂ and X₃ represents chlorine, bromine, iodine or —OSO₂CF₃, and the other represents —B(OH)₂ or an ester thereof.

16. An intermediate compound for producing the compound of claim 14, said intermediate compound being represented by the following formula (16): 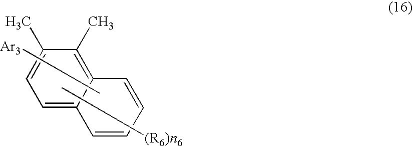
wherein R₆, n₆ and Ar₃ are the same as those in the formula (1).

17. A method for producing the intermediate compound of claim 16, said method comprising the step of reacting the compound represented by the formula (15-1) with a compound represented by the following formula (17): 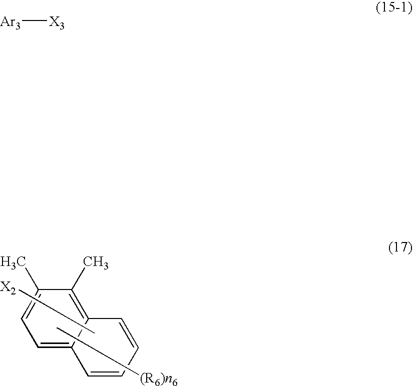
wherein R₆, n₆ and Ar₃ are the same as those in the formula (1), and one of X₂ and X₃ represents chlorine, bromine, iodine or —OSO₂CF₃, and the other represents —B(OH)₂ or an ester thereof.

18. The compound of claim 1, wherein Ar₂ is a group represented by the following formula (18):
—Ar₅—Ar₄—Ar₅— (18)
wherein Ar₄ and Ar₅ are the same as those in the formula (1).

19. An intermediate compound for producing the compound of claim 18, said intermediate compound being represented by the following formula (19):
OHC—Ar₅—Ar₄—Ar₅—CHO (19)
wherein Ar₄ and Ar₅ are the same as those in the formula (1).

20. A method for producing the compound of claim 18, said method comprising the step of reacting a compound represented by the following formula (19) with a compound represented by the following formula (20):
OHC—Ar₅—Ar₄—Ar₅—CHO (19) 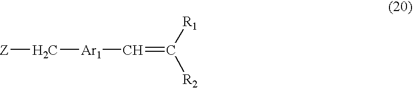
wherein R₁, R₂, Ar₁, Ar₄ and Ar₅ are the same as those in the formula (1), and Z represents —PO(OR)₂ or —PA₃⁺ or a salt of —PA₃⁺ and a base, wherein R represents a non-substituted or substituted alkyl group, and A represents a non-substituted or substituted aryl group.

21. A method for producing the compound of claim 18, said method comprising the step of reacting a compound represented by the following formula (21) with a compound represented by the following formula (21-1):
Z—CH₂—Ar₅—Ar₄—Ar₅—CH₂—Z (21) 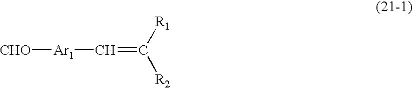
wherein R₁, R₂, Ar₁, Ar₄ and Ar₅ are the same as those in the formula (1), and Z represents —PO(OR)₂ or —PA₃⁺ or a salt of —PA₃⁺ and a base, wherein R represents a non-substituted or substituted alkyl group, and A represents a non-substituted or substituted aryl group.

22. A method for producing the intermediate compound of claim 19, said method comprising the step of reacting a compound represented by the following formula (22) with a compound represented by the following formula (22-1):
X₂—Ar₄—X₂ (22)
OHC—Ar₅—X₃ (22-1)
wherein Ar₄ and Ar₅ are the same as those in the formula (1), and one of X₂ and X₃ represents chlorine, bromine, iodine or —OSO₂CF₃, and the other represents —B(OH)₂ or an ester thereof.

23. The compound of claim 1 wherein Ar₁ is a group represented by the formula (10), and Ar₂ is a group represented by the following formula (23): 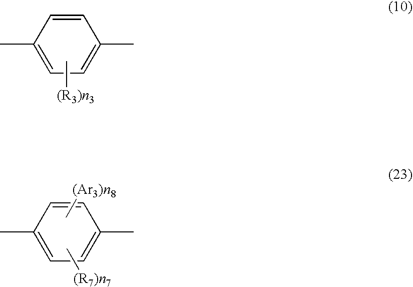
wherein R₃, R₇, Ar₃, n₃, n₇ and n₈ are the same as those in the formula (1).

24. A method for producing the compound of claim 23, said method comprising the step of reacting a compound represented by the following formula (24) with a compound represented by the following formula (24-1): 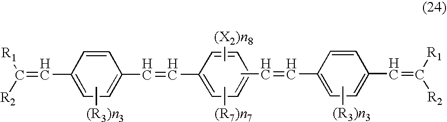
Ar₃—X₃ (24-1)
wherein R₁ to R₃, R₇, Ar₃, n₃, n₇ and n₈ are the same as those in the formula (1), and one of X₂ and X₃ represents chlorine, bromine, iodine or —OSO₂CF₃, and the other represents —B(OH)₂ or an ester thereof.

25. An intermediate compound for producing the compound of claim 23, said intermediate compound being represented by the following formula (25): 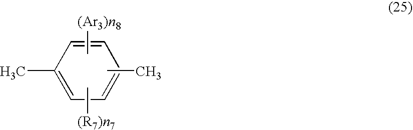
wherein R₇, Ar₃, n₇ and n₈ are the same as those in the formula (1).

26. A method for producing the intermediate compound of claim 25, said method comprising the step of reacting the compound represented by the formula (24-1) with a compound represented by the following formula (26):
Ar₃—X₃ (24-1) 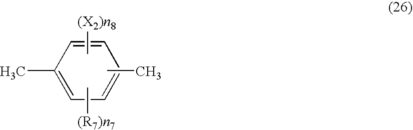
wherein R₇, Ar₃, n₇ and n₈ are the same as those in the formula (1), and one of X₂ and X₃ represents chlorine, bromine, iodine or —OSO₂CF₃, and the other represents —B(OH)₂ or an ester thereof.

27. The compound of claim 1, wherein Ar₁ is a group represented by the formula (10), and Ar₂ is a group represented by the following formula (27): 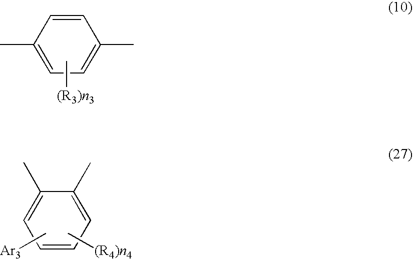
wherein R₃, R₄, Ar₃, n₃ and n₄ are the same as those in the formula (1).

28. An organic electroluminescent element comprising a layer containing the compound of claim 1.
